(19) United States
(12) Patent Application Publication
(10) Pub. No.: US 2004/0213133 A1
(43) Pub. Date: Oct. 28, 2004

(54) Diffraction grating, method of producing it, method of duplicating it, optical head device employing it and optical disk drive apparatus employing the optical head device

(76) Inventors: Hiroyoshi Funato, Kanagawa (JP); Masanori Kobayashi, Kanagawa (JP); Kazuya Miyagaki, Kanagawa (JP); Hiroyuki Sugimoto, Kanagawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/830,021

(22) Filed: Apr. 23, 2004

(30) Foreign Application Priority Data
Apr. 24, 2003 (JP) NO. 2003-120141
Jul. 8, 2003 (JP) NO. 2003-193733

(51) Int. Cl. G11B 7/135

(52) U.S. Cl. 369/112.07; 369/112.05; 369/112.06

(57) ABSTRACT

In a diffraction grating used in an optical head device leading light, diffracted light exiting from each of the plurality of areas is lead to a corresponding particular photo-detecting area of the photodetector. Each of the plurality of areas of the diffraction grating is produced either by first two-beam interference exposure to interference fringes from first divergent light from a position equivalent to a light emitting point on the light source of the optical head device and second divergent light form a position equivalent to a light receiving point corresponding to each photo-detecting area, or by second two-beam interference exposure to interference fringes from first convergent light converging at the position equivalent to the light emitting point on the light source and second convergent light converging at the point equivalent to the light receiving point corresponding to each photo-detecting area.

### BACKGROUND OF THE INVENTION

### 1. Field of the Invention

The present invention relates to a diffraction grating (hologram), a method of producing it, a method of duplicating it, an optical head device (optical pickup device) employing the diffraction grating, and an optical disk drive apparatus employing the optical head device. In particular, the present invention relates to an optical head device which may have a plurality of light sources, and may have a function of recording or reproducing information to or from an optical recording medium (optical disk) in various standards requiring different wavelengths to be applied, such as an optical disk in a CD (compact disk) family (CD, CD-R, CD-RW or such), a DVD (digital versatile disk) family (DVD, DVD-R, DVD+R, DVD-RW, DVD+RW or such), a high-density optical disk requiring a blue semiconductor laser as a light source, or such, and an optical disk drive apparatus mounting the optical head device.

Conventionally, various systems have been proposed as optical head devices (also referred to as optical pickup devices) in which reflected light from an optical recording medium, i.e., an optical disk is made to branch off through a diffraction optical head device, and is then received by a photodetector. Thereamong, a system in which, as the diffraction optical head device, a polarization diffraction grating (hologram) is used is known. For example, Japanese Patent No. 2594548 discloses a diffraction grating (hologram) in which a double refraction projection-and-depression grating is provided, isotropic medium is used to fill at least the depressions thereof, and thus, a polarization property is provided in which diffraction efficiency differs according to a polarization direction of light applied.

FIGS. 33 and 34 show one example of an optical head device and a diffraction grating used there in the related art.

As shown in FIG. 33, the optical head device includes a light source 8 made of a semiconductor laser or such, a diffraction grating 7, a coupling lens, 10, a ¼ wavelength plate 11, a converging lens (objective lens) 12 and a photodetector 9. In this configuration, light from the light source 8 is led into an optical system in which the converging lens (objective lens) 12 converges the light onto an optical disk 13 which is an optical recording medium, reflected light from the optical disk 13 is then detected by the photodetector 9, and thus, information is recorded to the optical disk 13 or information is reproduced therefrom.

As shown in FIG. 34, the diffraction grating 7 has a configuration of a polarization diffraction grating in which, on a transparent substrate 1, a medium 2 having a rectangular projection-and-depression shape having a double refraction function (optical anisotropic property) is disposed, an optical isotropic medium 3 is provided to fill the depressions thereof and cover the medium 2, and then, thereover, a transparent substrate 1′ is placed to cover the optical isotropic medium 3. In this configuration, as a result of a refraction of the isotropic medium 3 being made equal to either one of an ordinary light refraction or an extraordinary light refraction of the double refraction medium 2, the diffraction grating has a polarization property (optical anisotropic property). In other words, this device transmits all the light with predetermined polarization, while it diffracts all the light with polarization perpendicular thereto.

By employing the polarization diffraction grating 7 having such a configuration in the optical head device as shown in FIG. 33 as a device of causing applied light to branch off, it becomes possible to achieve a high efficiency in luminous energy in the optical head device both for a goring light path and for a returning light path, as follows: Light emitted from the light source 8 is set so that a polarization direction of the light enables the light to be completely transmitted by the diffraction grating 7 in the going light path from the light source 8 to the optical disk 13, and thus, the light from the light source 8 is efficiently converged onto the optical disk 13. On the other hand, by disposing the ¼ wavelength plate 11 on the light path, it becomes possible to cause the reflected light from the optical disk 13 to return with a polarization direction perpendicular to that appearing on the above-mentioned going light path. Thereby, the reflected light passing through the ¼ wavelength plate 11 is completely diffracted by the polarization diffraction grating 7 so that the diffracted light in the returning light path is efficiently received by the photodetector 9.

FIG. 35 illustrates a diffraction efficiency of +1-st diffracted light with respect to an incidence angle thereof to the polarization diffraction grating 7 shown in FIG. 34. This polarization diffraction grating 7 has a diffraction efficiency of on the order of approximately 40% around the perpendicular (normal) incidence state. Conventionally, a polarization diffraction grating having such diffraction efficiency is sufficient to be used as it is. However, in order to achieve high-speed recording/reproduction (in particular, reproduction speed) in an optical disk drive apparatus mounting the optical head device having the configuration shown in FIG. 33, a diffraction efficiency more than 40% is needed in the diffraction grating 7 for the purpose of improving an S/N ratio when where reflected light from the optical disk 13 is received by the photodetector 9. In particular, in case where the configuration shown in FIG. 33 is applied to a case of a high-density optical disk which requires a semiconductor laser having a blue zone in wavelength as the light source therefor, a band width of a reproduced signal is widened as a result of information being recorded in the recording medium at a high density, and simultaneously, the sensitivity of the photodetector may be degraded for the blue zone in comparison to a case for a red zone. From these two reasons, an S/N ratio in the photo-detection signal tends to be degraded. In order to avoid the degradation in the S/N ratio, a high diffraction efficiency exceeding 40% is needed in the polarization diffraction grating for the returning light path. Furthermore, in order to achieve a small-sized hologram unit in which the light source and the photodetector are integrated (specifically, in the example of FIG. 33, a unit which integrates the light source 8, the photodetector 9 and the polarization diffraction grating 7) for the blue zone, it is necessary to narrow the grating pitch of the polarization diffraction grating along with the shortening of the wavelength applied. Specifically, the grating pitch on the order of 1 μm is needed.

As described above, in the rectangular grating such as that shown in FIG. 34, it is not possible to provide the +1-st diffraction efficiency of more than 40%, and thus, not possible to achieve the above-mentioned polarization diffraction grating having a narrow pitch and having a high diffraction efficiency, which are required to provide the diffraction grating which is suitable for the system in which the wavelength of the light source is shortened as mentioned above. A blaze grating, known for improving the efficiency in one of the +1-st diffraction, provides a high efficiency of 80 through 90%. However, in this case, it is difficult to achieve a narrow pitch on the order of 1 μm since working thereof involves a difficulty for achieving such a fine structure.

### SUMMARY OF THE INVENTION

The present invention has been devised in consideration of the above-described situation, and an object of the present invention is to provide a diffraction grating, especially, a polarization diffraction grating applied in an optical head device for an optical disk by which both increasing a +1-st (or −1-st) diffraction (one of 1-st diffraction) efficiency and narrowing the grating pitch can be achieved simultaneously. Furthermore, an object of the present invention is to provide a method of producing this diffraction grating, a method of duplicating the diffraction grating in which the diffraction grating is duplicated or replicated so as to provide a large number of the diffraction gratings easily. Furthermore, an object of the present invention is to provide an optical head device employing this diffraction grating and an optical disk drive apparatus mounting the optical head device.

According to a first aspect of the present invention, a diffraction grating is used in an optical head device which leads light from a light source to an optical system, converges the light on an optical recording medium through a converging lens, detects reflected light from the optical recording medium by a photodetector and records information to the optical recording medium or reproduces information therefrom, or performs both the recording and reproducing. The diffraction grating includes a grating part which comprises a plurality of areas obtained from dividing the grating part, wherein: a setting is made such that diffracted light exiting from each of the plurality of areas is led to a corresponding particular photo-detecting area of the photodetector; and each of the plurality of areas of the diffraction grating is produced either by first two-beam interference exposure in which a hologram recording material is exposed to interference fringes produced from first divergent light emitted from a position equivalent to a light emitting point on the light source of the optical head device and second divergent light emitted form a position equivalent to a light receiving point corresponding to each photo-detecting area, or by second two-beam interference exposure in which a hologram recording material is exposed to interference fringes produced from first convergent light converging at the position equivalent to the light emitting point on the light source of the optical head device and second convergent light converging at the point equivalent to the light receiving point corresponding to each photo-detecting area.

A second aspect of the present invention is a method for producing the above-mentioned diffraction grating, which method may include the step of disposing a sector mask defining the respective areas immediately before the hologram recording material when producing the plurality of areas of the diffraction grating by the two-beam interference exposure individually.

According to a third aspect of the present invention, in the diffraction grating in the first aspect of the present invention or in a diffraction grating produced by the method in the second aspect of the present invention, a wavelength of the light used for producing the diffraction grating through the interference exposure may be different from a wavelength of the optical head device; and each of the plurality of areas of the diffraction grating may be produced either by first two-beam interference exposure of a hologram recording material with first divergent light emitted from a position according to the difference in wavelength corresponding to the light emitting point on the light source of the optical head device and second divergent light emitted from a position according to the difference in wavelength corresponding to the light receiving point of each photo-detecting area, or by second two-beam interference exposure of the hologram recording material with first convergent light converging at the position according to the difference in wavelength corresponding to the light emitting point on the light source of the optical head device and second convergent light converging at the position according to the difference in wavelength corresponding to the light receiving point of each photo-detecting area.

According to a fourth aspect of the present invention, a method for producing the diffraction grating in the third aspect of the present invention may include the step of: configuring at least one optical system used for the two-beam interference exposure so that the optical system provides aberration for canceling out aberration otherwise occurring due to the difference in wavelength of light used between in recording operation for the hologram recording material and in reproduction operation in the optical head device so that diffracted light without aberration occurs on the photodetector in a condition in which the thus-produced diffraction grating is applied in the optical head device.

According to a fifth aspect of the present invention, the method for producing the diffraction grating in the fourth aspect of the present invention further may include the step of disposing a hologram providing the aberration canceling out the aberration otherwise occurring when difference occurs in wavelength between recording and reproduction in at least one optical path.of the two-beam interference exposure optical system.

According to a sixth aspect of the present invention, a method for duplicating a diffraction grating may include the step of utilizing the diffraction grating according to the first or the third aspect of the present invention including the grating part which is divided into the plurality of areas or a diffraction grating created according to the method in the second or the fourth aspect of the present invention also including the grating part which is divided into the plurality of areas, as an original hologram plate, and make the original hologram plate and a hologram recording material for duplication approximately in contact with one another; and applying light from the side of the original hologram plate, so as to expose the hologram recording material to the interference fringes occurring as a result of 0-th light and 1-st diffracted light generated from the original hologram plate being made to be applied to the hologram recording material.

According to a seventh aspect of the present invention, a method for duplicating a diffraction grating may include the step of configuring a diffraction grating based on calculation made through a computer for calculating interference fringes equivalent to those of the diffraction grating according to the first or the third aspect of the present invention including the grating part which is divided into the plurality of areas or a diffraction grating created according to the method in the second or fourth aspect of the present invention also including the grating part which is divided into the plurality of areas, for utilizing it as an original hologram plate, and attaching the original hologram plate to a hologram recording material for duplication approximately so as to make them approximately in contact with one another; and applying light from the side of the original hologram plate, so as to expose the hologram recording material to the interference fringes occurring as a result of 0-th light and 1-st diffracted light generated from the original hologram plate being made to be applied to the hologram recording material.

According to an eighth aspect of the present invention, in the method for duplicating a diffraction grating in the sixth or seventh aspect of the present invention, convergent light converging at the position equivalent to the light emitting point on the light source of the optical head device or divergent light emitted from the position equivalent to the light emitting point on the light source of the optical head device may be used as light to be applied when the original hologram plate of the diffraction grating is made approximately in contact with the hologram recording material for duplication, and the light is applied from the side of the original hologram plate so that the diffraction grating is duplicated in the hologram recording material.

According to a ninth aspect of the present invention, the method for duplicating a diffraction grating in the sixth or the seventh aspect of the present invention, convergent light converging at a position, corresponding to the light emitting point of the light source, determined according to a difference between the duplicating wavelength and the light source wavelength of the optical head device or divergent light emitted from a position, corresponding to the light emitting point of the light source, determined according to the difference between the duplicating wavelength and the light source wavelength of the optical head device may be used as light to be applied when the original hologram plate of the diffraction grating is made approximately in contact with the hologram recording material for duplication and the light is applied from the side of the original hologram plate so that the diffraction grating is duplicated.

According to a tenth aspect of the present invention, the method for duplicating a diffraction grating in the sixth or the seventh aspect of the present invention, convergent light converging at a position equivalent to a point from among a plurality of light receiving points respectively corresponding to a plurality of photo-detecting areas of the photodetector of the optical head device or divergent light emitted from a position equivalent to a point from among the plurality of light receiving points respectively corresponding to the plurality of photo-detecting areas may be used as light to be applied when the original hologram plate of the diffraction grating is made approximately in contact with the hologram recording material for duplication and the light is applied from the side of the original hologram plate so that the diffraction grating is duplicated.

According to an eleventh aspect of the present invention, the method for duplicating a diffraction grating in the sixth or the seventh aspect of the present invention, convergent light converging at a position, corresponding to a point from among a plurality of light receiving points respectively corresponding to a plurality of photo-detecting areas of the photodetector of the optical head device, determined according to a difference between the duplicating wavelength and the light source wavelength of the optical head device, or divergent light emitted from a position, corresponding to a point from among the plurality of light receiving points respectively corresponding to the plurality of photo-detecting areas of the photodetector of the optical head device, determined according to the difference between the duplicating wavelength and the light source wavelength of the optical head device may be used as light to be applied when the original hologram plate of the diffraction grating is made approximately in contact with the hologram recording material for duplication and the light is applied from the side of the original hologram plate so that the diffraction grating is duplicated.

According to a twelfth aspect of the present invention, in the method for duplicating a diffraction grating in the tenth or the eleventh aspect of the present invention, as the light to be applied for duplication, convergent light converging at a position corresponding to a light receiving point, used for obtaining a focus error signal, from among the plurality of light receiving points respectively corresponding to the plurality of photo-detecting areas, or divergent light diverging from the corresponding position may be used.

According to a thirteenth aspect of the present invention, a method for duplicating a diffraction grating may include the step of configuring a diffraction grating based on calculation made through a computer for interference fringes equivalent to that of the diffraction grating in the first or the third aspect of the present invention or a diffraction grating produced according to the method in the second, fourth or fifth aspect of the present invention, which comprises the grating part divided into the plurality of areas, for utilizing it as a first original hologram plate, and making the original hologram plate and a hologram recording material for duplication approximately in contact with one another; applying light thereto from the side of the original hologram plate, so as to expose the hologram recording material to the interference fringes occurring as a result of 0-th light and 1-st diffracted light thus generated from the first original hologram plate being made to be applied to the hologram recording material so as to produce a second original hologram plate; making the second original hologram plate and a hologram recording material for duplication approximately in contact with one another; and applying light thereto from the side of the second original hologram plate, so as to expose the hologram recording material to interference fringes occurring as a result of 0-th light and 1-st diffracted light thus generated from the second original hologram plate being made to be applied to the hologram recording material so as to produce a diffraction grating, wherein, when the diffraction grating is produced as a result of the second original hologram plate and the hologram recording material for duplication being made approximately in contact with one another and the light being applied thereto from the side of the second original hologram plate, convergent light converging at a position equivalent to a light emitting point of the light source of the optical head device or divergent light emitted from the position equivalent to the light emitting point of the light source is used as the light to be applied there.

According to a fourth aspect of the present invention, a method for duplicating a diffraction grating may include the step of configuring a diffraction grating based on calculation made through a computer for interference fringes equivalent to those of the diffraction grating in the first or the third aspect of the present invention or a diffraction grating produced according to the method in the second, fourth or fifth aspect of the present invention, which comprises the grating part which is divided into the plurality of areas, for utilizing it as a first original hologram plate, and making the original hologram plate and a hologram recording material for duplication approximately in contact with one another; applying light thereto from the side of the original hologram plate, so as to expose the hologram recording material to interference fringes occurring as a result of 0-th light and 1-st diffracted light thus generated from the first original hologram plate being made to be applied to the hologram recording material so as to produce a second original hologram plate; making the second original hologram plate and a hologram recording material for duplication approximately in contact with one another; and applying light thereto from the side of the second original hologram plate, so as to expose the hologram recording material to interference fringes occurring as a result of 0-th light and 1-st diffracted light thus generated from the second original hologram plate being made to be applied to the hologram recording material so as to produce a diffraction grating, wherein, in a case where the duplicating exposure wavelength is different from the light source wavelength in the optical head device when the diffraction grating is produced as a result of the second original hologram plate and the hologram recording material for duplication being made approximately in contact with one another and the light being applied thereto from the side of the second original hologram plate, convergent light converging at a position, corresponding to the light emitting point of the light source of the optical head device, determined according to a difference between the duplicating exposure wavelength and the light source wavelength of the optical head device, or divergent light emitted from a position, corresponding to the light emitting point of the light source of the optical head device, determined according to the difference between the duplicating exposure wavelength and the light source wavelength of the optical head device is used.

According to a fifteenth aspect of the present invention, a method for duplicating a diffraction grating may include the step of configuring a diffraction grating based on calculation made through a computer for interference fringes equivalent to those of the diffraction grating in the first or the third aspect of the present invention or a diffraction grating produced according to the method in the second, fourth or fifth aspect of the present invention, which comprises the grating part which is divided into the plurality of areas, for utilizing it as a first original hologram plate, and making the original hologram plate and a hologram recording material for duplication approximately in contact with one another; applying light thereto from the side of the original hologram plate, so as to expose the hologram recording material to the interference fringes occurring as a result of 0-th light and 1-st diffracted light thus generated from the first original hologram plate being made to be applied to the hologram recording material so as to produce a second original hologram plate; making the second original hologram plate and a hologram recording material for duplication approximately in contact with one another; and applying light thereto from the side of the second original hologram plate, so as to expose the hologram recording material to interference fringes occurring as a result of 0-th light and 1-st diffracted light thus generated from the second original hologram plate being made to be applied to the hologram recording material so as to produce a diffraction grating, wherein, when the diffraction grating is produced as a result of the second original hologram plate and the hologram recording material for duplication being made approximately in contact with one another and the light being applied thereto from the side of the second original hologram plate, convergent light converging at a position equivalent to a point from among a plurality of light receiving points corresponding to a plurality of photo-detecting areas of the photodetector of the optical head device or divergent light emitted from a position equivalent to a point from among the plurality of light receiving points is used as the light to be applied there.

According to a sixteenth aspect of the present invention, a method for duplicating a diffraction grating, may include the step of configuring a diffraction grating based on calculation made through a computer for interference fringes equivalent to those of the diffraction grating in the first or third aspect of the present invention or a diffraction grating produced according to the method in the second, fourth or fifth aspect of the present invention, which comprises the grating part which is divided into the plurality of areas, for utilizing it as a first original hologram plate, and making the original hologram plate and a hologram recording material for duplication approximately in contact with one another; applying light thereto from the side of the original hologram plate, so as to expose the hologram recording material to interference fringes occurring as a result of 0-th light and 1-st diffracted light thus generated from the first original hologram plate being made to be applied to the hologram recording material so as to produce a second original hologram plate; making the second original hologram plate and a hologram recording material for duplication approximately in contact with one another; and applying light thereto from the side of the second original hologram plate, so as to expose the hologram recording material to interference fringes occurring as a result of 0-th light and 1-st diffracted light thus generated from the second original hologram plate being made to be applied to the hologram recording material so as to produce a diffraction grating, wherein, in case where the duplicating exposure wavelength is different from the light source wavelength of the optical head device, when the diffraction grating is produced as a result of the second original hologram plate and the hologram recording material for duplication being made approximately in contact with one another and the light being applied thereto from the side of the second original hologram plate, convergent light converging at a position, determined according to a difference between the duplicating exposure wavelength and the light source wavelength of the optical head device, corresponding to a point from among a plurality of light receiving points corresponding to a plurality of photo-detecting areas of the photodetector of the optical head device or divergent light emitted from a position, determined according to the difference between the duplicating exposure wavelength and the light source wavelength of the optical head device, corresponding to a point from among the plurality of light receiving points corresponding to the plurality of photo-detecting areas of the photodetector of the optical head device is used as the light to be applied there.

According to a seventeenth aspect of the present invention, the method for duplicating a diffraction grating in any of the sixth through sixteenth aspects of the present invention, when the duplicating exposure wavelength is different from the light source wavelength of the optical head device, the duplicating exposure may be performed with the use of an optical system for applying the light from the side of the original hologram plate configured so that the optical system provides aberration for canceling out aberration otherwise occurring due to the difference in wavelength of light applied between the duplicating operation and the reproduction operation in the optical head device.

According to an eighteenth aspect of the present invention, a method for duplicating a diffraction grating may include the step of using, as an original hologram plate, the diffraction grating in the first or third aspect of the present invention, a diffraction grating produced according to the method in the second, fourth or fifth aspect of the present invention, or a diffraction grating produced based on calculation made through a computer for interference fringes, and exposing a hologram recording material for duplication to interference fringes produced as a result of applying 0-th light or 1-st diffracted light, generated from the original hologram plate as a result of applying light thereto from the side of the original hologram plate, to the hologram recording material for duplication, via a relay optical system.

According to a nineteenth aspect of the present invention, in the method for duplicating a diffraction grating in the eighteenth aspect of the present invention, the relay optical system may be configured so that a surface on the original hologram plate and a surface on the hologram recording material for duplication have a relation of approximately conjugate planes in imaging.

According to a twentieth aspect of the present invention, in the method for duplicating a diffraction grating in the eighteenth or nineteenth aspect of the present invention, the relay optical system may comprise two lens systems, wherein a front-side focal point of a first lens system thereof closer to the original hologram plate may coincide with a surface of the original hologram plate, a rear-side focal point of the first lens system may be made coincident with a front-side focal point of a second lens system, and also, a rear-side focal point of the second lens system may coincide with a surface of the hologram recording material for duplication.

According to a twenty-first aspect of the present invention, in the method for duplicating a diffraction grating in any of the eighteenth through twentieth aspects of the present invention, when a diffraction grating is duplicated as a result of light being applied from the side of the original hologram plate, a wavelength of the duplication applying light may be in the vicinity of the light source wavelength of the optical head device, and, convergent light converging at a position equivalent to the light emitting point of the light source of the optical head device or divergent light emitted from the position equivalent to the light emitting point of the light source may be used as the light to be applied.

According to a twenty-second aspect of the present invention, in the method for duplicating a diffraction grating in any of the eighteenth through twentieth aspects of the present invention, when a diffraction grating is duplicated as a result of light being applied from the side of the original hologram plate, a wavelength of the duplication applying light may be different from the light source wavelength of the optical head device, and, convergent light converging at a position, determined according to a difference between the duplicating wavelength and the light source wavelength of the optical head device, corresponding to the light emitting point of the light source of the optical head device or divergent light emitted from the position, determined according to the difference between the duplicating wavelength and the light source wavelength of the optical head device, corresponding to the light emitting point may be used as the light to be applied.

According to a twenty-third aspect of the present invention, in the method for duplicating a diffraction grating in any of the eighteenth through twentieth aspects of the present invention, when a diffraction grating is duplicated as a result of light being applied from the side of the original hologram plate, a wavelength of the duplication applying light may be in the vicinity of the light source wavelength of the optical head device, and, convergent light converging at a position equivalent to a point from among a plurality of light receiving points corresponding to a plurality of photo-detecting areas of the photodetector of the optical head device or divergent light emitted from a position equivalent to a point from among the plurality of light receiving points may be used as the light to be applied.

According to a twenty-fourth aspect of the present invention, in the method for duplicating a diffraction grating in any of the eighteenth through twentieth aspects of the present invention, when a diffraction grating is duplicated as a result of light being applied from the side of the original hologram plate, a wavelength of the duplication applying light may be different from the light source wavelength of the optical head device, and, convergent light converging at a position, determined according to a difference between the duplicating wavelength and the light source wavelength of the optical head device, corresponding to a point from among a plurality of light receiving points corresponding to a plurality of photo-detecting areas of the photodetector of the optical head device or divergent light emitted from a position, determined according to a difference between the duplicating wavelength and the light source wavelength of the optical head device, corresponding to a point from among a plurality of light receiving points corresponding to a plurality of photo-detecting areas of the photodetector of the optical head device may be used as the light to be applied.

According to a twenty-fifth aspect of the present invention, in the method of duplicating a diffraction grating in any of the eighteenth through twenty-fourth aspects of the present invention, a spatial filter may be provided in the relay optical system for only transmitting 0-th light and one (+l-st or −1-st) of 1-st diffracted light applied from the original hologram plate and blocking diffracted light in the other orders.

According to a twenty-sixth aspect of the present invention, in the method of duplicating a diffraction grating in any of the twenty-first through twenty-fifth aspects of the present invention, a plane including a converging point or a diverging point of the duplication applying light for the original hologram plate and perpendicular to an optical axis of the relay optical system and a plane including imaging points of light emitted from these points through the relay optical system and perpendicular to the optical axis may have a relation of conjugate planes in imaging by the relay optical system.

According to a twenty-seventh aspect of the present invention, in the method of duplicating a diffraction grating in any of the twenty-first through twenty-sixth aspects of the present invention, an imaging magnification to the hologram recording material for duplication by the relay optical system from the original hologram plate surface to the surface may be equal to an imaging magnification to the imaging point of light by the relay optical system from a converging point or a diverging point of the duplication applying light.

According to a twenty-eighth aspect of the present invention, in the method of duplicating a diffraction grating in any of the sixth through twenty-seventh aspects of the present invention, the diffraction grating obtained through the duplication may be a volume phase diffraction grating including liquid crystal material in the hologram recording material for duplication.

According to a twenty-ninth aspect of the present invention, in the method of duplicating a diffraction grating in any of the sixth through twenty-eighth aspects of the present invention, the diffraction grating in the original hologram plate, or the diffraction grating in each of the first and second original hologram plates may be a volume phase diffraction grating.

According to a thirtieth aspect of the present invention, in the method of duplicating a diffraction grating in the twenty-ninth aspect of the present invention, the diffraction grating in the original hologram plate, or the diffraction grating in each of the first and second original hologram plates may have a diffraction efficiency equal between for 0-th light and for +1-st diffracted light

According to a thirty-first aspect of the present invention, in the method of duplicating a diffraction grating in any of the sixth through twenty-eighth aspects of the present invention, the diffraction grating in the original hologram plate or the diffraction grating in each of the first and second original hologram plates is a surface relief diffraction grating.

According to a thirty-second aspect of the present invention, in the method of duplicating a diffraction grating in the thirty-first aspect of the present invention, the diffraction grating in the original hologram plate or the diffraction grating in each of the first and second original hologram plates may have a diffraction efficiency equal between for 0-th light and for +1-st diffracted light.

According to a thirty-third aspect of the present invention, the method of duplicating a diffraction grating in any of the sixth through seventeenth aspects and the twenty-eighth through thirty-second aspects, may include the steps of providing an original hologram plate having a plurality of the diffraction gratings each having the plurality of divided areas approximately in contact with a hologram recording material for duplication, exposing the hologram recording material to interference fringes made from 0-th light and 1-st diffracted light generated from a single diffraction grating of the original hologram plate as a result of light being applied from the side of the original hologram plate to the single diffraction grating; relatively moving the original hologram plate, the hologram recording material for duplication and the light for the exposure by a predetermined amount after the exposure; and repeating the step of exposure and the step of moving alternately a plurality of times.

According to a thirty-fourth aspect of the present invention, the method of duplicating a diffraction grating in any of the sixth through seventeenth aspects and the twenty-eighth through thirty-second aspects, may include the steps of: providing an original hologram plate having a plurality of the diffraction gratings each having the plurality of divided areas approximately in contact with a hologram recording material for duplication, exposing the hologram recording material to interference fringes made from 0-th light and 1-st diffracted light generated from respective diffraction gratings of the original hologram plate as a result of light being applied from the side of the original hologram plate to the plurality diffraction gratings simultaneously from among the plurality of diffraction gratings included in the original hologram plate; relatively moving the original hologram plate, the hologram recording material for duplication and a light for the exposure by a predetermined amount after the exposure; and repeating the step of exposure and the step of moving alternately a plurality of times.

According to a thirty-fifth aspect of the present invention, the method of duplicating a diffraction grating in any of the sixth through seventeenth aspects and the twenty-eighth through thirty-second aspects, may include the steps of: providing an original hologram plate having a plurality of the diffraction gratings each having the plurality of divided areas approximately in contact with a hologram recording material for duplication, and exposing the hologram recording material to interference fringes made from 0-th light and 1-st diffracted light generated from the respective diffraction gratings of the original hologram plate as a result of light being applied from the side of the original hologram plate to the plurality diffraction gratings simultaneously so as to expose the hologram recording material for duplication for the plurality of diffraction gratins included in the original hologram plate in a lump.

According to a thirty-sixth aspect of the present invention, the method of duplicating a diffraction grating in any of the eighteenth through thirty-second aspects of the present invention may include the steps of: disposing an original hologram plate having a plurality of the diffraction gratings each having the plurality of divided areas recorded therein and a hologram recording material for duplication with the relay optical system inserted therebetween, and exposing the hologram recording material to interference fringes made from 0-th light and 1-st diffracted light generated from a single diffraction grating of the original hologram plate as a result of light being applied from the side of the original hologram plate to the diffraction grating; and relatively moving the original hologram plate, the hologram recording material for duplication and a light for the exposure by a predetermined amount after the exposure; and repeating the step of exposure and the step of moving alternately a plurality of times.

According to a thirty-seventh aspect of the present invention, the method of duplicating a diffraction grating in any of the eighteenth through thirty-second aspects of the present invention may include the steps of: disposing an original hologram plate having a plurality of the diffraction gratings each having the plurality of divided areas recorded therein and a hologram recording material for duplication with the relay optical system inserted therebetween, exposing the hologram recording material to interference fringes made from 0-th light and 1-st diffracted light generated from respective diffraction gratings of the original hologram plate as a result of light being applied from the side of the original hologram plate to the plurality of diffraction gratings from among the plurality of diffraction gratings of the original hologram plate; and moving relatively the original hologram plate, the hologram recording material for duplication and a light for the exposure by a predetermined amount after the exposure; and repeating the step of exposure and the step of moving alternately a plurality of times.

According to a thirty-eighth aspect of the present invention, the method of duplicating a diffraction grating in any of the eighteenth through thirty-second aspects of the present invention may include the steps of: disposing an original hologram plate having a plurality of the diffraction gratings each having the plurality of divided areas recorded therein and a hologram recording material for duplication with the relay optical system inserted therebetween, and exposing the hologram recording material to interference fringes made from 0-th light and 1-st diffracted light generated from the respective diffraction gratings of the original hologram plate as a result of light being applied from the side of the original hologram plate to the plurality of diffraction gratings thereof so as to expose the hologram recording material for duplication for the plurality of diffraction gratings included in the original hologram plate in a lump.

According to a thirty-ninth aspect of the present invention, the diffraction grating same as that in the first aspect of the present invention may be produced as a result of the method of duplicating a diffraction grating in any of the sixth through thirty-eighth aspects of the present invention being performed.

According to a fortieth aspect of the present invention, an optical head device leads light from a light source to an optical system, converges the light to a recording medium by a converging lens, detects reflected light from the recording medium by a photodetector and thus performs recording, reproduction or both recording and reproduction of information to or from the recording medium. In the optical system, the diffraction grating, which may be one in the first or third aspect of the present invention, one produced according to the method in any of the second, fourth and fifth aspects of the present invention, or one in the thirty-ninth aspect of the present invention, and a ¼ wavelength plate are provided on a light path, and the reflected light from the recording medium is received by the photodetector after branching off by means of the diffraction grating.

According to a forty-first aspect of the present invention, in the optical head device in the fortieth aspect of the present invention, the light source, the photodetector and the diffraction grating may be integrated into a unit.

According to a forty-second aspect of the present invention, an optical head device leads light from a plurality of light sources to an optical system through a common coupling lens, converges the light to a recording medium by a converging lens, detects reflected light from the recording medium by a photodetector and thus performs recording, reproduction or recording and reproduction of information to or from the recording medium. In the optical system, the diffraction grating, which may be one in the first or third aspect of the present invention, one produced according to the method in the second, fourth or fifth aspect of the present invention, or one in the thirty-ninth aspect of the present invention, and a ¼ wavelength plate are provided on a light path, and the reflected light from the recording medium is received by the common photodetector after branching off by means of the diffraction grating.

According to a forty-third aspect of the present invention, in the optical head device in the forty-second aspect of the present invention, the plurality of light sources, the photodetector and the diffraction grating may be united.

According to a forty-fourth aspect of the present invention, an optical disk drive apparatus may employ an optical head device in any of the fortieth through forty-third aspects of the present invention for performing recording, reproduction or both recording and reproduction of information to or from a recording medium.

In the diffraction grating according to the first aspect of the present invention, since the grating part is divided into the plurality of areas and each area is formed through two-beam interference exposure, it is possible to achieve increase in the efficiency in the one (+1-st) of diffraction and also reduction in the grating pitch in the diffraction grating to be applied in the optical head for an optical disk.

In the diffraction grating according to the second aspect of the present invention, by producing the hologram diffraction grating through interference exposure as a result of each area of the plurality of divided areas of the grating part being produced individually, it becomes possible to detect therethrough a focus error signal, a track error signal, an RF signal and so forth which are required in the optical head device.

In the diffraction grating or the method for producing a diffraction grating according to any of the third through fifth aspects of the present invention, even when the hologram recording material has no recording sensitivity in a wavelength used by the optical head, it becomes possible to record a hologram by a wavelength in which the recording sensitivity exists. Furthermore, it is possible to provide a hologram diffraction grating having a high efficiency more than 80% and having satisfactory homogeneity there in which aberration otherwise occurring due to the difference in wavelength between recording operation and reproduction operation is well controlled, thus it is possible to apply light without aberration to the photodetector when the diffraction grating is used in the optical head, and Bragg requirements can be satisfied throughout the whole area of the hologram.

In the method of duplicating a diffraction grating according to the sixth aspect of the present invention, it becomes possible to duplicate a hologram diffraction grating with a high efficiency and a well reduced pitch for an optical head device with the use of the diffraction grating according to the first aspect of the present invention as the original hologram plate for a large number of products thereof with a simple configuration, and thus, it becomes possible to effectively reduce the costs through the mass production.

In the method of duplicating a diffraction grating according to the seventh aspect of the present invention, in a method of duplicating a diffraction grating through exposure with the use of the original hologram plate of the diffraction grating (for example, an original hologram plate), the original hologram plate is produced with the use of interference fringes (hologram (CGH: computer generated hologram) produced artificially through calculation performed by a computer. Thereby, many advantage can be obtained, i.e., the divided areas of the diffraction grating can be freely set easily, there occurs no problem of aberration generation due to difference between the original hologram plate producing wavelength and the wavelength applied when the diffraction grating is mounted in the optical head device (as a result of the wavelength at which the interference fringes are calculated being made coincident with the wavelength applied in the optical head device), and so forth.

In the method of duplicating a diffraction grating according to the eighth or tenth aspect of the present invention, since a configuration is provided such that a hologram diffraction grating obtained from exposure duplication from the original hologram plate for the diffraction grating (original hologram plate) has no aberration and also Bragg requirements are satisfied throughout the whole area of the hologram, it is possible to provide a hologram diffraction grating having a high efficiency more than 80%, and having satisfactory homogeneity.

In the method of duplicating a diffraction grating according to the ninth or eleventh aspect of the present invention, even when a hologram recording material has no recording sensitivity in the wavelength used by the optical head (light source wavelength), it becomes possible to duplicate a hologram from an original hologram plate by a wavelength at which the recording sensitivity exists. Also, it is possible to control aberration otherwise occurring due to the above-mentioned difference between the wavelength in the duplication and the light source wavelength of the optical head device so as to provide a hologram diffraction grating satisfying Bragg requirements throughout the whole area of the hologram, having a high efficiency more than 80% and having satisfactory homogeneity.

In the method of duplicating a diffraction grating according to the twelfth aspect of the present invention, in addition to the advantage obtained from the sixth aspect of the present invention, since a configuration is provided such that, especially, diffracted light used for detecting a focus error signal has no aberration, it is possible to provide a hologram diffraction grating by which a satisfactory focus error signal having no focus offset can be obtained when it is applied in the optical head device.

In the method of duplicating a diffraction grating in the thirteenth or fifteenth aspect of the present invention, it becomes possible to optimize the original hologram plate used in the duplicating process in such a manner in which the first original hologram plate is a primary original hologram plate produced through photolithography, electron beam lithography or such suitable for production of a computer generated hologram while the second original hologram plate is an original hologram plate from which duplication exposure is available through which a final product of a hologram diffraction grating is obtained to be applied in the optical head device having a high diffraction efficiency. In other words, by using the two original hologram plates, it becomes possible to provide a final hologram diffraction grating with a high diffraction efficiency from duplication of the computer generated hologram.

In the method of duplicating a diffraction grating according to the fourteenth or sixteenth aspect of the present invention, in addition to the advantage obtained from the thirteenth aspect of the present invention, even when a hologram recording material has no recording sensitivity in a wavelength used by an optical head device (light source wavelength), it becomes possible to duplicate a hologram from an original hologram plate by a wavelength in which the recording sensitivity exists. Also, it is possible to control aberration occurring due to the above-mentioned difference between the wavelength in the duplication and the light source wavelength of the optical head device so as to provide a hologram diffraction grating satisfying the Bragg requirements throughout the whole area of the hologram, having a high efficiency more than 80% and having satisfactory homogeneity.

In the method of duplicating a diffraction grating according to the seventeenth aspect of the present invention, in case where a difference between the duplicating wavelength and the wavelength used in the optical head device increases, it becomes possible to control aberration generation due to the difference in the wavelength, and thus, it becomes possible to apply light without aberration to a photodetector when the diffraction grating resulting therefrom is applied in the optical head device.

In the method of duplicating a diffraction grating according to the eighteenth or nineteenth aspect of the present invention, in case of obtaining a hologram through duplication, it is possible to perform the duplication in a condition in which an original hologram plate and a hologram recording material for duplication should not be disposed in a mutual contact condition but may be disposed separately spatially. Accordingly, it becomes possible to avoid problems which would otherwise occur in case of duplication performed in a mutual contact condition. In case of duplication performed in a mutual contact condition, the following problems might occur: In order to reduce a gap between the original hologram plate and the hologram recording material for duplication, it would be necessary to considerably reduce the thickness of the original hologram plate or a cover glass of the hologram recording material; In order to avoid unnecessary interference fringes occurring due to multiple reflection between the original hologram plate and the hologram recording material disposed in the mutual contact condition, it would be necessary to insert a refractive index matching liquid therebetween or so. According to the present invention, since it is not necessary to perform the duplication process in the mutual contact condition, it becomes possible to provide a hologram diffraction grating with a high quality without using the above-mentioned cover glass considerably reduced in the thickness, the refractive index matching liquid or such. Furthermore, since the original hologram plate is not caused to be in contact with the hologram recording material for duplication, there occurs no damage in the original hologram plate otherwise occurring due to collision therebetween during many times of the duplication operations.

In the method of duplicating a diffraction grating according to the twentieth aspect of the present invention, it should not be necessary to make the scale of the original hologram plate coincide with that of a final product of a hologram, and thus, the degree of freedom in producing the original hologram plate increases.

In the method of duplicating a diffraction grating according to the twenty-first or twenty-second aspect of the present invention, in duplication for a hologram diffraction grating to be used for an optical head device with the use of a relay optical system, it is possible to produce a diffraction grating which has no aberration for a photodetector in case where it is applied in an optical head device, and also, which can provide diffracted light at a high diffraction efficiency.

In the method of duplicating a diffraction grating according to the twenty-second or twenty-fourth aspect of the present invention, a hologram diffraction grating can be obtained from duplication even without disposing an original hologram plate and a hologram recording material for duplication in a mutual contact condition with the use of a relay optical system. Also, even when the recording materiel for duplication has no recording sensitivity in a wavelength of an optical head device, it is possible to perform recording in a wavelength in which the recording sensitivity exists, and also, it is possible to produce a diffraction grating which can generate diffracted light not including aberration for a photodetector and also having a high diffraction efficiency in case where it is applied in the optical heads device.

In the method of duplicating a diffraction grating according to the twenty-fifth aspect of the present invention, even when diffracted light other than 0-th and 1-st diffracted light which is required for an original hologram plate occurs, it is possible to extract only the 0-th light and the 1-st diffracted light required and to perform interference exposure of a hologram recording material for duplication only with these necessary two beams. Accordingly, a hologram thus obtained does not generate useless diffracted light, and thus, it is possible to provide a hologram diffraction grating having a high efficiency to be used for an optical head device.

In the method of duplicating a diffraction grating according to the twenty-sixth or twenty-seventh aspect of the present invention, in addition to the advantages obtained from the twenty-first through twenty-fifth aspects of the present invention, wavefronts of 0-th light and 1-st diffracted light generated from the original hologram plate are accurately projected onto a hologram recording material for duplication, and thus, it is possible to provide a hologram diffraction grating similar to the original hologram plate accurately through duplication.

In the method of duplicating a diffraction grating according to the twenty-eighth aspect of the present invention, by using a volume phase hologram recording material for duplication including liquid crystal, it is possible to produce a polarization diffraction grating having high transmittance for a going light path and having a high diffraction efficiency for a returning light path. Then, when using it for an optical head device, it is possible to provide the optical head device in a reduced size and a reduced weight by which high speed recording and high speed reproduction are achieved.

In the method of duplicating a diffraction grating according to the twenty-ninth aspect of the present invention, since a volume phase diffraction grating is used as an original hologram plate for a diffraction grating, it is possible to perform the duplication with the use of the original hologram plate which is ideal so as not to generate diffracted light other than 0-th light and 1-st diffracted light.

In the method of duplicating a diffraction grating according to the thirtieth aspect of the present invention, in addition to the advantages obtained from the twenty-ninth aspect of the present invention, by well controlling an exposing amount in the interference exposure in production of the original hologram plate, it becomes possible to make the intensity approximately equal between 0-th light and +1-st diffracted light. Then, by performing the duplication according to any of the sixth through twenty-eighth aspects of the present invention with the use of this diffraction grating original hologram plate, it becomes possible to maximize contrast in interference fringes in the duplication exposure, and thus, to produce a duplicated diffraction grating having a high efficiency.

In the method of duplicating a diffraction grating according to the thirty-first aspect of the present invention, since a surface relief diffraction grating is used as the original hologram plate in the method according to any of the sixth through twenty-eight aspects of the present invention, it becomes possible to make the intensity approximately equal between 0-th light and 1-st diffracted light, and thus, it is possible to achieve a diffraction grating suitable as an original hologram plate.

In the method of duplicating a diffraction grating according to the thirty-second aspect of the present invention, in case where a surface relief diffraction grating is used as the original hologram plate, by especially using 0-th light and 1-st diffracted light and making the intensity approximately equal therebetween, it becomes possible to well control generation of the other diffracted light. Accordingly, by using this original hologram plate in the duplication, it becomes possible to maximize interference fringe contrast in the duplication exposure, and thus, to produce a duplicated diffraction grating having a high efficiency.

In the method of duplicating a diffraction grating according to the thirty-third aspect of the present invention, since it becomes possible to duplicate a plurality of hologram diffraction gratings disposed in an original hologram plate at the same time on a hologram recording material for duplication, mass production is achieved, and thus, the production costs can be reduced.

In the method of duplicating a diffraction grating according to the thirty-fourth aspect of the present invention, advantages same as those obtained from the thirty-third aspect of the present invention can be obtained, and also, it is possible to reduce the number of processes required in comparison to the thirty-third aspect of the present invention. Thus, it becomes possible to achieve mass production further efficiently and thus, to further reduce the production costs.

In the method of duplicating a diffraction grating according to the thirty-fifth aspect of the present invention, advantages same as those obtained from the thirty-third or thirty-fourth aspect of the present invention can be obtained, and also, it is possible to further reduce the number of processes required in comparison to the thirty-fourth aspect of the present invention. Thus, it becomes possible to achieve mass production further efficiently and thus, to further reduce the production costs.

In the method of duplicating a diffraction grating according to the thirty-sixth aspect of the present invention, since it becomes possible to duplicate many hologram diffraction gratings on the original hologram plate on a hologram recording material for duplication without making the original hologram plate in contact with the hologram recording material, mass production is made possible efficiently, and thus, the production costs can be reduced.

In the method of duplicating a diffraction grating according to the thirty-seventh aspect of the present invention, the duplication is made possible without making the original hologram plate and the hologram recording material in contact with one another, the number of processed required for the duplication can be reduced and also, it becomes possible to achieve mass projection further efficiently, and to further reduce the production costs.

In the method of duplicating a diffraction grating according to the thirty-eighth aspect of the present invention, the duplication is made possible without making the original hologram plate and the hologram recording material in contact with one another, the number of processed required for the duplication can be further reduced in comparison to the thirty-seventh aspect of the present invention, and also, it becomes possible to achieve mass projection further efficiently, and to further reduce the production costs.

In the method of duplicating a diffraction grating according to the thirty-ninth aspect of the present invention, since a diffraction grating is produced in the method according to any of the sixth through thirty-eighth aspects of the present invention, the advantages obtained from the first or third aspect of the present invention are also obtained, and thus, it becomes possible to achieve a diffraction grating for which mass production is made possible and production costs can be reduced.

In the optical head device according to the fortieth aspect of the present invention, by using the diffraction grating (especially, a polarization diffraction grating) according to any of the first through thirty-ninth aspects of the present invention, in case where the diffraction grating is to be made closer to a light source so as to miniaturize a configuration including the light source and a photodetector, miniaturization of the grating pitch is made possible, the optical head device having a high detection efficiency is achievable, and high speed recording/high speed reduction can be achieved.

In the optical head device according to the forty-first aspect of the present invention, by uniting/integrating a light source, a photodetector and a diffraction grating into a unit configuration, it becomes possible to effectively reduce a time required for the assembly of the optical head device since the light source, the photodetector and the diffraction gratin are united already. Also, an adjustment work for the optical system therein can be made simpler.

In the optical head device according to the forty-second aspect of the present invention, by using the diffraction grating (especially, a polarization diffraction grating) according to any of the first through thirty-ninth aspects of the present invention in combination with light sources of a plurality of wavelengths, in case where the diffraction grating is to be made closer to the light sources so as to miniaturize a configuration including the plurality of light sources and a photodetector, miniaturization of the grating pitch is made possible, the optical head device having a high detection efficiency is achievable, and the optical head device performing high speed recording/high speed reduction can be achieved.

In the optical head device according to the forty-third aspect of the present invention, by uniting the plurality of light sources in the plurality of wavelengths, a photodetector and a diffraction grating into a unit configuration, it becomes possible to effectively reduce a time required for the assembly of the optical head device since the plurality of light sources with the plurality of wavelengths, the photodetector and the diffraction gratin are united already. Also, an adjustment work for the optical system therein can be made simpler.

In the optical disk drive apparatus according to the forty-fourth aspect of the present invention, by mounting the optical head device according to any of the fortieth through forty-third aspects of the present invention, it becomes possible to achieve the optical disk drive apparatus in which stable signal detecting is performed, and recording speed and reproduction speed can be increased.

Furthermore, by providing a plurality of light sources in different wavelengths in the optical head device in the optical disk drive apparatus, it becomes possible to achieve the optical disk drive apparatus by which information recording and reproduction is performed for optical disks having a plurality of different standards applying different wavelengths such as optical disks in a CD family or a DVD family, a high density optical disk requiring a blue semiconductor laser light source and so forth.

### BRIEF DESCRIPTION OF THE DRAWINGS

Other objects and further features of the present invention will become more apparent from the following detailed description when read in conjunction with the following accompanying drawings:

FIGS. 1A and 1B illustrate a relationship between a plurality of diffraction grating areas divided in a grating part of a diffraction grating;

FIG. 2 illustrates a method of producing of a sector (1) in the diffraction grating shown in FIG. 1A;

FIGS. 3A, 3B and 3C illustrate examples of sector masks used for producing the diffraction grating shown in FIG. 1A;

FIG. 4 illustrates a method of producing of a sector (2) in the diffraction grating shown in FIG. 1A;

FIG. 5 illustrates a method of producing of a sector (3) in the diffraction grating shown in FIG. 1A;

FIG. 6 illustrates another method of producing the diffraction grating shown in FIG. 1A;

FIG. 7 illustrates a state in which the hologram diffraction grating configured as shown in FIG. 1A is used in an optical head device same as that shown in FIG. 33;

FIG. 8 illustrates a method of duplicating a diffraction grating in one embodiment of the present invention;

FIG. 9 shows a plan view of an original hologram plate produced based on data calculated by a computer;

FIG. 10 shows an example of an arrangement for duplicating a hologram diffraction grating on a hologram recording material for duplication with the use of the original hologram plate shown in FIG. 9;

FIG. 11 shows a result of comparison in diffraction efficiency between a diffraction grating in an embodiment of the present invention and one in the related art;

FIG. 12 shows a method of duplicating a diffraction grating in another embodiment of the present invention;

FIG. 13 shows a method of duplicating a diffraction grating in another embodiment of the present invention;

FIG. 14 shows a grating sectional view of one example of a volume phase diffraction grating;

FIG. 15 shows a relationship between an exposing amount in interference exposure and a diffraction efficiency when a volume phase diffraction grating is produced with the use of interference exposure;

FIG. 16 shows a rough sectional view of a part of one example of a surface relief diffraction grating;

FIG. 17 shows a rough sectional view of a part of another example of a surface relief diffraction grating;

FIG. 18 shows a rough sectional view of a part of another example of a surface relief diffraction grating;

FIG. 19 shows a rough sectional view of a part of another example of a surface relief diffraction grating;

FIG. 20 shows a rough sectional view of a part of another example of a surface relief diffraction grating;

FIG. 21 shows a plan view of one example of an original hologram plate having a configuration in which many hologram diffraction gratings are disposed on a common substrate;

FIG. 22 shows a method of duplicating a diffraction grating using an original hologram plate shown in FIG. 21 in one embodiment of the present invention;

FIG. 23 shows a method of duplicating a diffraction grating using an original hologram plate shown in FIG. 21 in another embodiment of the present invention;

FIG. 24 shows a method of duplicating a diffraction grating using an original hologram plate shown in FIG. 21 in another embodiment of the present invention;

FIGS. 25A, 25B, 25C and 25D illustrate a duplication process according to the duplication method shown in FIG. 24;

FIG. 26 illustrates a method of duplicating a diffraction grating in another embodiment of the present invention using the original hologram plate shown in FIG. 21;

FIG. 27 illustrates a method of duplicating a diffraction grating in another embodiment of the present invention using the original hologram plate shown in FIG. 21;

FIG. 28 illustrates a general configuration of an optical head device in one embodiment of the present invention;

FIG. 29 illustrates a general configuration of an optical head device in another embodiment of the present invention;

FIG. 30 illustrates a general configuration of an optical head device in another embodiment of the present invention;

FIG. 31 illustrates a general configuration of an optical head device in another embodiment of the present invention;

FIG. 32 shows a block diagram of an optical disk drive apparatus in one embodiment of the present invention;

FIG. 33 shows a general configuration of one example of an optical disk device in the related art;

FIG. 34 illustrates a rough sectional view of one example of a diffraction grating in the related art used in the optical head device shown in FIG. 33;

FIG. 35 shows a diffraction efficiency on +1-st diffracted light with respect to an incidence angle in a polarization diffraction grating shown in FIG. 34;

FIG. 36 shows another method of producing a diffraction grating shown in FIG. 1A;

FIG. 37 shows another method of producing a diffraction grating shown in FIG. 1A;

FIG. 38 illustrates a two-beam interference exposure in case where different wavelengths are applied;

FIGS. 39 through 43, 44A, 44B and 45 through 53 illustrate methods of duplicating a diffraction grating in other embodiments according to the present invention, respectively;

FIG. 54 illustrates a relationship between a grating depth and a diffraction efficiency in a surface relief diffraction grating; and

FIGS. 55 through 62 illustrate methods of duplicating a diffraction grating in other embodiments according to the present invention, respectively.

### DESCRIPTION OF THE PREFERRED EMBODIMENTS

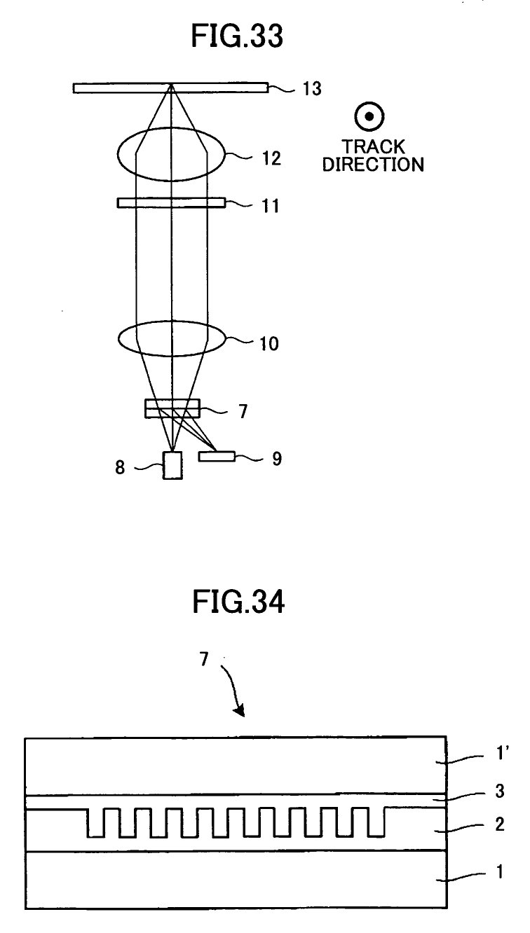

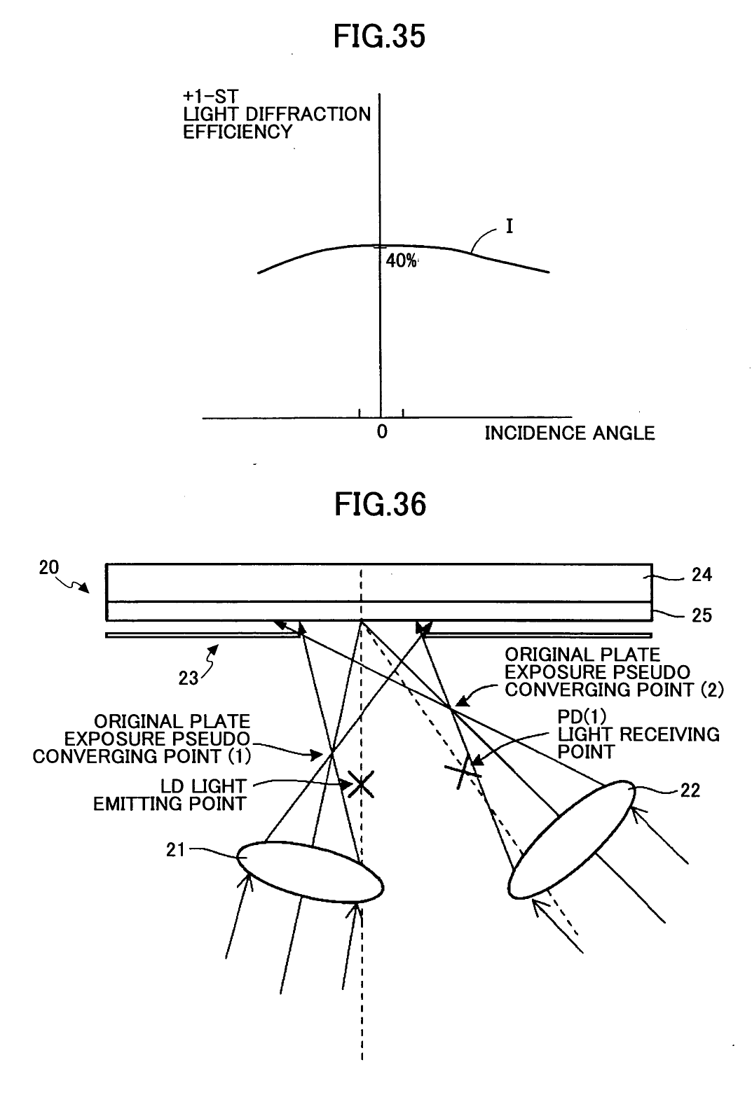

A first embodiment according to the first and second aspects of the present invention will now be described. Description is then made taking an example of a diffraction grating disposed at a position same as a position of the diffraction grating 7 in the optical head device described above with reference to FIG. 33.

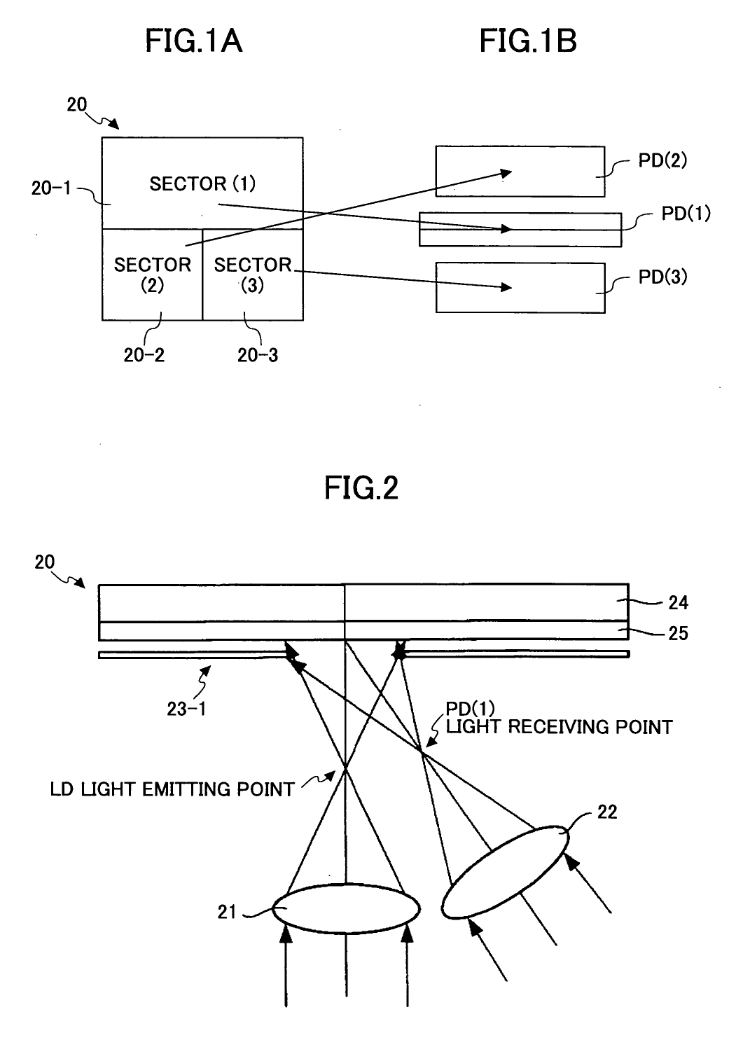

FIGS. 1A and 1B illustrate a relationship between a plurality of diffraction grating areas in a grating part of a diffraction grating in an embodiment of the present invention and photo-detecting areas in a photodetector in the optical head device. As shown in FIG. 1A, in the diffraction grating 20 according to the embodiment of the present invention, the grating produced in a substrate is divided into a plurality of diffraction grating areas, i.e., sectors (1), (2) and (3) 20-1, 20-2 and 20-3, respectively, in this example. As shown in FIG. 1B, the photodetector has three photo-detecting areas PD(1), PD(2) and PD(3) corresponding to the above-mentioned sectors (1), (2) and (3), respectively. However, the example shown is one of typical embodiments, manners of spatial division in the diffraction grating and the photodetector are not limited thereto.

In this configuration, light diffracted through the diffraction grating area 20-1 (sector (1)) is converged on a line which divides the photo-detecting area PD(1) into two areas, as shown, whereby focus detecting according to a knife edge method is performed. Diffracted light beams exiting the sectors (2) and (3), i.e., 20-2 and 20-3, are received by the PD(2) and PD(3), respectively, whereby track detection is performed according to a push-pull method.

A method of producing the diffraction grating shown in FIG. 1A is described next with reference to FIG. 2. As shown, on a transparent substrate 24, a hologram recording material 25 is formed. In close proximity to the hologram recording material 25, a sector mask 23-1 is disposed. Although not shown, coherent laser light emitted from a laser light source such as a gas laser, a solid laser, a semiconductor laser (LD) or such is divided into two beams by means of a half mirror or such, and then, one of the two beams is applied to a first lens 21 whereby the applied light is converged. At this time, a point of the converging is a point equivalent to a position of light emission (LD light emitting point) from a light source (LD) 8 in the optical head device shown in FIG. 33. Thereby, the light which becomes equivalent to light emitted from the light emitting point of the light source 8 in the optical head device, is applied to the hologram recording material 25.

The other one (laser light) of the two beams divided by the half mirror as mentioned above is applied to a second lens 22 whereby the light is converged. A point of converging at this time is equivalent to a light receiving point on the photo-detecting area PD(1) in the photodetector 9 in the optical head device shown in FIG. 33. Thereby, the light which is emitted from a point equivalent to the light receiving point of the photo-detecting area PD(1) in the photodetector 9 of the optical head device, is applied to the hologram recording material 25. As a result, the light beam applied from the first lens 21 and the light beam applied from the second lens 22 gather one another on the hologram recording material 25, as shown. Thereby, the hologram recording material 25 is exposed by interference fringes produced therewith in a two-beam interference exposing manner.

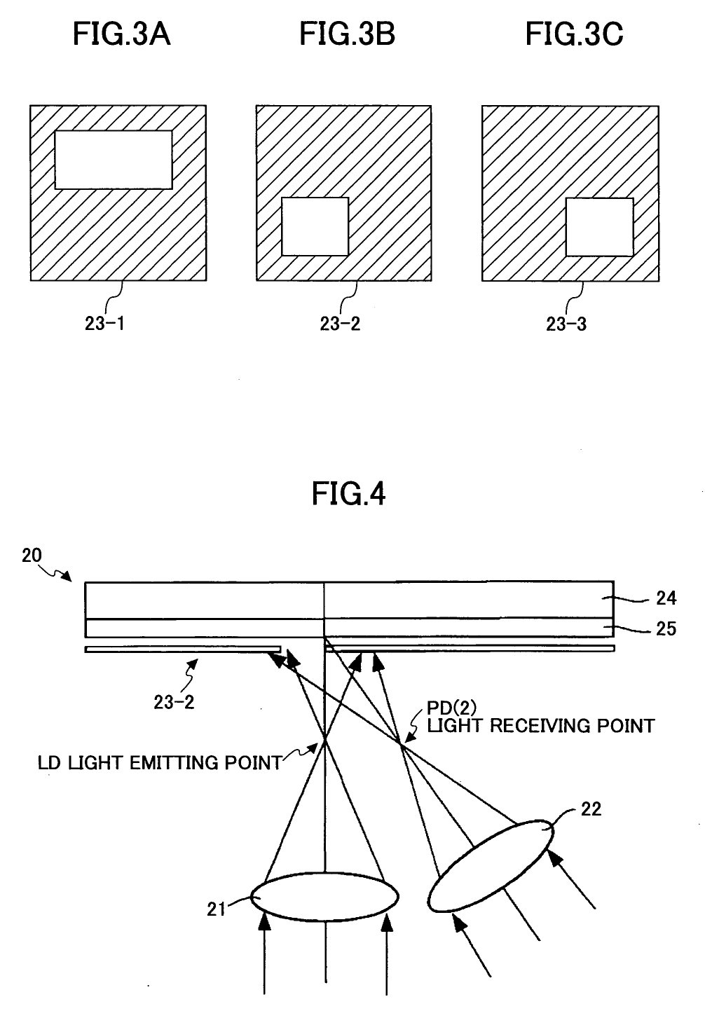

At the time of the exposure, the sector mask is disposed immediately before the hologram recording material 25, and thereby, each of areas of the sectors (1) through (3) are defined. In other words, sector masks 23-1, 23-2 and 23-3 such as those shown in FIGS. 3A through 3C are prepared, each of which is an aperture mask which blocks an area other than the relevant sector area of the diffraction grating.

For example, FIG. 2 shows an example in which the sector (1) is recorded onto the hologram recording material 25. At this time, the sector mask 23-1 shown in FIG. 3A is applied, and therewith, the above-mentioned two-beam interference exposure is performed. FIG. 4 illustrates one example of arrangement for recording the sector (2). At this case, the sector mark 23-2 shown in FIG. 3B is disposed as shown. Then, divergent light from a point equivalent to the light receiving point on the photo-detecting area PD(2) and divergent light from a point equivalent to the light emitting point on the light source are used to perform the two-beam interference exposure, the same as in the case of the sector (1) described above.

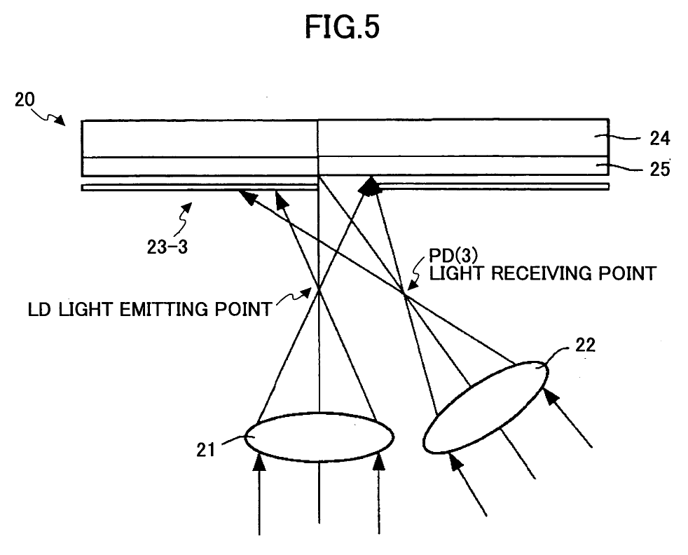

FIG. 5 illustrates one example of arrangement for recording the sector (3). At this case, the sector mark 23-3 shown in FIG. 3C is disposed as shown. Then, divergent light from a point equivalent to the light receiving point on the photo-detecting area PD(3) and divergent light from a point equivalent to the light emitting point on the light source are used to perform the two-beam interference exposure, the same as in the case of the sector (1) described above.

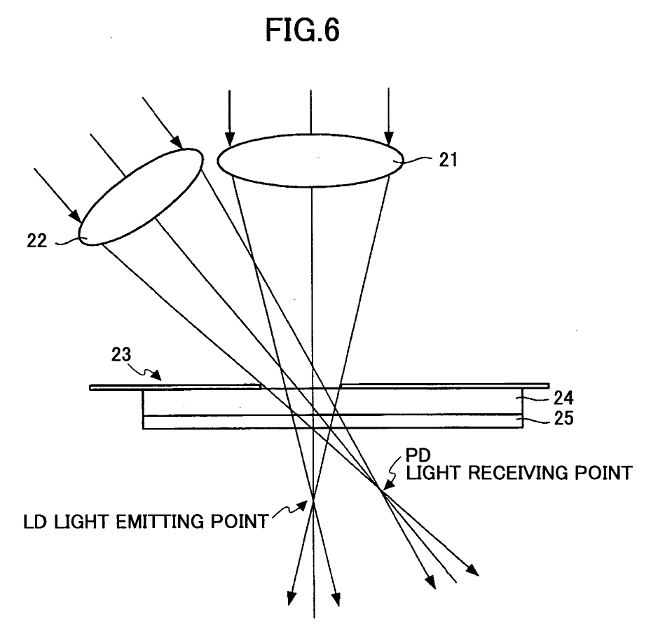

Other than the above-mentioned two-beam interference exposure with the use of the two different beams, a method of two-beam interference exposure with the use of two convergent beams may be applied instead as shown in FIG. 6. In this case, as shown, a light source, a half mirror (both not shown) and lenses 21 and 22 are disposed on the rear side of the substrate 24 while the hologram recording material 25 is formed on the front side of the same. Then, by means of the first lens 21, convergent light (convergent beam) is produced which converges at a point equivalent to the light emitting point on the LD acting as the light source 8 in the optical head device shown in FIG. 33, while, by means of the second lens 22, convergent light (convergent beam) is produced which converges at a point equivalent to the light receiving point on the photo-detecting area (PD(1), PD(2) or PD(3)) of the photodetector 9 in the optical head device shown in FIG. 33. The thus-produced two convergent beams are made to cause interference on the hologram recording material 25, and thus, recording is performed on the hologram recording material 25 therewith. At this time, a sector mask 23 same as any of the sector masks 23-1 through 23-3 shown in FIGS. 3A through 3C is disposed in contact with the substrate 24 while the hologram recording material 25 is formed on the other side of the same as shown, whereby the relevant divided area of the diffraction grating is defined.

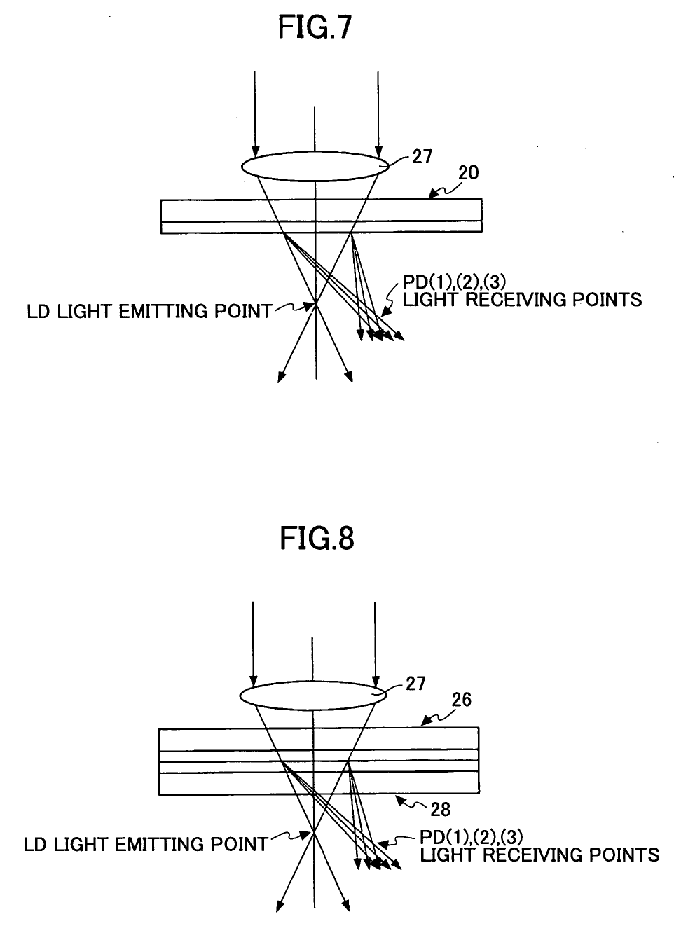

In such a method, the hologram diffraction grating used for the optical head device can be produced in which the grating part is divided into the plurality of areas. FIG. 7 illustrates a state in which the thus-produced hologram diffraction grating is used in an optical head device having a configuration same as that shown in FIG. 33. Reflected light from an optical disk not shown converges at a light emitting point of a semiconductor laser (LD) (not shown) acting as a light source through a collimator lens 27 acting as a coupling lens. At this time, since a beam corresponding to one beam of the two beams applied in the two-beam interference exposure is applied to the hologram diffraction grating 20, +1-st diffracted light is efficiently generated from the hologram diffraction grating 20, and, as shown in FIGS. 1A and 1B, diffracted light (beams) diffracted by means of the respective divided areas (sectors (1), (2) and (3)) included in the hologram diffraction grating 20 converges at the respective photo-detecting areas PD(1), PD(2) and PD(3) on the photodetector. As a result, the diffracted light is received by the photodetector properly.

A second embodiment according to the third aspect of the present invention is described next.

In the above-described first embodiment, the recording wavelength for the hologram diffraction grating is approximately equal to the operation wavelength (light source wavelength) when it is used in the optical head device. However, according to the second embodiment, the recording wavelength in the duplicating exposure and the operation wavelength of the optical head device are different from one another. FIG. 36 shows a case where the recording wavelength in the duplication exposure for the hologram diffraction grating is longer than the operation wavelength in the optical head device.

When these wavelengths are different from one another, a first lens 21 is used to converge the beam at an original plate exposure pseudo converging point (1) corresponding to the light source light emitting point (LD light emitting point) in the optical head device, and a beam emitting from this original plate exposure pseudo converging point (1) is generated. On the other hand, a second lens 22 is used to converge the beam at an original plate exposure pseudo converging point (2) corresponding to the light receiving point on the photo-detecting area PD(1) in the photodetector of the optical head device, and a beam emitting from this original plate exposure pseudo converging point (2) is generated. Then, the thus-generated two beams are applied to the hologram recording material 25 for the hologram diffraction grating 20, interference fringes are generated as a result of these two beams gather on the hologram recording material 25 one another, and thereby, recording is performed on the recording materiel 25.

When the recording wavelength for the hologram diffraction grating is longer than the operation wavelength in the optical head device, incidence angles of chief rays of the two beams in the two-beam interference exposure increase in comparison to the case where these two wavelengths are equal to one another. Furthermore, the original plate exposure pseudo converging points (1) and (2) are closer to the hologram recording material 25 than the LD light emitting point and the light receiving point on the photo-detecting area PD(1) in the optical head device, as shown. FIG. 38 illustrates two-beam interference exposure in a case where the above-mentioned wavelengths are different from one another. When the recording wavelength for the hologram diffraction grating is shorter than the operation wavelength in the optical head device, incidence angles of chief rays of the two beams in the two-beam interference exposure decreases in comparison to the case where the two wavelengths are equal to one another. Furthermore, the original plate exposure pseudo converging points (1) and (2) are farther from the hologram recording material 25 than the LD light emitting point and the light receiving point on the photo-detecting area PD(1) in the optical head device. However, also for this case, the second embodiment can be applied since the nature thereof is common as that in case where the recording wavelength is longer.

In FIG. 38, a case is assumed in which interference fringes are generated in the interference exposure at a wavelength λ1 on a hologram recording layer, while, after that, reproduction is performed at a wavelength of λ0 (operation wavelength in the optical head device). There, λ0<λ1. Further, a refractive index of the hologram recording layer is n0 at λ1 while the same is n1 at λ1.

Interference fringes are generated as a result of two beams of wavelength λ1 are applied to the hologram recording layer with incidence angles of αl and β1, as shown. At this time, the pitch of the interference fringes thus generated is d while the inclination angle inside the recording layer is γ. At this time, these incidence angles α1, β1 and γ have the following relationship:

d=λ1/n1×(sin α1+sin β1) (1)

γ=(α1+β1)/2 (2)

Then, when reproduction illumination light at λ0 is applied to the thus-produced hologram grating at an incidence angle α0 (inside of the recording layer), a diffraction angle β0 occurring there is obtained by the following formula (3):

sin α0+sin β0−λ0/n0×d (3)

At this time, requirements for casing Bragg diffraction there are obtained from the following formula (4):

(α0+β0)/2=γ (4)

Then, from the above-mentioned formulas (1) through (4), the requirements causing Bragg diffraction at the wavelength λ0 from the interference fringes produced at the recording wavelength λ1 are expressed by the following formulas (5) and (6):

n0×(sin α0+sin β0)/λ0=n1×(sin α1 +sin β1)/λ1 (5)

α0+β0 =α1+β1 (6)

Thus, the incidence angles and the diffraction angle should be set so as to satisfy the formulas (5) and (6).

It is assumed that the optical head device in which the relevant hologram diffraction grating is used has a light source of a wavelength λ0. When reflected returning light from an optical disk is applied to the hologram diffraction grating, the chief ray of the returning light performs normal (perpendicular) incidence. Thereby, α0=0 for the chief ray, and thus, the formulas (5) and (6) become:

n0×sin β0/λ0=n1×(sin α1+sin β1)/λ1 (7)

β0=α1+β1 (8)

When the hologram diffraction grafting is used in the optical head device, the incidence angles when recording (producing the hologram diffraction grating) and the diffraction angle applied when the thus-produced hologram diffraction grating is used in the optical head device should be set to approximately satisfy the above-mentioned formulas (7) and (8).

A third embodiment of the present invention according to the fourth aspect of the present invention will now be described.

In the recording (producing a hologram diffraction grating) arrangement shown in FIG. 36, interference exposure is performed as a result of spots not including aberration being produced at the original plate exposure pseudo converging points (1) and (2) through converging. However, when the recording wavelength for producing a hologram diffraction grating and the operation wavelength in the optical head device in which the thus-reproduced hologram diffraction grating is used are different from one another remarkably, or when the light source light emitting point and the photodetector light receiving point are actually arranged in a particular configuration, aberration may occur in diffracted light for the photodetector in the optical head device when the hologram diffraction grating is actually used in the optical disk device if spots not including aberration are produced at the pseudo converging points (1) and (2) during a process of recording the hologram diffraction grating. In such a case, satisfactory convergent light may not be obtained.

In order to solve this problem, it is effective to add aberration, which cancels out aberration otherwise occurring in diffracted light at the operation wavelength in the optical head device, upon performing interference recording of the hologram diffraction grating, whereby, finally, no aberration occurs in the diffracted light. In order to provide the above-mentioned aberration for canceling out expected problematic aberration, aberration for canceling out should be provided to an optical element such as a lens, a mirror or such included in one of or both of optical systems (the lenses 21 and 22, in the example of FIG. 2) used for generating two beams used for the above-mentioned two-beam interference exposure for recording the hologram diffraction grating. In case of a lens, the canceling out aberration is provided therein during a lens designing process. In case of a mirror, the reflection surface is worked so as to provide an uneven shape whereby a wavefront of reflected light becomes such as that canceling out the expected problematic aberration. Alternatively, it is also possible to provide a phase plate in one of or both of the respective optical systems for generating the two beams of the two-beam interference exposure. The phase plate is such that an uneven shape is provided in a transparent substrate such as glass, as a result of a surface thereof being worked, whereby the canceling out aberration is provided to transmitted light.

By thus providing the canceling out aberration when recording the hologram diffraction grating, it becomes possible to prevent aberration from occurring in diffracted light when the hologram diffraction grating is actually used in the optical head device.

A fourth embodiment according to the fifth aspect of the present invention will now be described.

As a method of providing the canceling out aberration in the two-beam interference exposure optical systems according to the third embodiment (fourth aspect) of the present invention, a hologram(s) generating the canceling out aberration may be provided in one of or both of these two-beam interference exposure optical systems.

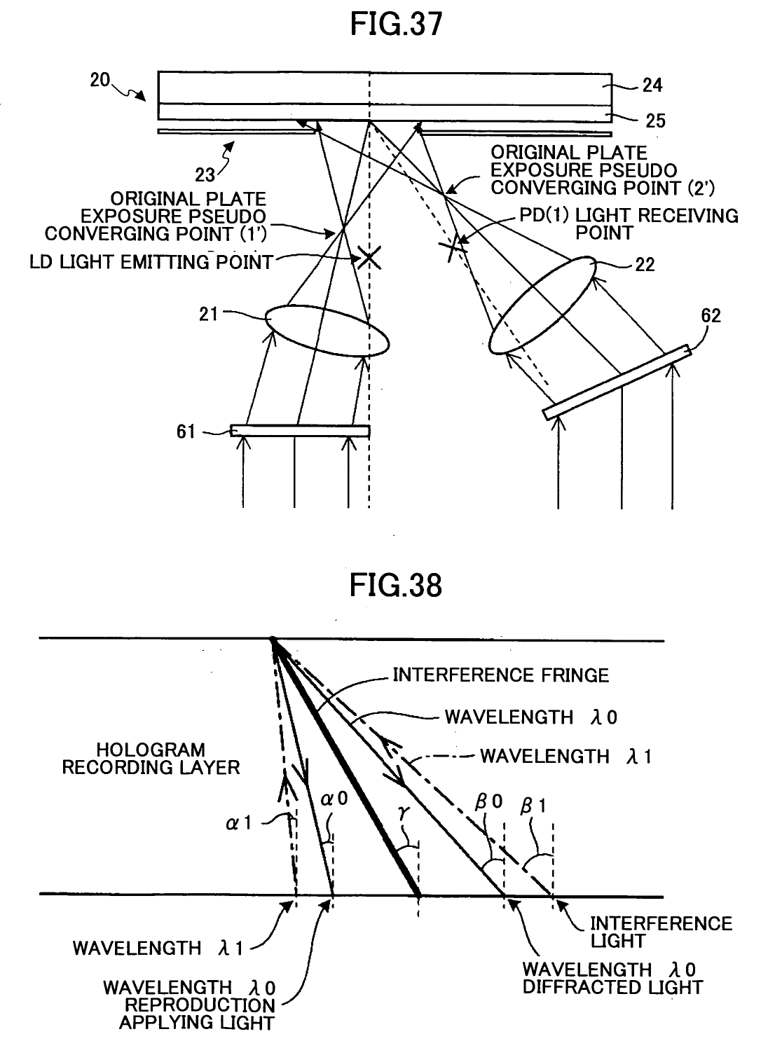

FIG. 37 shows one example thereof. In this configuration, a first hologram 61 and a second hologram 62 are disposed in light paths of the two-beam interference exposure optical systems same as those in the configuration of FIG. 36. In each of the holograms 61 and 62, aberration for canceling out expected aberration otherwise occurring due to difference in wavelength between the hologram recording wavelength and the operation wavelength in the optical head device mentioned above is recorded. 1-st diffracted light (beam) from each of the holograms 61 and 62 converges at the original plate exposure pseudo converging point (1′) or (2′) through the first or second lens 21 or 22, thus becomes divergent light, is applied to the hologram recording material 25 and thus performs recording (duplication) of the hologram diffraction grating thereto. By the thus-recorded hologram diffraction grating, aberration otherwise occurring due to difference between the recording wavelength and the operation wavelength in the optical head device is cancelled out, and thus, a beam spot including no aberration is finally formed on the photodetector in the optical head device as a result of reflected light from an optical disk being diffracted by the hologram diffraction grating used there.

Although FIG. 37 shows the example in which the holograms 61 and 62 for canceling out aberration are provided in both the two-beam interference exposure optical systems, it is not necessary to be limited thereto. It is also possible that such a hologram for canceling out aberration is provided only one of the two two-beam interference exposure optical systems.

Furthermore, in the configurations described with reference to FIGS. 36 and 37 according to the third through fifth aspects of the present invention, the interference exposure is performed with the use of the two divergent beams diverging from the original plate exposure pseudo converging points as shown. However, it is not necessary to be limited thereto. It is also possible that the same concept can also be applied to interference exposure with the use of two convergent beams converging at the two original plate exposure pseudo converting points.

A fifth embodiment according to the sixth and thirty-ninth aspects of the present invention will now be described.

When a large number of hologram diffraction gratings are produced according to any of the first through fourth embodiments described above in which each of the divided areas of the hologram diffraction grating is produced by the two-beam interference exposure area by area, and product by product, a considerable time may be required. According to the fifth embodiment, a hologram diffraction grating produced according to the method in any of the first through fourth embodiments is used as an original hologram plate, exposure duplication is performed therefrom onto a hologram recording material for duplication, and thus, mass production is made possible efficiently. FIG. 8 illustrates a method of duplicating a diffraction grating in one embodiment according to this concept.

As shows in FIG. 8, a hologram diffraction grating produced by the method in the first embodiment is used as an original hologram plate 26 for example, a hologram recording material for duplication 28 is approximately made in contact therewith, and duplication light is applied thereto from the side of the original hologram plate 26. At this time, from the original hologram plate 26, 0-th light and 1-st diffracted light are generated, and thus interference fringes are generated in a zone on the rear side of the original hologram plate 26 in which the 0-th light and the 1-st diffracted light gather one another. The thus-generated interference fringes are used to expose the hologram recording material for duplication 28 disposed approximately in contact with the original hologram plate 26, and thus, recording is performed thereto. As a result, the hologram diffraction grating recorded in the original hologram plate 26 is transferred to the hologram recording material for duplication 28, and thus, a copy (replica) of the hologram diffraction grating is obtained in the hologram recording material for duplication 28 accordingly.

A sixth embodiment according to the seventh and thirty-ninth aspects of the present invention will now be described.

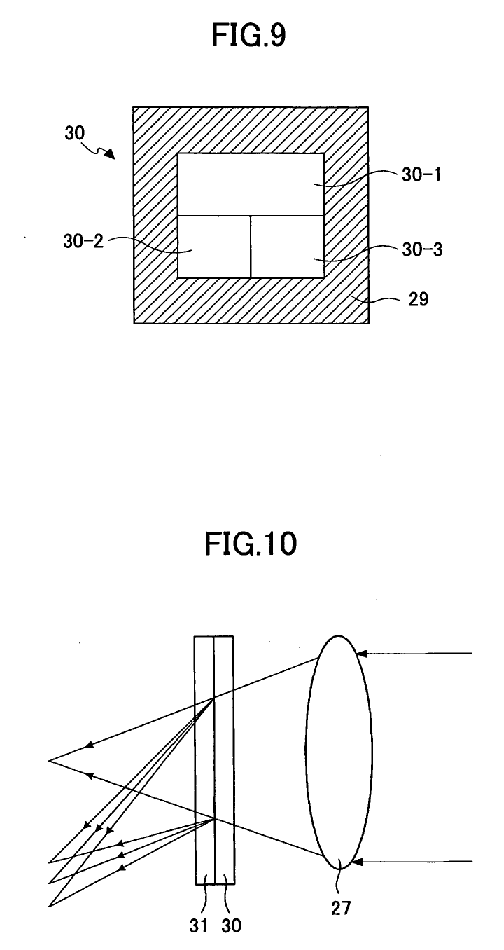

In the fifth embodiment described above, for the purpose of mass production, the original hologram plate 26 for exposure duplication is produced in the manner of two-beam interference exposure described above for the first embodiment for example. However, a method of producing the original hologram plate is not limited thereto. It is possible to calculate interference fringes which should be generated in the manner of two-beam interference exposure, produce a mask based on data thus calculated, and use the mask as the original hologram plate. FIG. 9 shows an example of an original hologram plate 30 in which a hologram is produced based on data calculated by a computer. In order to produce this original hologram plate 30, interference fringes with a wavefront equivalent to the hologram diffraction grating 20 described above for the first embodiment are calculated by means of a computer, and, based thereon, with the use of an electron beam lithography or photolithography technique, the hologram sectors 30-1 through 30-3 are produced on a substrate 29.

By this method, it is possible to freely set the divided areas of the diffraction grating, and thus, this method is advantageous in that, for example, the above-mentioned problem of aberration occurrence due to difference between the original hologram plate recording wavelength and the operation wavelength in the optical head device can be solved. In fact, the above-mentioned problem can be easily eliminated simply by selecting a wavelength at which the interference fringes are calculated same as the operation wavelength of the optical head device in which a resulting hologram diffraction grating will be used. FIG. 10 illustrates an example of an arrangement in case where the original hologram plate 30 is produced based on the data of interference fringes which are calculated by the computer and then is used for duplicating a hologram diffraction grating in a hologram recording material for duplication 31. The specific manners of this method are same as those in the above-described fifth embodiment except that the original hologram plate 30 is produced based on the computer-calculated data of interference fringes as described above.

A seventh embodiment according to the eighth and thirty-ninth aspects of the present invention will now be described.

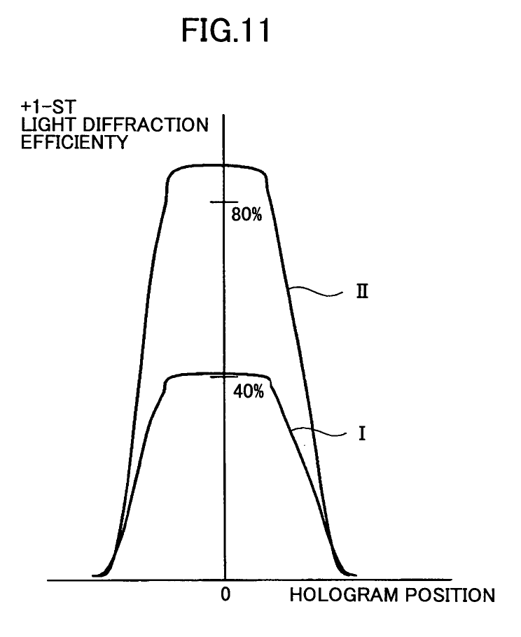

When duplication exposure is performed in a condition in which an original hologram plate produced according to the method in the fifth or sixth embodiment of the present invention is made in contact with a hologram recording material for duplication, it is preferable that light applied from the side of the original hologram plate has a wavelength in the neighborhood of a wavelength of a light source mounted in an optical head device in which a hologram diffraction grating thus produced is applied, and also, the relevant light used in the duplication exposure is light converging at a position equivalent to a light emitting point of the light source. Thereby, a beam spot created on the photodetector as a result of being diffracted and converged through the thus-obtained hologram diffraction grating by means of the duplication includes no aberration, and also, the hologram diffraction grating has high diffraction efficiency throughout the whole area thereof. This is because the hologram diffraction grating is produced by means of interference exposure at the operation wavelength of the optical head device with the use of two beams corresponding to reflected returning light from an optical disk and diffracted light to the photodetector in the optical head device, and thereby, interference fringes produced in the hologram recording material for duplication forms a Bragg grating optimized with respect to the two light waves used for the hologram production. Accordingly, when the thus-obtained hologram diffraction grating is used in the optical head device actually, the returning light from the optical disk is applied to the hologram diffraction grating as a converging wave converging at the light emitting point of the light source, the Bragg requirements are satisfied throughout the whole area of the hologram diffraction grating at this time, and 1-st diffracted light is generated therefrom at high efficiency. FIG. 11 shows a comparison with the related art.

In this figure, the horizontal axis expresses a positional coordinate in a hologram diffraction grating, while the vertical axis expresses a diffraction efficiency for +1-st diffracted light. There, a curve I denotes a diffraction efficiency distribution in a diffraction grating having a rectangular grating in the related art shown in FIG. 34, while a curve II denotes a diffraction grating distribution in a hologram diffraction grating produced by means of the duplication according to the present invention. With reference to the curve I, a diffraction efficiency of approximately 40% which is near to peak efficiency in a rectangular grating appears in the related art. On the other hand, with reference to the curve II, a +1-st diffraction efficiency of more than 80% appears throughout the whole area of the diffraction grating according to the present invention, and thus, it can be said that a high efficiency which has not been achieved from a diffraction grating for an optical head device conventionally-is achieved. Furthermore, diffracted light obtained there has a wavefront same as that appearing at the time of duplication recording for the hologram diffraction grating, and a converged spot having no aberration is produced on the surface of the photodetector in the optical head device.

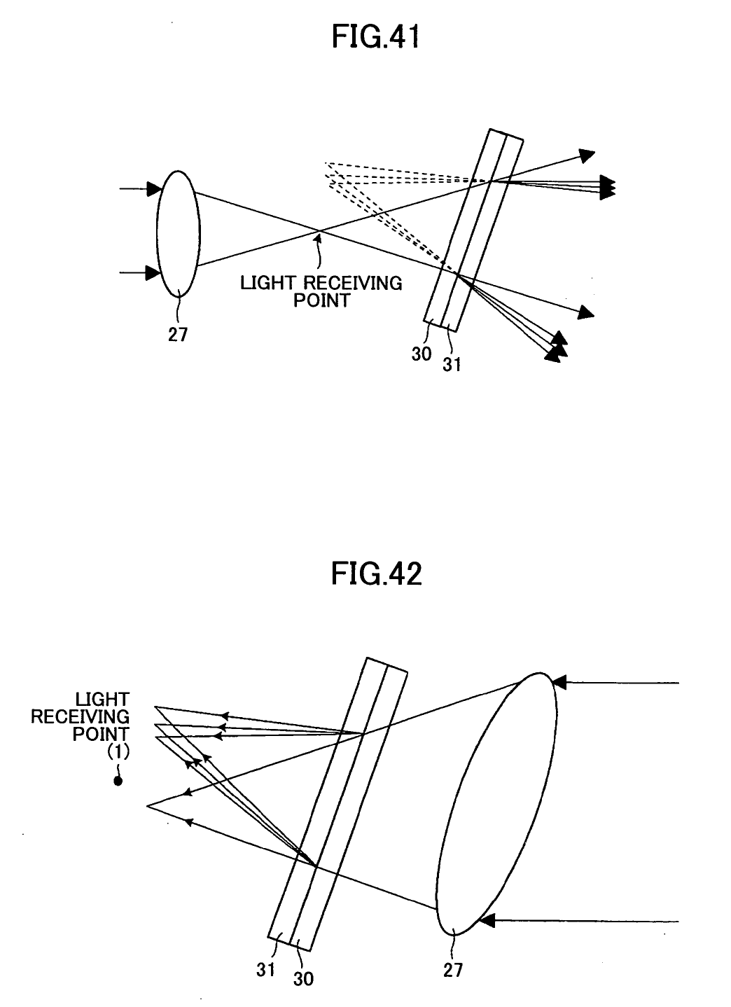

As another embodiment, in case where duplication is performed in a condition in which an original hologram plate is made approximately in contact with a hologram recording material for duplication, instead of applying a manner of exposure shown in FIG. 10, a lens 27 may be used to once converge laser light at a position equivalent to a light source light emitting point, and divergent light diverging from this light source light emitting point may be then applied to the original hologram plate 30, as shown in FIG. 41. In this case, from the original hologram plate 30, both 0-th light diverging from the light source light emitting point and 1-st diffracted light diverging from each photo-detecting area of a photodetector are generated. The hologram recording material for duplication 31 is exposed to interference fringes produced as a result of interference between the 0-th light and the 1-st diffracted light, and thus, a hologram diffraction grating is produced by means of duplication there. Also with this method, it is possible to produce a hologram diffraction grating having a high efficiency throughout the whole area thereof. This is because, since interference exposure is performed at the operation wavelength of the optical head device with the use of the two beams corresponding to the light emitted from the light source light emitting point and the light emitted from each photo-detecting area of the photodetector, the interference fringes produced in the hologram recording material for duplication forms a Bragg grating optimized for the two light waves for the production. Thereby, when the thus-obtained diffraction grating is used in the optical head device actually, returning light from an optical disk is applied to the hologram diffraction grating as a converging wave converging at the light source light emitting point, Bragg requirements are satisfied throughout the whole area of the hologram diffraction grating at this time, and thus, 1-st diffracted light at high efficiency is generated. Furthermore, in diffracted light applied to the photodetector at this time, a wavefront same as that at the time of the hologram duplication recording is reproduced, and thus, a converged spot having no aberration is produced on the surface of the photodetector.

In each of the above-described embodiments, a diffracted and converged spot is produced on the surface of the photodetector, and this configuration is suitable for a case where a focus detecting system such as a knife edge method is applied. However, the present invention is not limited thereto, and can also be applied to a case where diffracted light is converged as a beam spot at a position other than the surface of the photodetector, in the same way. This case is suitable for a case where a focus detection method such as a beam size method is applied. This can hold also in an embodiment according to the ninth aspect of the present invention described next.

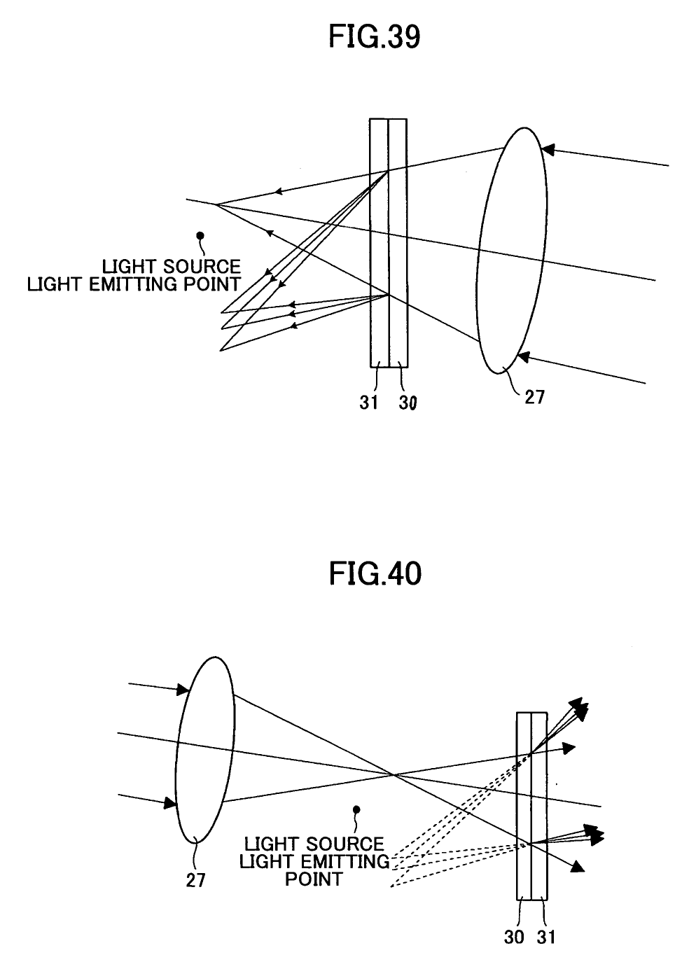

An eighth embodiment according to the ninth or thirty-ninth aspects of the present invention is described next. In the eighth aspect of the present invention, the duplication wavelength (wavelength of light for the duplication exposure) for a hologram diffraction grating and the operation wavelength of the optical head device are approximately equal to one another. FIG. 39 shows a case where these wavelengths are different from one another. In this case, an original hologram plate 30 and a hologram recording material for duplication 31 are made approximately in contact with one another, and, when exposure is performed with the use of convergent light applied from the side of the original hologram plate, the convergent light is one which converges not at the light source light emitting point in the optical head device in which the thus-produced diffraction grating is applied but at a point (corresponding to the original plate exposure pseudo converging point (1) shown in FIG. 36) distant therefrom according to difference between the duplication wavelength and the operation wavelength of the optical head device.

At this time, the following formulas (9) and (10) approximately hold similar to the formulas (7) and (8) with respect to a chief ray, assuming that an incidence angle (inside the duplication hologram recording material layer) of the chief ray of the convergent light for the duplication exposure is α1′, a diffraction angle (inside the duplication hologram recording material layer) of 1-st diffracted light from the original hologram plate is β1′, a diffraction angle (inside the duplication hologram recording material layer) of 1-st diffracted light applied to the photodetector when the thus-produced diffraction grating is used in the optical head device is β0, a refractive index of the duplication hologram recording material layer at the operation wavelength λ0 of the optical head device is n0, and the refractive index of the same at the duplication wavelength λ1′ is n1′:

n0×sin β0/λ0=n1′×(sin α1′+sin β1′)/λ1′ (9)

β0=α1′+β1′ (10)

FIG. 40 shows another embodiment. In this embodiment, instead of the convergent light in the embodiment described above with reference to FIG. 39, divergent light is applied from the side of the original hologram plate 30. Specifically, laser light is once converged through a lens 27 at a point (corresponding to the original plate exposure pseudo converging point (1) shown in FIG. 36) distant from the light source light emitting point of the optical head device according to difference between the duplication wavelength and the operation wavelength of the optical head device, and then, divergent light diverging from the converging point is applied to the original hologram plate 30. From the original hologram plate 30, 0-th light which is light transmitted as it is, and 1-st diffracted light diverging from each of points according to the difference in the wavelength corresponding to the respective photo-detecting areas of the photodetector in the optical head device are generated. Then, a hologram recording material for duplication 31 disposed approximately in contact with the original hologram plate 30 is exposed by interference fringes produced by the two beams, i.e., the 0-th light and the 1-st diffracted light, and thus a hologram diffraction grating is produced by means of duplication. At this time, a chief ray of the duplication applying light and a chief ray of the diffracted light behave approximately according to the above-mentioned formulas (9) and (10).

A ninth embodiment according to the tenth and thirty-ninth aspects of the present invention is described next.

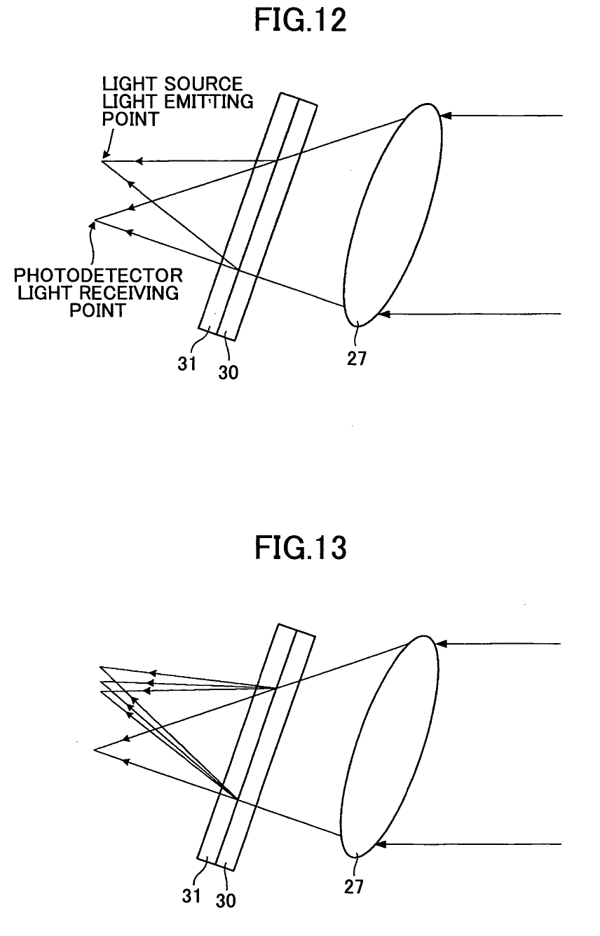

In the seventh embodiment, light applied from the side the original hologram plate at the time of duplication has a wavelength in neighborhood of the light source light wavelength in the optical head device in which the thus-produced hologram diffraction grating is mounted, and the convergent light converging at a point equivalent to the light emitting point of the light source is applied. However, instead, in the ninth embodiment, as shown in FIG. 12, light to be applied in duplication for a hologram diffraction grating has a wavelength in neighborhood of the light source wavelength in the optical head device in which the thus-produced hologram diffraction grating is mounted, is convergent light converging at a point the light receiving point on the photodetector in the optical head device, and is applied to the original hologram plate 30 as oblique applying light. In this case, from the original hologram plate 30, 0-th light converging at the light receiving point on the photodetector and −1-st diffracted light converging at the light emitting point of the light source are generated. With the use of these two beams, interference fringes are produced on a hologram recording material for duplication 31 disposed approximately in contact with the original hologram plate 30, and thereby, the hologram diffraction grating is recorded in manner of duplication.

FIG. 12 shows the example in which the hologram diffraction grating is not divided. However, actually, as described above for the first through third embodiments, a plurality of divided areas (sectors (1) through (3) or such) are set. In this case, convergent light which converges at a light receiving point in one area from among the plurality of photo-detecting areas (PD(1) through PD(3) or such) of the photodetector is used as light to be applied in the duplication. At this time, as shown in FIG. 13, from the original hologram plate 30, diffracted light beams diffracted by the respective divided areas in the hologram converging at the light emitting point on the light source are generated in the number of the divided areas, and the diffraction is performed there for generating the diffracted beams having different converging points, respectively, actually, as shown. The difference in the converging points corresponds to the difference in the positions of the respective photo-detecting areas on the photodetector.

Thus, from the light applied to the original hologram plate, the 0-th light beam and the group of the diffracted light beams corresponding to the hologram divided areas are generated, thereby interference fringes are generated immediately behind the original hologram plate, and thereby, duplication is produced in the hologram recording material for duplication 31.

When reflected light from an optical disk is applied to the hologram diffraction grating produced according to the above-described method by means of duplication recording as converging light converging at the light emitting point of the light source in the optical head device, diffracted light satisfying Bragg requirements is generated from each of the divided areas of the diffraction grating, and converges at the respective photo-detecting areas of the photodetector.

As another embodiment, in case where duplication is performed by exposure of a hologram recording material for duplication as a result of exposure light being applied from an original hologram plate approximately in contact with the hologram recording material, instead of a method of exposure with the use of the converging light as shown in FIG. 12, it is also possible, as shown in FIG. 41, that once laser light is converged at a point equivalent to a light receiving point on a photodetector, and then, divergent light diverging from the light receiving point on the photodetector is applied to the original hologram plate 30. In this case, from the original hologram plate, 0-th light diverging from the light receiving point on the photodetector and 1-st diffracted light diverging from the light source light emitting point are generated. The hologram recording material for duplication 31 is exposed by interference fringes produced as a result of interference between the 0-th light and the 1-st diffracted light, and thus, a hologram diffraction grating is produced in manner of duplication therefrom. Also in this method, it is possible to provide a diffraction grating having a high efficiency throughout the whole area thereof. This is because since interference exposure is performed at the operation wavelength in the optical head device with the use of two beams corresponding to light emitted from the light source light emitting point and light emitting from each photo-detecting area of the photodetector, the interference fringes produced in the hologram recording material for duplication form a Bragg grating optimized for the two light waves for hologram production. Thereby, when the thus-produced hologram diffraction grating is used in the optical head device, returning light from the optical disk is applied to the hologram diffraction grating as a converging wave converging at the light source light emitting point, Bragg requirements are satisfied throughout the whole area of the hologram diffraction grating at this time, and 1-st diffracted light at a high efficiency is generated therefrom. Also, in the diffracted light applied to the photodetector, a wavefront same as that at the time of hologram duplication recording is reproduced, and a converged spot having no aberration is produced on the surface of the photodetector.

In connection with the example shown in FIG. 41, actually in the hologram diffraction grating, a plurality of divided areas are set. In this case, divergent light diverging from one area from among the plurality of photo-detecting areas of the photodetector is used as light to be applied for the duplication. At this time, as shows in FIG. 41, from the original hologram plate 30, diffracted light diffracted by the respective divided areas in the hologram diverging from the light emitting point of the light source is generated in the number of the divided areas, and also, the diffraction is performed there for generating the diffracted beams having different diverging points, respectively, as shown. The difference in the diverging points corresponds to the difference in the positions of the respective photo-detecting areas on the photodetector.

A tenth embodiment according to the eleventh and thirty-ninth aspects of the present invention is described next.

In the ninth embodiment, the hologram duplication wavelength and the operation wavelength in the optical head device are approximately equal to one another. FIG. 42 illustrates the tenth embodiment in which the wavelengths are different from one another. When the original hologram plate 30 and the hologram recording material for duplication 31 are made approximately in contact with one another and converging light is used to expose the hologram recording material from the side of the original hologram plate, a converging point of the convergent light used in this case is not the light receiving point on the photodetector located when the thus-produced diffraction grating is used in the optical head device but a point distant therefrom according to difference between the duplication wavelength and the operation wavelength in the optical head device (corresponding to the original plate exposure pseudo converging point (2) shown in FIG. 36).

At this time, the formulas (9) and (10) approximately hold similar to the formulas (7) and (8) with respect to the chief ray, assuming that an incidence angle (inside the duplication hologram recording material layer) of the chief ray of the convergent light for the duplication exposure is β1′, a diffraction angle (inside the duplication hologram recording material layer) of 1-st diffracted light from the original hologram plate is α1′, a diffraction angle (inside the duplication hologram recording material layer) of 1-st diffracted light applied to the photodetector when the thus-produced diffraction grating is used in the optical head device is β0, a refractive index of the duplication hologram recording material layer at the operation wavelength λ0 of the optical head device is n0, and the refractive index of the same at the duplication wavelength λ1′ is n1′.

FIG. 43 shows another embodiment. In this embodiment, instead of the convergent light in the embodiment described above with reference to FIG. 42, divergent light is applied from the side of the original hologram plate 30. Specifically, laser light is once converged through a lens 27 at a point (corresponding to the original plate exposure pseudo converging point (2) shown in FIG. 36) distant from the light receiving point on the photodetector in the optical head device determined according to difference between the duplication wavelength and the operation wavelength of the optical head device, and then, divergent light diverging from the converging point is applied to the original hologram plate 30. From the original hologram plate 30, 0-th light which is light transmitted thereby as it is, and 1-st diffracted light diverging from a point different according to the difference in the wavelength corresponding to the light source light emitting point in the optical head device are generated. Then, a hologram recording material for duplication 31 disposed approximately in contact with the original hologram plate 30 is exposed by interference fringes produced by the two beams, i.e., the 0-th light and the 1-st diffracted light, and thus a hologram diffraction grating is produced by means of duplication. At this time, a chief ray of the duplication applying light and a chief ray of the diffracted light behave approximately according to the formulas (9) and (10).

An eleventh embodiment according to the twelfth and thirty-ninth aspects of the present invention is described next.

In the ninth and tenth embodiments, when the duplication exposure is performed, convergent light converging at a point corresponding to the light receiving point of one area from among the plurality of photo-detecting areas of the photodetector, or divergent light diverging from a point corresponding to the light receiving point of one area from among the plurality of photo-detecting areas of the photodetector is used for the light to be applied for the duplication. According to the eleventh embodiment, the photo-detecting area to be selected at this time is one used for obtaining a focus error signal. Thereby, when returning light from an optical disk is applied to the diffraction grating produced by means of duplication as converging light converging at the light emitting point of the light source, diffracted light applied to the area used for detecting the focus error signal on the photodetector has no aberration, no useless offset is included in the thus-detected focus error signal, and also, no reduction in an amplitude of the focus error signal occurs.

In contrast thereto, slight aberration exists in diffracted light used for detecting a track error signal in this case, and thus, a converged spot on the photodetector is enlarged. However, as a result of the photo-detecting area being previously made to have a size so large as to include the thus-enlarged spot, it is possible to avoid any problem from occurring also in detection of the track error signal.

A twelfth embodiment according to the thirteenth and thirty-ninth aspects of the present invention is described next.

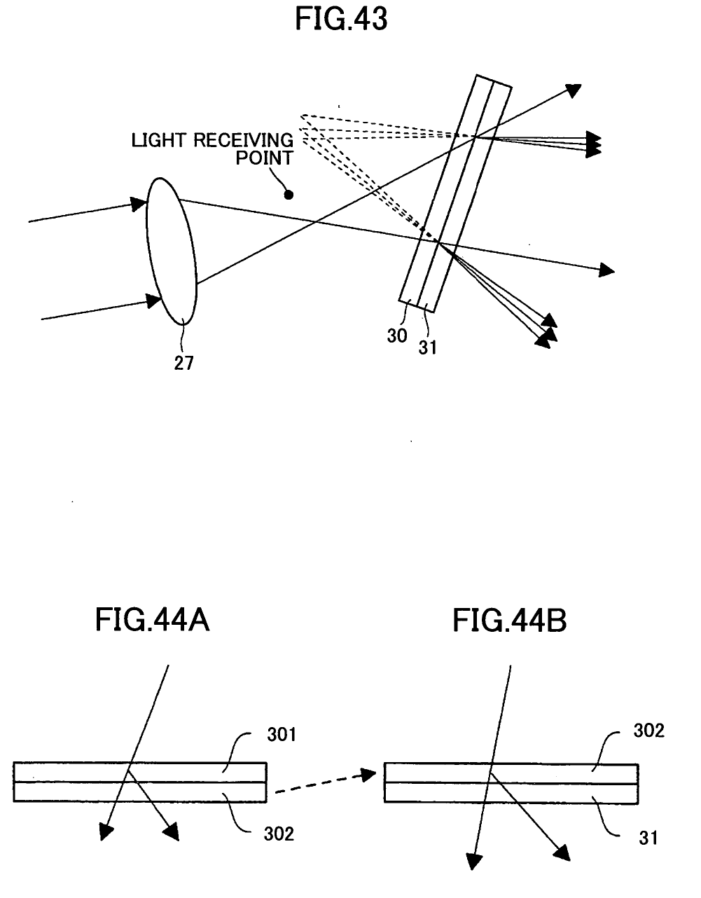

FIGS. 44A and 44B illustrate a method for exposing a hologram recording material for duplication from an original hologram plate in the twelfth embodiment in which the original hologram plate is produced by two steps illustrated in FIGS. 44A and 44B. With reference to FIG. 44A, a first original hologram plate 301 is produced as a result of a mask being produced based on data of interference fringes produced by means of interference exposure calculated by a computer. Specifically, the interference fringes are calculated by the computer, hologram sectors (1), (2) and (3) are produced therefrom according to an electron beam lithography or photolithography method, and thus, the first original hologram plate 301 is produced. Then, the thus-obtained first original hologram plate 301 is made approximately in contact with a photosensitive original hologram plate hologram recording material, light is applied from the side of the first original hologram plate 301, interference fringes produced by means of 0-th light and 1-st diffracted light generated from the first original hologram plate 301 are used to expose the hologram recording material, and thus, a second original hologram plate 302 is produced therefrom.

Then, as shown in FIG. 44B, the second original hologram plate 302 is made approximately in contact with a hologram recording material for duplication 31, light having a wavelength approximately same as the operation wavelength in the optical head device is applied from the side of the second original hologram plate 302, interference fringes produced by means of 0-th light and 1-st diffracted light generated from the second original hologram plate 302 are used to expose the hologram recording material for duplication 31 so as to record therein interference fringes, and thus, finally, a hologram diffraction grating to be mounted in the optical head device is produced therefrom.

By this method, it is possible to optimize these original hologram plates used in the duplication process. Specifically, the first original hologram plate 301 is produced as a primary original hologram plate suitable for producing a computer generated hologram with the use of electron beam lithography or photolithography, while the second original hologram plate 302 is produced as an original hologram plate suitable for making it possible to achieve duplication exposure such as that to yield a hologram diffraction grating having a high efficiency finally to be mounted in the optical head device. In other words, the two original hologram plates are used so that, from the hologram generated by the computer, the hologram diffraction grating having high diffraction efficiency can be finally produced.

In case where the duplication wavelength lies in neighborhood of the operation wavelength in the optical head device, when duplication exposure is performed to the hologram recording material for duplication 31 from the second original hologram plate 302, the same as in the case of FIG. 10, the hologram recording material for duplication 31 are exposed to interference fringes produced by means of 0-th light and 1-st diffracted light generated from the second original hologram plate 302 as a result of converging light converging at the light source light emitting point in the optical head device being applied thereto, and thus, exposure recording is performed on the hologram recording material for duplication 31. Alternatively, it is also possible, as shown in FIG. 45, to once converge light at the light source light emitting point in the optical head device from the side of the original hologram plate, and then, to apply divergent light diverging from the light source light emitting point.

Requirements on the applying duplication light (a direction of the chief ray and a position of the converging point or the diverging point) when the second original hologram plate 302 is produced from the first original hologram plate 301 in a condition in which they are made approximately in contact with one another are determined so that, when the final hologram recording material for duplication is exposed for duplication from the second original hologram plate 302 in the approximately mutual contact state, 0-th light and 1-st diffracted light generated from the second original hologram plate 302 become approximately equal to one another in the diffraction efficiency. At this time, the wavelength of the light to be applied should not necessarily be equal to the operation wavelength in the optical head device or to the duplication wavelength applied in the second step of final production from the second original hologram plate. When exposure intensity in the 0-th light and the same in the 1-st diffracted light from the second original hologram plate 302 are made approximately equal to one another, it becomes possible that interference fringes having the highest contrast are generated therefrom for the final hologram recording material for duplication 31, and thus, it is possible to increase the diffraction efficiency of the hologram diffraction grating thus produced by means of duplication.

Thus, it is possible to provide a hologram diffraction grating used for an optical head device having no aberration in diffracted light obtained therefrom and having high diffraction efficiency with the use of an ideal hologram diffraction grating calculated by a computer in the initial stage.

A thirteenth embodiment according to the fourteenth and thirty-ninth aspects of the present invention is described next.

In the above-described twelfth embodiment (thirteenth aspect) of the present invention, the wavelength used when the duplication exposure is performed from the second original hologram plate 302 to the final hologram recording material for duplication 31 is approximately equal to the operation wavelength in the optical head device. In the thirteenth embodiment, the wavelength used when the duplication exposure in the second step from the second original hologram plate 302 is different from the operation wavelength in the optical head device.

As in the twelfth embodiment, an original hologram plate 30 is produced by the two steps. Divided hologram sectors (1) through (3) are produced according to electron beam lithography or photolithography method based on interference fringes calculated by a computer, and thus, a first original hologram plate 301 is obtained. Then, the thus-obtained first original hologram plate 301 is made approximately in contact with a photosensitive original hologram plate hologram recording material, light is applied from the side of the first original hologram plate 301, interference fringes produced by means of 0-th light and 1-st diffracted light generated from the first original hologram plate 301 are used to expose the hologram recording material, and thus, a second original hologram plate 302 is produced, as in the case of FIG. 44A (first step). Then, as in the way described above with reference to FIG. 44B, the second original hologram plate 302 is made approximately in contact with a hologram recording material for duplication 31, light having a wavelength different from the operation wavelength in the optical head device is applied from the side of the second original hologram plate 302, interference fringes produced by means of 0-th light and 1-st diffracted light generated from the second original hologram plate 302 are used to expose the hologram recording material for duplication 31 so as to record therein the interference fringes, and thus, finally, a hologram diffraction grating to be mounted-in the optical head device is produced (second step).

In case where the duplication wavelength is different from the operation wavelength in the optical head device, when duplication exposure is performed from the second original hologram plate 302 to the recording materiel for duplication 31, light applied to the second original hologram plate 302 is provided in the following manner. That is, as in the case of FIG. 39, when the second original hologram plate 302 is used as the original hologram plate, the original hologram plate and the hologram recording material for duplication 31 are made approximately in contact with one another and convergent light is applied from the side of the original hologram plate, a converting point of the convergent light is not the light source light emitting point located when the diffraction grating thus produced is used in the optical head device but a point distant therefrom according to the difference between the duplication wavelength and the operation wavelength in the optical head device (corresponding to the original plate exposure pseudo converging point (1) shown in FIG. 36). Then, interference fringes are generated from 0-th light and 1-st diffracted light generated from the original hologram plate 30 (second original hologram plate 302), and thus, a hologram diffraction grating is transferred to the hologram recording material for duplication 31.

Alternatively, it is also possible, as in the case of FIG. 40, to apply divergent light, instead of the convergent light, from the side of the original hologram plate. In this case, once laser light is converged at a point (corresponding to the original plate exposure pseudo converging point (1) shown in FIG. 36) by a lens 27, which point is distant from the light source light emitting point located when the thus-produced diffraction grating is applied in the optical head device according to the difference between the duplication wavelength and the operation wavelength in the optical head device, and then, divergent light diverging from this converging point is applied to the original hologram plate 30 (second original hologram plate 302). Then, interference fringes are generated from 0-th light and 1-st diffracted light from the second original hologram plate, and therewith, the hologram diffraction grating is obtained in the hologram recording material for duplication 31 in manner of transfer.

In any of,these cases, the formulas (9) and (10) approximately hold with respect to the chief ray, assuming that an incidence angle (inside the duplication hologram recording material layer) of the chief ray of the duplication exposure is β1′, a diffraction angle (inside the duplication hologram recording material layer) of 1-st diffracted light from the original hologram plate is α1′, a diffraction angle (inside the duplication hologram recording material layer) of 1-st diffracted light applied to the photodetector when the thus-produced diffraction grating is used in the optical head device is β0, a refractive index of the duplication hologram recording material layer at the operation wavelength λ0 of the optical head device is n0, and the refractive index of the same at the duplication wavelength λ1′ is n1′.

Requirements on applying duplication light (a direction of the chief ray and a position of the converging point or the diverging point) when the second original hologram plate 302 is produced from the first original hologram plate 301 (in the first step) in a condition in which they are made approximately in contact with one another are determined so that, when the final hologram recording material for duplication is exposed for duplication (in the second step) from the second original hologram plate 302 in the approximately mutual contact state, 0-th light and 1-st diffracted light generated from the second original hologram plate 302 become approximately equal to one another in the diffraction efficiency. At this time, the wavelength of the light to be applied should not necessarily be equal to the operation wavelength in the optical head device or to the duplication wavelength applied in the second step of production from the second original hologram plate. When exposure intensity in the 0-th light and the same in the 1-st diffracted light from the second original hologram plate 302 are made approximately equal to one another, it becomes possible that interference fringes having the highest contrast are generated for the final hologram recording material for duplication 31, and thus, it is possible to increase the diffraction efficiency of the hologram diffraction grating thus produced by means of duplication.

Thus, it is possible to provide a hologram diffraction grating used for an optical head device having no aberration in diffracted light obtained therefrom and having high diffraction efficiency with the use of an ideal hologram diffraction grating calculated by a computer in the initial stage.

A fourteenth embodiment according to the fifteenth and thirty-ninth aspects of the present invention is described next.

As in the twelfth embodiment (thirteenth aspect), an original hologram plate 30 is produced by the two steps. As in the case of FIG. 44A, a first original hologram plate 301 is produced as a result of a mask being produced based on data of interference fringes produced by means of interference exposure calculated by a computer. Specifically, the interference fringes are calculated by the computer, hologram sectors (1), (2) and (3) are produced therefrom according to an electron beam lithography or photolithography method, and thus, the first original hologram plate 301 is produced. Then, the thus-obtained first original hologram plate 301 is made approximately in contact with a photosensitive original hologram plate hologram recording material, light is applied from the side of the first original hologram plate 301, interference fringes produced by means of 0-th light and 1-st diffracted light generated from the first original hologram plate 301 are used to expose the hologram recording material, and thus, a second original hologram plate 302 is produced (first step). Then, as in the case of FIG. 44B, the second original hologram plate 302 is made approximately in contact with a hologram recording material for duplication 31, light having a wavelength approximately same as the operation wavelength in the optical head device is applied from the side of the second original hologram plate 302, interference fringes produced by means of 0-th light and 1-st diffracted light generated from the second original hologram plate 302 are used to expose the hologram recording material for duplication 31 so as to record therein the interference fringes, and thus, finally, a hologram diffraction grating to be mounted in the optical head device is produced there (second step).

In case where the duplication wavelength lies in neighborhood to the operation wavelength in the optical head device, when duplication exposure is performed to the hologram recording material for duplication 31 from the second original hologram plate 302 (second step), the same as in the case of FIG. 12, the hologram recording material for duplication 31 is exposed to interference fringes produced by means of 0-th light and 1-st diffracted light generated from the second original hologram plate 302 as a result of converging light converging at a point in the photo-detecting areas of the photodetector in the optical head device being applied thereto, and thus, exposure recording is performed on the hologram recording material for duplication 31.

Alternatively, it is also possible, as shown in FIG. 41, to once converge light at a point (light receiving point) in the photo-detecting areas of the photodetector in the optical head device from the side of the original hologram plate, and then, applying divergent light diverging from this light receiving point.

Requirements on applying duplication light (a direction of the chief ray and a position of the converging point or the diverging point) when the second original hologram plate 302 is produced from the first original hologram plate 301 in a condition in which they are made approximately in contact with one another are determined so that, when the final hologram recording material for duplication is exposed for duplication from the second original hologram plate 302 in the approximately mutual contact state, 0-th light and 1-st diffracted light generated from the second original hologram plate 302 become approximately equal to one another in the diffraction efficiency. At this time, the wavelength of the light to be applied should not necessarily be equal to the operation wavelength in the optical head device or to the duplication wavelength applied in the second step from the second original hologram plate. When exposure intensity in the 0-th light and the same in the 1-st diffracted light from the second original hologram plate 302 are made approximately equal to one another, it becomes possible that interference fringes having the highest contrast are generated for the final hologram recording material for duplication 31, and thus, it is possible to increase the diffraction efficiency of the hologram diffraction grating thus produced by means of duplication.

Thus, it is possible to provide a hologram diffraction grating used for an optical head device having no aberration in diffracted light obtained therefrom and having high diffraction efficiency with the use of an ideal hologram diffraction grating calculated by a computer.

A fifteenth embodiment according to the sixteenth and thirty-ninth aspects of the present invention is described next.

In the fourteenth embodiment (fifteenth aspect) of the present invention, the wavelength used when the duplication exposure is performed from the second original hologram plate 302 to the final hologram recording material for duplication 31 is approximately equal to the operation wavelength in the optical head device. In the fifteenth embodiment, the wavelength used when the duplication exposure from the second original hologram plate 302 (second step) is different from the operation wavelength in the optical head device.

As in the twelfth embodiment (thirteenth aspect), an original hologram plate 30 is produced by the two steps. Divided hologram sectors (1) through (3) are produced according to electron beam lithography or photolithography method based on interference fringes calculated by a computer, and thus, a first original hologram plate 301 is obtained. Then, the thus-obtained first original hologram plate 301 is made approximately in contact with a photosensitive original hologram plate hologram recording material, light is applied from the side of the first original hologram plate 301, interference fringes produced by means of 0-th light and 1-st diffracted light generated from the first original hologram plate 301 are used to expose the hologram recording material, and thus, a second original hologram plate 302 is produced, as in the case of FIG. 44A (first step). Then, as in the way described above with reference to FIG. 44B, the second original hologram plate 302 is made approximately in contact with a hologram recording material for duplication 31, light having a wavelength different from the operation wavelength in the optical head device is applied from the side of the second original hologram plate 302, interference fringes produced by means of 0-th light and 1-st diffracted light generated from the second original hologram plate 302 are used to expose the hologram recording material for duplication 31 so as to record therein the interference fringes, and thus, finally, a hologram diffraction grating to be mounted in the optical head device is produced (second step).

In case where the duplication wavelength is different from the operation wavelength in the optical head device, when duplication exposure is performed from the second original plat to the recording materiel for duplication 31 in the second step, light applied to the second original hologram plate 302 is provided in the following manner. That is, as in the case of FIG. 42, when the second original hologram plate 302 is used as the original hologram plate, the original hologram plate and the hologram recording material for duplication 31 are made approximately in contact with one another and convergent light is applied from the side of the original hologram plate, a converting point of the convergent light is not the light receiving point on the photodetector located when the diffraction grating thus produced is used in the optical head device but a point distant therefrom according to the difference between the duplication wavelength and the operation wavelength in the optical head device (corresponding to the original plate exposure pseudo converging point (2) shown in FIG. 36). Then, interference fringes are generated from 0-th light and 1-st diffracted light generated from the original hologram plate 30 (second original hologram plate 302), and thus, a hologram diffraction grating is transferred to the hologram recording material for duplication 31.

Alternatively, it is also possible, as in the case of FIG. 43, to apply divergent light, instead of the convergent light, from the side of the original hologram plate. In this case, once laser light is converged at a point (corresponding to the original plate exposure pseudo converging point (2) shown in FIG. 36) by a lens 27, which point is distant from the light receiving point on the photodetector located when the thus-produced diffraction grating is applied in the optical head device according to the difference between the duplication wavelength and the operation wavelength in the optical head device, and then, divergent light diverging from the converging point is applied to the original hologram plate 30 (second original hologram plate 302). Then, interference fringes are generated from 0-th light and 1-st diffracted light generated from the second original hologram plate, and therewith, the hologram diffraction grating is obtained in the hologram recording material for duplication 31 in manner of transfer.

In any of these case, the formulas (9) and (10) approximately hold with respect to the chief ray, assuming that an incidence angle (inside the duplication hologram recording material layer) of the chief ray of the duplication exposure is β1′, a diffraction angle (inside the duplication hologram recording material layer) of 1-st diffracted light from the original hologram plate is α1′, a diffraction angle (inside the duplication hologram recording material layer) of 1-st diffracted light applied to the photodetector when the thus-produced diffraction grating is used in the optical head device is β0, a refractive index of the duplication hologram recording material layer at the operation wavelength λ0 of the optical head device is n0, and the refractive index of the same at the duplication wavelength λ1′ is n1′.

Requirements on applying duplication light (a direction of the chief ray and a position of the converging point or the diverging point) when the second original hologram plate 302 is produced from the first original hologram plate 301 in a condition in which they are made approximately in contact with one another are determined so that, when the final hologram recording material for duplication is exposed for duplication from the second original hologram plate 302 in the approximately mutual contact state, 0-th light and 1-st diffracted light generated from the second original hologram plate 302 become approximately equal to one another in the diffraction efficiency. At this time, the wavelength of the light to be applied should not necessarily be equal to the operation wavelength in the optical head device or to the duplication wavelength applied in the second step from the second original hologram plate. When exposure intensity in the 0-th light and the same in the 1-st diffracted light from the second original hologram plate 302 are made approximately equal to one another, it becomes possible that interference fringes having the highest contrast are generated for the final hologram recording material for duplication 31, and thus, it is possible to increase the diffraction efficiency of the hologram diffraction grating thus produced by means of duplication.

Thus, it is possible to provide a hologram diffraction grating used for an optical head device having no aberration in diffracted light obtained therefrom and having high diffraction efficiency with the use of an ideal hologram diffraction grating calculated by a computer.

A sixteenth embodiment according to the seventeenth and thirty-ninth aspects of the present invention is described next.

According to the methods of duplication from an original hologram plate in the fifth through fifteenth embodiments (sixth through sixteenth aspects of the present invention), aberration may occur in diffracted light applied to the photodetector when the hologram diffraction grating thus-produced is applied in the optical head device, and thus, convergence of light for the photodetector may not be performed sufficiently in some case when the duplication exposure light wavelength and the operation wavelength in the optical head device are different from one another largely, or depending on a particular situation of arrangement of the light source and the photodetector in the optical head device. In order to solve such a problem, aberration for canceling out the above-mentioned aberration which otherwise would occur in the diffracted light applied to the photodetector is added to the optical system which applies light from the original hologram plate when the hologram recording material is exposed in a condition in which the original hologram plate is approximately in contact with the hologram recording material when the hologram diffraction grating is produced, according to the sixteenth embodiment.

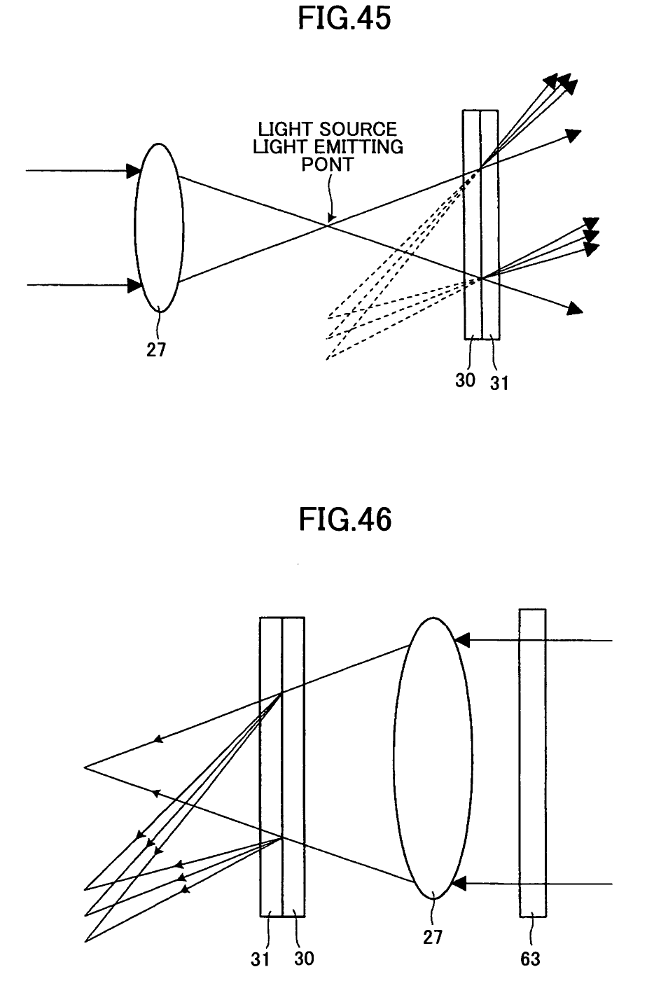

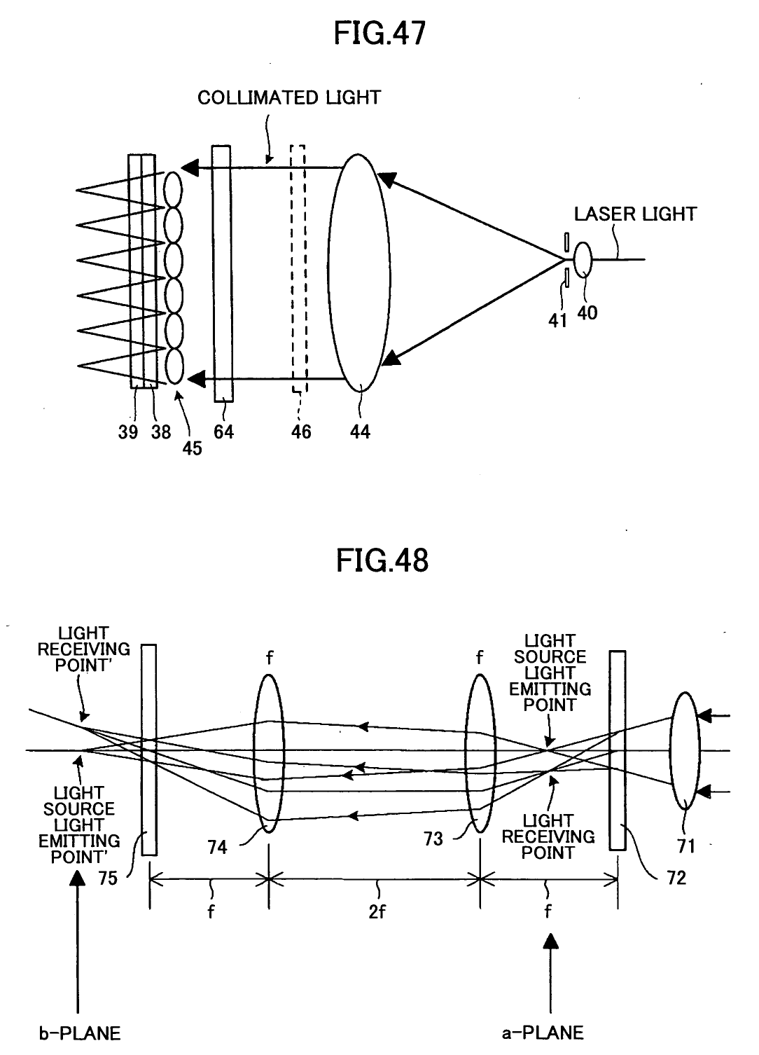

In order to give the aberration for canceling out the expected aberration as mentioned above, a configuration is provided such that an optical element/system such as a lens, a mirror or such included in the optical system generating the light for duplicating a hologram provides the aberration for canceling out the expected aberration. In a case of a lens, it should be designed to provide the aberration for canceling out. In a case of a mirror, the mirror is worked to have unevenness on the surface thereof such that reflected light therefrom has a wavefront which cancels out the expected aberration. Alternatively, as shown in FIGS. 46 and 47, a phase plate 63 (a phase plate array 64) is disposed in the duplication optical system. This phase plate is provided as a result of a surface of a transparent substrate such as a glass being worked so that the surface has an unevenness which generates transmitted light canceling out the expected aberration. Further alternatively, it is also possible to dispose a hologram providing the aberration for canceling out the expected aberration in the optical system applying light for duplication, and use 1-st diffracted light from the hologram as the light to be applied for the duplication exposure.

A seventeenth embodiment according to the eighteenth, nineteenth and thirty-ninth aspects of the present invention is described next.

In the methods according to the fifth through fifteenth embodiments (sixth through sixteenth aspects of the present invention), duplication for a hologram diffraction grating from the original hologram plate is performed in the condition in which the original hologram plate and the hologram recording material for duplication are made approximately in contact with one another. However, in duplication for a hologram diffraction grating in such a condition in which the original hologram plate and the hologram recording material for duplication are approximately in contact with one another, a necessity arises to insert refractive index matching liquid or such to avoid generation of useless interference fringes due to multiple light interference between the original hologram plate and the hologram recording material for duplication or so, and thus, the workability may be degraded. Furthermore, if a gap in distance occurs between the hologram layer in the original hologram plate and the recording layer in the hologram recording material for duplication when the hologram diffraction grating is divided into the plurality of areas and diffraction directions of 1-st diffracted light beams from the respective divided holograms differ from each other, the division lines of the duplicated hologram diffraction grating deviates from the same in the original hologram plate according to the amount of the above-mentioned gap occurring. Therefore, technical problems may occur such as that to reduce such a distance gap as much as possible, it is necessary to reduce the thickness of the glass as much as possible when the cover glass is used on the original hologram and the hologram recording material for duplication, and so forth.

In order to solve the above-mentioned problem which may occur in case of the above-mentioned contact exposure duplication, a method is applied according to the seventeenth embodiment described next with reference to FIG. 48. In the method illustrated in FIG. 48, an original hologram plate 72 (the original hologram plate 30 or the second original hologram plate 302) in the fifth through fifteenth embodiments (the sixth through sixteenth aspects of the present invention) and a hologram recording material 75 for duplication are disposed separately spatially, and a relay optical system is inserted therebetween. In this configuration, convergent light from a lens 71 is applied to the original hologram plate 72, 0-th light and 1-st diffracted light generated from the original hologram plate 72 are applied to the hologram recording material 75 for duplication via the relay optical system including lenses 73 and 74. At this time, the relay optical system is configured so that the original hologram plate 72 and the hologram recording material 75 for duplication have a relation of conjugate planes in imaging in which the original hologram plate acts as an object plane while the hologram recording material 75 for duplication acts as an image plane. Thereby, the 0-th light and the 1-st diffracted light generated from the original hologram plate 72 gather again on the surface of the hologram recording material 75 for duplication and generate interference fringes there. The thus-generated interference fringes are thus recorded in the hologram recording material 75 for duplication, and as a result, the hologram diffraction grating in the original hologram plate 72 is duplicated there.

An eighteenth embodiment according to twentieth and thirty-ninth aspects of the present invention is described next.

In FIG. 48, the relay optical system includes two lens systems (lens 73 and lens 74). Although the lenses 73 and 74 are respective single lenses, each thereof may be one which is made of a combination of a plurality of lenses.

The respective lenses are disposed so that a front focal point of the lens 73 is made coincident with a plane of the original 72 plate while a rear focal point of the lens 73 is made coincident with a front focal point of the lens 74, and also, a rear focal point of the lens 74 is made coincident with a plane of the hologram recording material 75. FIG. 48 shows a case where the focal lengths of the lens 73 and the lens 74 are equal to one another, and each thereof is ‘f’. When the focal lengths of the lens 73 and the lens 74 are thus equal to one another, the original hologram plate plane is imaged on the hologram recording material for duplication with a unity (1:1) magnification. A hologram divided pattern recorded in the original hologram plate 72 is used to expose the hologram recording material for duplication 75 with the unity magnification. Furthermore, the hologram grating pattern is also formed in the hologram recording material for duplication 75 at the same pitch as that in the original hologram plate 72.

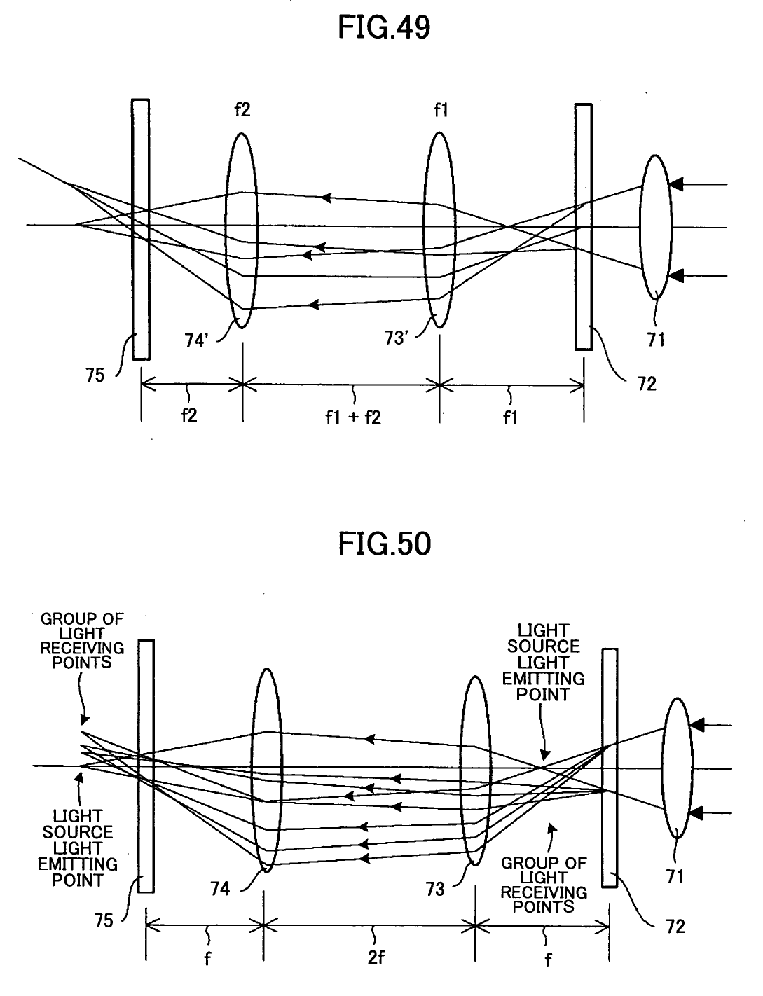

FIG. 49 illustrates another embodiment for duplicating a diffraction grating, where two lenses included in a relay optical system are different from one another in their focal lengths. The relay optical system includes a lens 73′ and a lens 74′, where the lens 73′ has a focal length of f1 while the lens 74′ has a focal length of f2. A positional relationship among front focal points and rear focal points of the lens 73′and the lens 74′ is same as that in the case of FIG. 48. In the arrangement in FIG. 49, by means of the relay optical system, the original hologram plate is imaged onto the hologram recording material for duplication 75 with a magnification of f2/f1. A divided hologram pattern and a grating pitch recorded in the original hologram plate 72 is thus recorded in the hologram recording material for duplication at f2/f1 times. According to this duplication method, even in case where a grating pitch of a final product of a hologram diffraction grating should be too small to produce an original hologram plate in the same grating pitch, the objective grating pitch, which is difficult to produce as it is, is achievable as a result of producing an original hologram plate with a coarser grating pitch, which is easier to produce, and duplication being performed therefrom where f1>f2.

A nineteenth embodiment according to the twenty-first and thirty-ninth aspects of the present invention is described next.

According to the present embodiment, in each the methods according to the seventeenth and eighteenth embodiments (the eighteenth through twentieth aspects of the present invention), light converging at a point equivalent to the light emitting point of the light source in the optical head device is applied to the original hologram plate 72 by means of the lens 71 as shown in FIG. 48. Then, from the original hologram plate 72, 0-th light converging at the light source light emitting point and 1-st diffracted light converging at a position equivalent to the light receiving point on the photodetector in the optical head device are generated. These two light beams again gather by the lenses 73 and 74 in the relay optical system on the plane of the hologram recording material for duplication 75, and after that, the 0-th light converges at a light emitting point' and the 1-st diffracted light converges at a light receiving point', as shown in FIG. 48. The two beams thus gathering on the plane of the hologram recording material for duplication 75 generate interference fringes, which are then applied to so as to expose the hologram recording material for duplication 75.

In FIG. 48, the plane of the original hologram plate 72 and the plane of the hologram recording material 75 for duplication correspond to the conjugate planes in imaging by means of the relay optical system, and simultaneously, a plane (a-plane in FIG. 48) of the light source light emitting point of the light generated by the original hologram plate and a plane (b-plane in FIG. 48) of the light source light emitting point' of the light produced through the relay optical system also correspond to conjugate planes in imaging.

According to the nineteenth embodiment, the light applied to the original hologram plate 72 has a wavelength in neighborhood of the light source wavelength of the optical head device in which the relevant hologram diffraction grating will be mounted, and is convergent light converging at a position equivalent to the light source light emitting point. As a result, the two beams applied to the hologram recording material for duplication 75 are convergent light converging at the light source light emitting point' produced through the lenses 73 and 74 of the relay optical system equivalent to the light source light emitting point and converting light converging at the light receiving point' equivalent to the light receiving point on the photodetector. Thereby, no aberration occurs in a spot formed on the photodetector as a result of being diffracted and-converged by the hologram diffraction grating thus produced by means of duplication when it is mounted in the optical head device. Also, the diffraction efficiency in the hologram diffraction grating is high throughout the whole area thereof.

This is because, since interference exposure is performed with the two beams at the wavelength which is the operation wavelength in the optical head device, which two beam correspond to reflected light from an optical disk and diffracted light applied to the photodetector in the optical head device, the interference fringes produced in the hologram recording material for duplication 75 forms a Bragg grating optimized for the two light waves used for producing them. Thereby, when the thus-produced hologram diffraction grating is used in the optical head device, returning light from the optical disk is applied to the hologram diffraction grating as convergent light converting at the light source light emitting point, Bragg requirements are satisfied throughout the whole area of the hologram diffraction grating at this time, and thus, 1-st diffracted light at high efficiency is generated therefrom.

FIG. 50 illustrates an example where the hologram in the original hologram plate 72 is configured of the plurality of divided holograms. When light converging at the light source light emitting light is applied to the original hologram plate 72, light beams emitted from the respective divided holograms produce a group of light receiving points as a result of they converging at the light receiving points corresponding to the respective different photo-detecting areas on the photodetector in the optical head device. 0-th light converging at the light source light emitting point and 1-st diffracted light converging at the group of the light receiving points again gather on the plane of the hologram recording material for duplication 75 through the lenses 73 and 74 of the relay optical system, which result in producing interference fringes there corresponding to the respective divided areas, which then expose the hologram recording material for duplication 75.

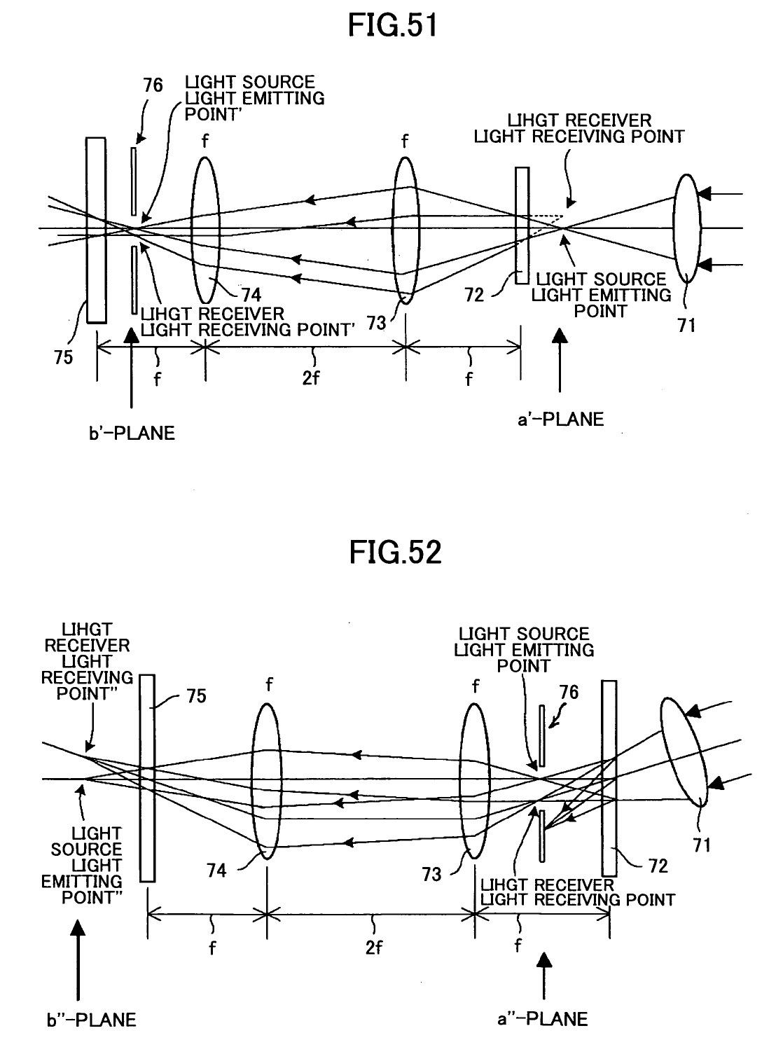

FIG. 51 illustrates another embodiment. In this example, light to be applied for duplication having a wavelength in neighborhood of the operation wavelength in the optical head device is converged at a point equivalent to the light source light emitting point in the optical head device once through the lens 71. Then, a divergent light beam diverging from this converging point is applied to the original hologram plate 72. From the original hologram plate 72, then, 0-th light transmitted thereby as it is and 1-st diffracted light diverging from a point equivalent to the photodetector light receiving point are generated as shown. These two beams once converges at two points behind a lens 74 through a relay optical system including lenses 73 and 74, and after that, diverge therefrom again. These two points of convergence are a light source light emitting point' which is an image of the light source light emitting point, and a light receiving point' which is an image of the light receiving point of the photodetector. Furthermore, according to this embodiment, the plane of the original hologram plate and the plane of the hologram recording material for duplication are set as being conjugate planes in imaging made by the relay optical system. Thereby, the divergent light diverting from the above-mentioned two converging points behind the lens 74 again gather on the plane of the hologram recording material for duplication 75 accurately. The divergent two beams thus gathering on the plane of the hologram recording material for duplication produce interference fringes, which is used to expose the hologram recording material for duplication 75.

In the embodiment shown in FIG. 51, the relay optical system includes the lenses 73 and 74, the two lenses are disposed so that a front focal point of the lens 73 is made coincident with the plane of the original hologram plate, a rear focal point of the lens 73 and a front focal point of the lens 74 are made coincident with one another, and also, a rear focal point of the lens 74 is made coincident with the plane of the hologram recording material for duplication.

The case of FIG. 51 is an example in which a divergent wave generated from the original hologram plate 72 having a wavefront in a phase opposite (conjugate) to that in the case of FIG. 48. Also in this case, the same as in the case of FIG. 48, a Bragg grating having no aberration is produced.

A twentieth embodiment according to the twenty-second and thirty-ninth aspects of the present invention is described next.

In the nineteenth embodiment (twenty-first aspect of the present invention), the duplication wavelength is in neighborhood of the operation wavelength in the optical head device. According to the twentieth embodiment, a hologram duplication wavelength is different from the operation wavelength in the optical head device. In case where the wavelengths are different and light to be applied for duplication is convergent light, a basic optical system is same as that shown in FIG. 48. However, the converging point at which convergent light applied to the original hologram plate by the lens 71 in the figure converges is not the light source light emitting point in the optical head device but, as the light to be applied to the original hologram plate in the case of FIG. 39, a point distant from the light source light emitting point located when the hologram diffraction grating thus produced is used in the optical head device according to the difference between the duplication wavelength and the operation wavelength in the optical head device (corresponding to the original plate exposure pseudo converging point (1) shown in FIG. 36).

At this time, the formulas (9) and (10) approximately hold with respect to the chief ray, assuming that an incidence angle (inside the duplication hologram recording material layer) of the chief ray of the duplication exposing convergent light is α1′, a diffraction angle (inside the duplication hologram recording material layer) of 1-st diffracted light from the original hologram plate is β1′, a diffraction angle (inside the duplication hologram recording material layer) of 1-st diffracted light applied to the photodetector when the thus-produced diffraction grating is used in the optical head device is β0, a refractive index of the duplication hologram recording material layer at the operation wavelength λ0 of the optical head device is n0, and the refractive index of the same at the duplication wavelength λ1′ is n1′.

On the other hand, in case where the wavelengths are different and divergent light is used as light to be applied for duplication to the original hologram plate grating, a basic optical system is same as that in FIG. 51. However, the converging point at which convergent light applied to the original hologram plate through the lens 71 in the figure converges is not the light source light emitting point in the optical head device but, as the light to be applied to the original hologram plate in the case of FIG. 40, a point distant from the light source light emitting point located when the hologram diffraction grating thus produced is used in the optical head device according to the difference between the duplication wavelength and the operation wavelength in the optical head device (corresponding to the original plate exposure pseudo converging point (1) shown in FIG. 36). Divergent light diverging from this converging point is then applied to the original hologram plate. Also at this time, the formulas (9) and (10) approximately hold with respect to the chief ray, on an incidence angle (inside the duplication hologram recording material layer) of the duplication exposing convergent light, a diffraction angle (inside the duplication hologram recording material layer) of 1-st diffracted light from the original hologram plate and a diffraction angle (inside the duplication hologram recording material layer) of 1-st diffracted light applied to the photodetector when the thus-produced diffraction grating is used in the optical head device.

A twenty-first embodiment according to the twenty-third and thirty-ninth aspects of the present invention is described next.

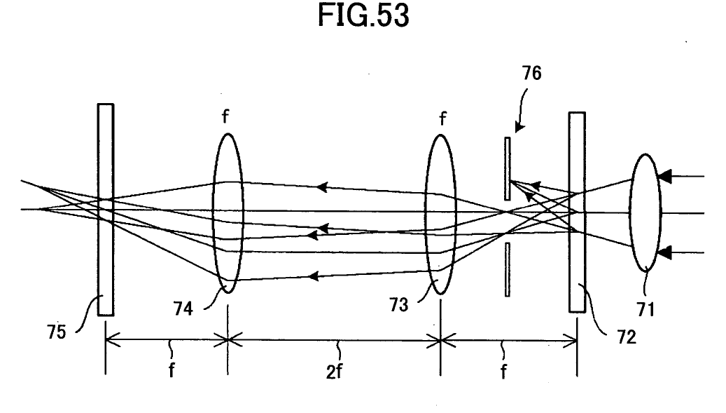

According to the present embodiment, in the method of duplicating a hologram diffraction grating in any of the seventeenth and eighteenth embodiments (eighteenth through twentieth aspects of the present invention), the duplication exposure light to be applied to the original hologram plate is applied to the original hologram plate 72 in a form of convergent light converging at a point equivalent to one of photodetector light receiving points in the optical head device by means of the lens 71, as shown in FIG. 52. From the original hologram plate 72, then, 0-th light converging at the photodetector light receiving point and 1-st diffracted light converging at a point equivalent to the light source light emitting point in the optical head device are generated. These two beams again gather on the plane of the hologram recording material for duplication through the lenses 73 and 74 in the relay optical system, and after that, the 0-th light converges at a photodetector light receiving point” and the 1-st diffracted light converges at a light source light emitting point”, as shown in FIG. 52. The two beams thus gathering on the plane of the hologram recording material for duplication generate interference fringes, which are then applied to so as to expose thereto the hologram recording material for duplication 75.

In FIG. 52, the plane of the original hologram plate and the plane 72 of the hologram recording material for duplication 75 correspond to the conjugate planes in imaging of the relay optical system, and simultaneously, a plane (a″-plane in FIG. 52) of the light source light emitting point of the light generated by the original hologram plate and a plane (b″-plane in FIG. 52) of the light source light emitting point” of the light produced through the relay optical system also correspond to conjugate planes in imaging.

According to the twenty-first embodiment, the light applied to the original hologram plate 72 has a wavelength in neighborhood of the light source wavelength of the optical head device in which the relevant hologram diffraction grating is mounted, and is convergent light converging at a position equivalent to the photodetector light receiving point in the optical head device. As a result, the two beams applied to the hologram recording material for duplication 75 are convergent light converging at the light source light emitting point” produced through the lenses 73 and 74 of the relay optical system equivalent to the light source light emitting point and converting light converging at the light receiving point” equivalent to the light receiving point on the photodetector in the optical head device. Thereby, no aberration occurs in a spot formed on the photodetector as a result of being diffracted and converged by the hologram diffraction grating thus produced by means of duplication when it is applied in the optical head device. Also, the diffraction efficiency in the hologram diffraction grating is high throughout the whole area thereof. This is because, since interference exposure is performed with the two beams at the wavelength which is the operation wavelength in the optical head device, which two beams correspond to reflected light from an optical disk and diffracted light applied to the photodetector, the interference fringes produced in the hologram recording material for duplication 75 forms a Bragg grating optimized for the two light waves used for producing the hologram. Thereby, when the thus-produced hologram diffraction grating is used in the optical head device, returning light from the optical disk is applied to the hologram diffraction grating as convergent light converting at the light source light emitting point, Bragg requirements are satisfied throughout the whole area of the hologram diffraction grating at this time, and thus, 1-st diffracted light at high efficiency is generated therefrom.

Other than the method shown in FIG. 52, it is also possible that, as shown in FIG. 41, once light is converged at a point equivalent to one of the photodetector light receiving points in the optical head device, divergent light diverging from this point is then applied to the original hologram plate, 0-th light and 1-st diffracted light generated from the original hologram plate are made to gather on the hologram recording material for duplication through the relay optical system, and thus, the desired interference exposure is achieved.

A twenty-second embodiment according to the twenty-fourth and thirty-ninth aspects of the present invention is described next.

In the twenty-first embodiment (twenty-third aspect of the present invention), the duplication wavelength is in neighborhood of the operation wavelength in the optical head device. According to the twenty-second embodiment, a hologram duplication wavelength is different from the operation wavelength in the optical head device. In case where the wavelengths are different and light to be applied for duplication is convergent light, a basic optical system is same as that shown in FIG. 52. However, the converging point at which convergent light applied to the original hologram plate by the lens 71 in the figure converges is not the photodetector light receiving point in the optical head device but, as the light to be applied to the original hologram plate in the case of FIG. 42, a point distant from the photodetector light receiving point located when the hologram diffraction grating thus produced is used in the optical head device according to the difference between the duplication wavelength and the operation wavelength in the optical head device (corresponding to the original plate exposure pseudo converging point (2) shown in FIG. 36). At this time, the formulas (9) and (10) approximately hold with respect to the chief ray on an incidence angle (inside the duplication hologram recording material layer) of the duplication exposing convergent light, a diffraction angle (inside the duplication hologram recording material layer) of 1-st diffracted light from the original hologram plate and a diffraction angle (inside the duplication hologram recording material layer) of 1-st diffracted light applied to the photodetector when the thus-produced diffraction grating is used in the optical head device.

On the other hand, in case where these wavelengths are different and divergent light is used as light to be applied for duplication to the original hologram plate grating, a basic optical system is same as that in FIG. 52. However, as shown in FIG. 43, light to be applied is such as that which is made to once converge at a point (corresponding to the original plate exposure pseudo converging point (2) shown in FIG. 36) different from the photodetector light receiving point in the optical head device according to the difference between the duplication exposure wavelength and the operation wavelength in the optical head device by means of a lens. Then, divergent light diverging from this point is applied to the original hologram plate. From the original hologram plate, 0-th light transmitted thereby as it is and 1-st diffracted light diverging from the point corresponding to the light source light emitting point in the optical head device but different therefrom according to the difference in the wavelengths are generated. Then, the two beams, i.e., the 0-th light and the 1-st diffracted light produce interference fringes through the relay optical system, which are used to expose the hologram recording material for duplication, and thus, a hologram is duplicated therein. At this time, the chief ray in the duplication applying light and the chief ray in the diffracted light approximately conform to the figures (9) and (10) described above.

In the twentieth and twenty-second embodiments (twenty-second and twenty-fourth aspects of the present invention), if the duplication wavelength and the operation wavelength in the optical head device are largely different from one another, diffracted light may have aberration due to this large difference in the wavelengths when the hologram diffraction grating thus obtained through duplication is used in the optical head device. In order to solve this problem, as shown in FIG. 46, a phase plate 63 providing aberration for canceling out the above-mentioned aberration otherwise occurring due to the difference in the wavelengths may be disposed in the relay optical system shown in FIG. 48 on a light path of the beam applied to the original hologram plate in the hologram diffraction grating duplication process. Alternatively, instead of the phase plate for canceling out the expected aberration, it is also possible to configure the lens 71 used for applying light to the original hologram plate so that the lens 71 provides aberration for canceling out the expected aberration. Further alternatively, it is also possible to dispose a hologram providing aberration for canceling out the expected aberration in the original hologram plate light applying optical system, and 1-st diffracted light from this hologram is used to be applied to the original hologram plate.

A twenty-third embodiment according to the twenty-fifth, twenty-sixth, twenty-seventh and thirty-ninth aspects of the present invention is described next.

According to this embodiment, in the method of duplicating a hologram diffraction grating in any of the seventeenth through twenty-second embodiments (eighteenth through twenty-fourth aspects of the present invention), exposure to interference fringes is performed only with two beams, i.e., 0-th light and one of 1-st diffracted light(i.e., one of +1-st diffracted light and −1-st diffracted light). In FIG. 53, a spatial filter 76 is disposed in the proximity to a plane on which the 0-th light and the 1-st diffracted light generated from the original hologram plate converge. This spatial filter 76 has an aperture such as that which transmits only the 0-th light and the one of 1-st diffracted light generated from the original hologram plate, and blocks the other-side 1-st diffracted light and the higher-order diffracted light. By providing the spatial filter 76, even when diffracted light other than the 0-th light and the one of 1-st diffracted light is generated, it is blocked by the spatial filter 76 appropriately. Accordingly, interference fringes produced only from the two beams, i.e., the 0-th light and the one of 1-st diffracted light are used to expose the hologram recording material for duplication 75. The hologram diffraction grating produced by means of duplication with interference purely produced by these two beams hardly generates diffracted light other than the necessary 1-st diffracted light, and thus, it becomes possible to achieve duplication for a hologram diffraction grating having high diffraction efficiency.

FIG. 51 illustrates another embodiment. In case where divergent light is applied to the original hologram plate 72, a spatial filter 76 is disposed behind the second lens 74 of the relay optical system in the proximity to a plane on which 0-th light converges, only the 0-th light and one of 1-st diffracted light are transmitted thereby, the other diffracted light is blocked thereby, and thus, only these two beams thus transmitted are used to produce interference fringes for exposing the hologram recording material for duplication 75. In another embodiment, in case where convergent light converging at the photodetector light receiving point shown in FIG. 52 is applied to the original hologram plate 72, the spatial filter 76 should be disposed as in the case of FIG. 53, between the original hologram plate 72 and the lens 73 in proximity to the converging point.

There, it is preferable that 0-th light and 1-st diffracted light transmitted by the spatial filter 76 are equal to one another in the intensities. This is because when two beams used for producing interference have the equal intensities, interference fringes produced therefrom has the maximum contrast. Thereby, it becomes possible to provide a hologram diffraction grating by means of duplication with high diffraction efficiency. An embodiment of the original hologram plate in this case is described next. The original hologram plate is a surface relief diffraction grating having rectangular projections and depressions on a transparent substrate, and, as an example, a rectangular grating with a duty of 0.5 is formed on one side of a transparent glass substrate having a refractive index n=1.5.

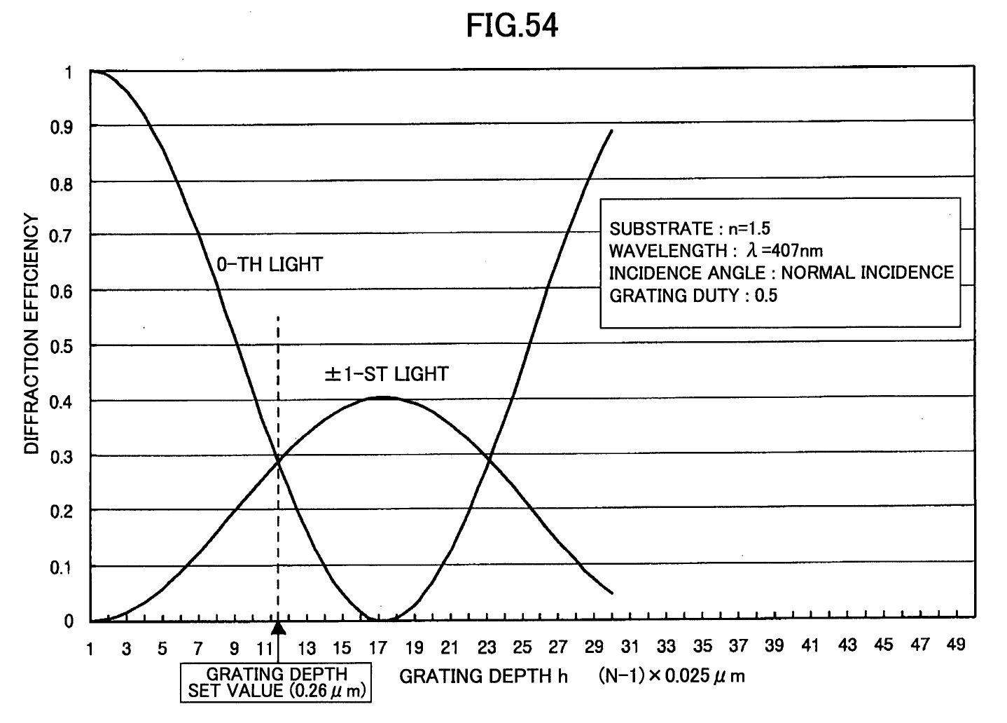

FIG. 54 illustrates a relationship between a grating depth of the rectangular grating and a diffraction efficiency on ±1-st diffracted light obtained therefrom. From the figure, it can be seen that when the depth of 0.26 μm is adopted, the diffraction efficiencies become equal between the 0-th light and the ±1-st diffracted light. A rectangular grating with this depth is used as the original hologram plate 72 in the duplication exposing system shown in FIG. 53. When light for duplication is applied to this rectangular grating, 0-th light and ±1-st light are generated therefrom. However, the spatial filter 76 is disposed at the converging point of the 0-th light, only the 0-th light and the one of 1-st diffracted light are transmitted thereby, and the other-side 1-st diffracted light and higher-order diffracted light are blocked thereby. As a result, through the relay optical system, only the 0-th light and the one of 1-st diffracted light having the equal intensities are used to produce two-beam interference fringes used to expose the hologram recording material for duplication 75.

According to the present embodiment, the rectangular grating is formed in the original hologram plate. However, the original hologram plate is not limited thereto. Any other grating may also be used in the original hologram plate as long as it has respective diffraction efficiencies on 0-th light and one of 1-st diffracted light approximately equal. Even if diffracted light in any other order is generated, as a result of a spatial filter which blocks unnecessary diffracted light is used together, ideal two-beam interference duplication exposure can be achieved.

According to the twenty-sixth aspect of the present invention, in the method of duplicating a diffraction grating according to any of the twenty-first through twenty-fifth aspects of the present invention, the plane including the converging point and the diverting point of light applied to the original hologram plate for duplication and perpendicular to the optical axis of the relay optical system; and the plane including the points at which the beams originating from these points again converge and perpendicular to the optical axis of the relay optical system have the relationship of the conjugate planes in imaging by means of the relay optical system. This relationship is described above for the nineteenth embodiment and so forth. In fact, for example, in FIG. 48, the plane of the original hologram plate and the plane of the hologram recording material for duplication are the conjugate planes in imaging by means of the relay optical system, and simultaneously, the plane of the light source light emitting point (the a-plane in FIG. 48) produced by the original hologram plate and the light source light emitting point' (the b-plane in FIG. 48) produced through the relay optical system are also the conjugate planes in imaging.

Further, according to the twenty-seventh aspect of the present invention, in the method of duplicating a diffraction grating according to any of the twenty-first through twenty-sixth aspects of the present invention, the imaging magnification of the relay optical system to the plane of the hologram recording material for duplication from the plane of the original hologram plate is equal to the imaging magnification of the relay optical system to the original hologram plate from the converging or diverging point of light to be applied for duplication. Specifically, the imaging magnification M1 of the relay optical system to the plane of the hologram recording material for duplication from the plane of the original hologram plate is made equal to the imaging magnification M2 of the relay optical system to the original hologram plate from the converging or diverging point of the light to be applied for duplication. Thereby, it becomes possible to accurately project and transfer a wavefront of 0-th light and 1-st diffracted light from the original hologram plate to the plane of the hologram recording material for duplication.

For this purpose, the relay optical system described above for the eighteenth embodiment should be applied. That is, in the relay optical system shown in FIG. 48 (or FIG. 49), the first lens system 73 (or 73′) and the second lens system 74 (74′) are separated by a distance of a sum of their focal lengths (2f or f1 +f2), and also, the converging or diverging point of the light to be applied for duplication is disposed before or behind the original hologram plate 72 with a separation from the original hologram plate 73 not more than the focal length of the first lens system 73 (or 73′). As a result, from imaging characteristics of the relay optical system made of the combined lens system, the imaging magnification M1 of the original hologram plate and the imaging magnification M2 of the converging or diverging point of the light to be applied for duplication can always be made equal to one another.

By providing the above-described configurations, wavefront of 0-th light and 1-st diffracted light generated from the original hologram plate is accurately projected and transferred to the hologram recording material for duplication, and thus, it becomes possible to accurately produce a hologram diffraction grating similar to that in the original hologram plate.

A twenty-fourth embodiment according to the twenty-eighth and thirty-ninth aspects of the present invention is described next.

When a hologram diffraction grating produced by the method in any of the fifth through twenty-third embodiments (sixth through twenty-seventh aspects of the present invention) is used in an optical head device, it is preferable that, on a going light path from a light source to an optical disk in the optical head device, almost all of a light beam is transmitted by the hologram diffraction grating (in other words, 0-th diffraction efficiency is high), a loss occurring in the light emitted from the light source is thus reduced as much as possible, and thus, a recording speed onto the optical disk is improved, while, on a returning light path along which reflected light from the optical disk returns to a photodetector, almost all of the returning beam is diffracted by the hologram diffraction grating (in other words, 1-st diffraction efficiency is high at this time), luminous energy applied to the photodetector is increased, and thus, the S/N ratio in the signal detection is increased and reproduction speed is increased.

In order to achieve these advantages, a polarization diffraction grating may be applied as the hologram diffraction grating. This is a diffraction grating having diffraction characteristics different between orthogonal polarization directions, and therewith, no change in refractive index occurs in the diffraction grating with respect to a polarization direction in light applied on the going light path, a cyclic configuration in the diffraction grating is not sensed there and thus, the light is not diffracted and thus goes straightly therethrough. Accordingly, the transmittance is high for the going light path. Furthermore, by providing a ¼ phase plate between the diffraction grating and the optical disk, as a result of light passing through this ¼ phase plate twice on the going and returning light paths, the polarization direction in the light returning at the diffraction grating becomes perpendicular to that appearing on the going light path. With respect to the light with the polarization direction perpendicular to that appearing on the going light path, the polarization diffraction grating has the maximum cyclic change in the refractive index, and thus, almost all of the light applied to the diffraction grating on the returning light path is diffracted and thus is applied to the photodetector.

As hologram recording material for the duplication exposure for achieving such a polarization diffraction grating by means of interference exposure described above for the fifth through twenty-third embodiments (sixth through twenty-seventh aspects of the present invention), a hologram recording material including liquid crystal may be applied. As an example thereof, holographic polymer dispersed liquid crystal (HPDLC), photo-polymerized liquid crystal (PPLC) or such may be cited.

The former HPDLC is a hologram recording material produced by dispersing liquid crystal in polymeric monomers. When the above-mentioned interference fringes are applied for exposing this hologram recording material thereto, the monomers moves to the bright parts in the interference fringes, and are hardened there. In the dark parts of the interference fringes, the liquid crystal is thus left, is pulled by the hardened polymers in the bright pats, and thus, is oriented in a specific direction. By this orientation, with respect to perpendicularly polarized light applied thereto, no refractive index change occurs and thus almost all of the light with one polarization direction is transmitted thereby. On the other hand, with respect to the light with the other polarization direction, this direction coincides with the direction in which the liquid crystal is oriented as mentioned above and thus the refractive index is large therefor, the applied light senses the change in the refractive index, and thus, is diffracted thereby. Thus, HPDLC functions as the polarization diffraction grating.

The latter PPLC is a hologram recording material produced as a result of liquid crystal having a photo-polymerization functional group attached thereto being inserted between transparent electrodes (ITO or such) and a substrate having an orientation layer for orienting the liquid crystal, and the liquid crystal is thus orientated horizontally. When interference fringes are applied to for exposing this, the liquid crystal molecules in the bright parts of the interference fringes are polymerized and thus hardened. On the other hand, in the dark parts in the interference fringes, the liquid crystal molecules are left unhardened. Then, light is applied thereto in a condition in which a voltage is applied to the transparent electrodes in which the liquid crystal layer is inserted. At this time, the liquid crystal in the dark parts is orientated in a direction perpendicular to the substrate and hardened. As a result, corresponding to the bright and dark parts in the interference fringes applied, the orientation in the liquid crystal has a horizontal/vertical cyclic structure. Then, when polarized light having mutually perpendicular polarization directions is applied to the diffraction grating recorded as described above, with respect to one polarization direction (coincident with the direction in which the short axis of the liquid molecules are oriented horizontally), applied light does not sense refractive index change even through the horizontal/vertical orientation, and thus, almost all thereof is transmitted thereby. On the other hand, with respect to the other direction perpendicular thereto, which coincides with the direction of the long axis of the liquid crystal molecules oriented horizontally, the applied light senses refractive index change occurring due to the horizontal/vertical orientation, and thus, almost all of the applied light is diffracted thereby.

By applying a hologram recording material made of a liquid crystal material such as the above-mentioned HPDLC, PPLC or such for the duplication exposure, it becomes possible to cause a hologram diffraction grating produced by means of interference exposure to have polarization characteristics. Furthermore, by optimizing the exposing amount applied in the duplication exposure, it becomes possible to cause a thus-produced hologram diffraction grating to have a 1-st diffraction efficiency in characteristics of the curve II in FIG. 11. As a result, it becomes possible to achieve a polarization diffraction grating having a high transmittance for the going light path and a high diffraction efficiency for the returning light path, and thus being optimum for the optical head device.

A twenty-fifth embodiment according to the twenty-ninth, thirtieth and thirty-ninety aspects of the present invention is described next.

In the method of duplication according to any of the fifth through twenty-fourth embodiments (sixth through twenty-eighth aspects of the present invention), it is preferable that the original hologram plate hologram diffraction grating (original hologram plate 30) in each of the fifth through eleventh embodiments (sixth through twelfth aspects of the present invention) and the second original hologram plate hologram diffraction grating (second original hologram plate 302) in each of the twelfth through fifteenth embodiments (thirteenth through sixteenth aspects of the present invention) are such that interference fringes produced by means of 0-th light and 1-st diffracted light generated from the original hologram plate for a hologram recording material for duplication have high contrast. In other words, as a result of interference fringes thus having high contrast being used for the exposure, it is possible to cause a hologram diffraction grating thus obtained by means of duplication has a high diffraction efficiency. For this purpose, it is necessary to configure a hologram diffraction grating in the original hologram plate which thereby generates 0-th light and 1-st diffracted light have approximately equal intensities, and also, does not generate diffracted light other than the 0-th light and the 1-st diffracted light.

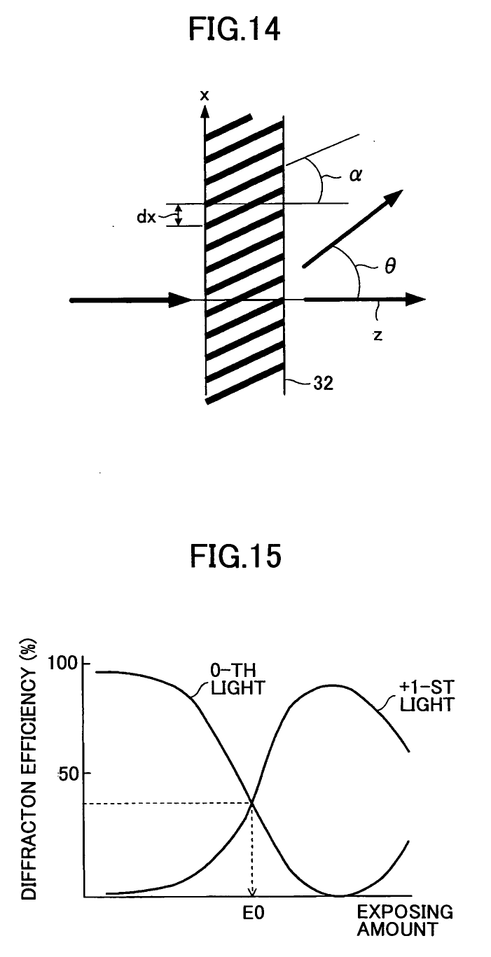

In order to achieve such an original hologram plate, for example, a volume phase diffraction grating may be applied as the original hologram plate. FIG. 14 shows a grating sectional view of one example of a volume phase diffraction grating 32. As shown, a cyclic grating made by alternate arrangement of high and low refractive index parts exists in a hologram layer three-dimensionally. In the layer, as shown, a hologram (interference fringes) is formed obliquely, and thus, a configuration is provided by which a specific diffracted light is made to be transmitted thereby at a high efficiency. Light of a wavelength λ in case where the light is applied perpendicularly is discussed next. Assuming that a pitch of the grating on the surface is dx, a grating inclination angle is α, an average refractive index in the grating layer is n, a diffraction angle of diffracted light is θ, and a diffraction angle in the layer is θ′,

dx×sin θ=λ

As a result,

sin θ=λ/dx

And also,

sin θ=n×sin θ′

Accordingly,

sin θ′=λ/n×dx

Thus, Bragg requirements for diffraction are satisfied when the following formula (11) holds, and at this time, only +1-st diffracted light is generated as diffracted light:

θ′=sin⁻¹λ/n×dx=2α (11)

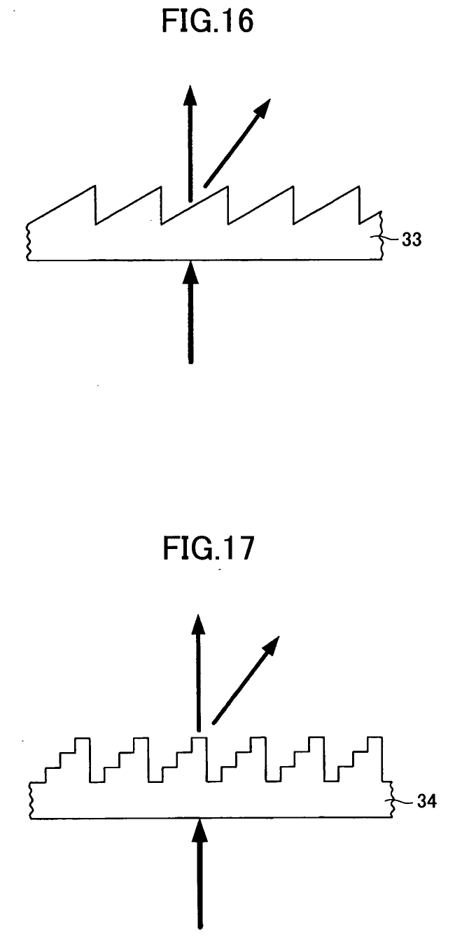

FIG. 15 shows a relationship between an exposing amount in interference exposure and a diffraction efficiency when a volume phase diffraction grating is produced by means of the interference exposure in a manner such that the formula (11) holds. As the exposing amount in the interference exposure is increased, 0-th light decreases, and 1-st diffracted light increases. At the exposing amount in the interference exposure of E0, the 0-th light and the 1-st diffracted light become equal to one another in the intensities. Thus, in producing a volume phase diffraction grating, by optimizing the exposing amount in the interference exposure, it is possible to yield an ideal original hologram plate in which 0-th light and 1-st diffracted light are equal to one another in the intensities, and also, no other diffracted light is generated therefrom. By performing duplication in the method according to any of the second through seventh embodiments described above with the use of this original hologram plate, it becomes possible to maximize interference fringe contrast in duplication exposure, and thereby, a duplicated diffraction grating having a high efficiency can be produced. Material of which such a volume phase diffraction grating is produced is, typically, photopolymer, a gelatin bichromate, Fe-added LiNbO₃ or such.

A twenty-sixth embodiment according to the thirty-first and thirty-ninth aspects of the present invention is described next.

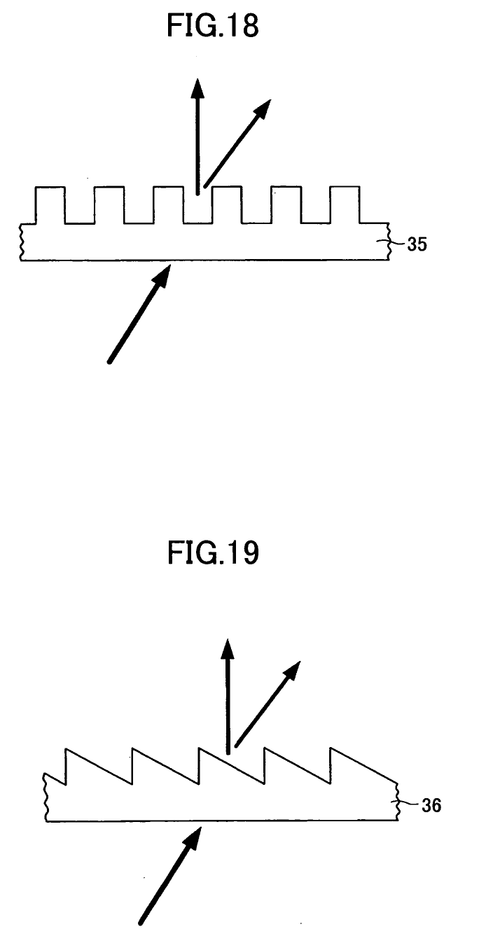

For the above-mentioned twenty-fifth embodiment (twenty-ninth and thirtieth aspects of the present invention), the example in which the original hologram plate or the second original hologram plate is achieved by a volume phase diffraction grating. However, it is also possible to achieve the original hologram plate by a surface relief diffraction grating such as that shown in FIG. 16 or FIG. 17, instead.

FIG. 16 shows an example of achieving the original hologram plate by a blazed diffraction grating of the surface relief diffraction grating. In this case, in a blazed diffraction grating, a blazed angle is formed so as to enhance +1-st diffracted light, also a grating depth is set so that 0-th light and +1-st diffracted light have equal intensities, and the original hologram plate 33 for duplication is produced to satisfy these requirements.

FIG. 17 shows an example of achieving an original hologram plate 34 in which the blazed diffraction grating described above with reference to FIG. 16 is approximated by a step-like grating. In this case, as a result of the grating being achieved by a step-like shape, fabrication thereof is made easier.

A twenty-seventh embodiment according to thirty-second and thirty-ninth aspects of the present invention is described next.

It is possible to make 0-th light and +1-st diffracted light have approximately equal intensities with the use of a blazed diffraction grating such as that shown in FIG. 16 or FIG. 17. However, in this way, some amount of diffracted light in higher orders is also generated. In order to prevent diffracted light in higher orders from being generated, as shown in FIG. 18, light is applied to a rectangular grating obliquely so that 0-th light emitted obliquely and −1-st diffracted light emitted in a direction perpendicular to the substrate are generated. In such a way of diffraction from the oblique incidence, generation of diffracted light other than 0-th light and −1-st diffracted light is controlled to a well reduced level. In order to make the 0-th light and the −1-st diffracted light have approximately equal intensities, the depth of the rectangular grating should be adjusted.

FIG. 19 shows another embodiment of an original hologram plate 36 employing a blazed diffraction grating as a surface relief diffraction grating. In this embodiment, light is applied thereto obliquely, so that 0-th light emitted straightly and −1-st diffracted light emitted in a direction perpendicular to the substrate through diffraction are generated, where generation of the other diffracted light can be controlled to a well reduced level. In order to make the 0-th light and the −1-st diffracted light have approximately equal intensities, the depth of the blazed grating should be adjusted.

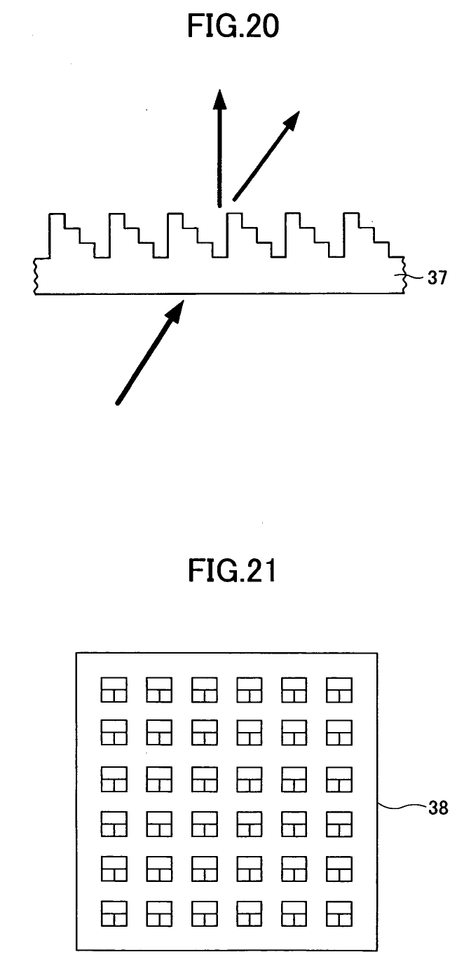

FIG. 20 shows another example in which the blazed diffraction grating described above with reference to FIG. 19 is approximated by a step-like grating as shown. Also in this case, it is possible to make 0-th light and −1-st diffracted light have approximately equal intensities and also to control generation of the diffracted light in other orders to a well reduced level.

A twenty-eighth embodiment according to the thirty-third and thirty-ninth aspects of the present invention is described next.

In the present embodiment, a plurality of hologram diffraction gratings are produced by means of duplication with a method of exposing a hologram recording material for duplication to interference fringes produced from the original hologram diffraction grating (original hologram plate 30) according to any of the fifth through eleventh embodiments (sixth through twelfth aspects of the present invention) or the second original hologram plate hologram diffraction grating (second original hologram plate 302) according to any of the twelfth through fifteenth embodiments (thirteenth through sixteenth aspects of the present invention). FIG. 21 shows a state in which a plurality of hologram diffraction gratings 38a each produced according to the method in the second embodiment or the third embodiment are arranged on a common substrate so as to produce an original hologram plate 38. This is the same as one in which a plurality of original hologram plates 26 (30) each of which is divided into a plurality of areas for being applied in the optical head device as mentioned above for the second or third embodiment are arranged in a manner of matrix.

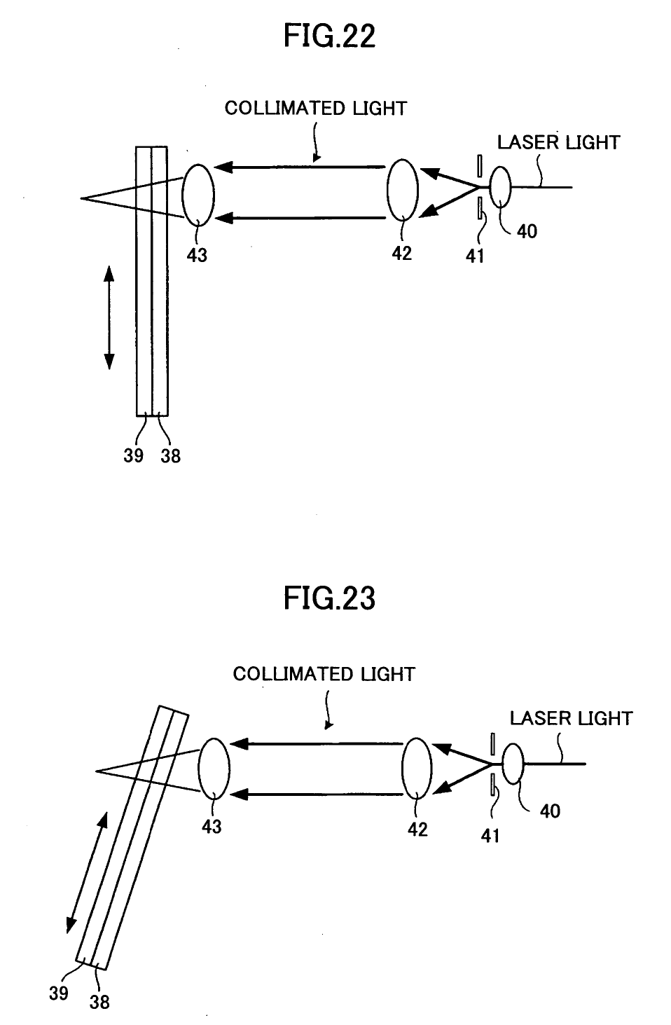

In the method of exposure for duplication in the present embodiment, as shown in FIG. 22, the original hologram plate 38 is made approximately in contact with a hologram recording material for duplication 39. Then, laser light for duplication is expanded by means of a lens 40, flare light of the beam if any is cut out as the necessity arises as a result of the beam being made to pass through a pin hole (or an aperture) 41, the beam is changed into collimated light by means of a collimator lens 42, and after that, the beam is applied to one of the plurality of hologram diffraction gratings 38a in the original hologram plate 38 after the beam is converged by means of a converging lens 43 for making the beam converge at a point equivalent to a light emitting point on a light source of an optical head device in which the thus-produced hologram diffraction grating by means of duplication is applied.

Then, after performing duplication exposure for a predetermined interval, the original hologram plate 38 and the hologram recording material for duplication 39 made approximately in contact with one another are moved integrally on the plane of substrate so that adjacent hologram diffraction grating in the original hologram plate is then used for the duplication, and then, duplication exposure is performed again therefor. The above-mentioned processes are repeated until all the hologram gratings included in the original hologram plate are used to the duplication exposure, and thus, all the hologram diffraction gratings in the original hologram plate are transferred to the hologram recording material for duplication 39 by means of interference exposure of the hologram recording material for duplication 39.

In a case where a wavelength of light to be applied for the duplication is in neighborhood to an operation wavelength of the optical head device, the converging point produced by the converging lens 43 is a position equivalent to the light emitting point on the light source of the optical head device. When the duplication wavelength is different from the operation wavelength in the optical head device, a configuration is made such that light is made to be applied to the original hologram plate 38 in a manner such that the light converges at a point different from the light emitting point on the light source by a distance determined according to the difference between the duplication wavelength and the operation wavelength in the optical head device.

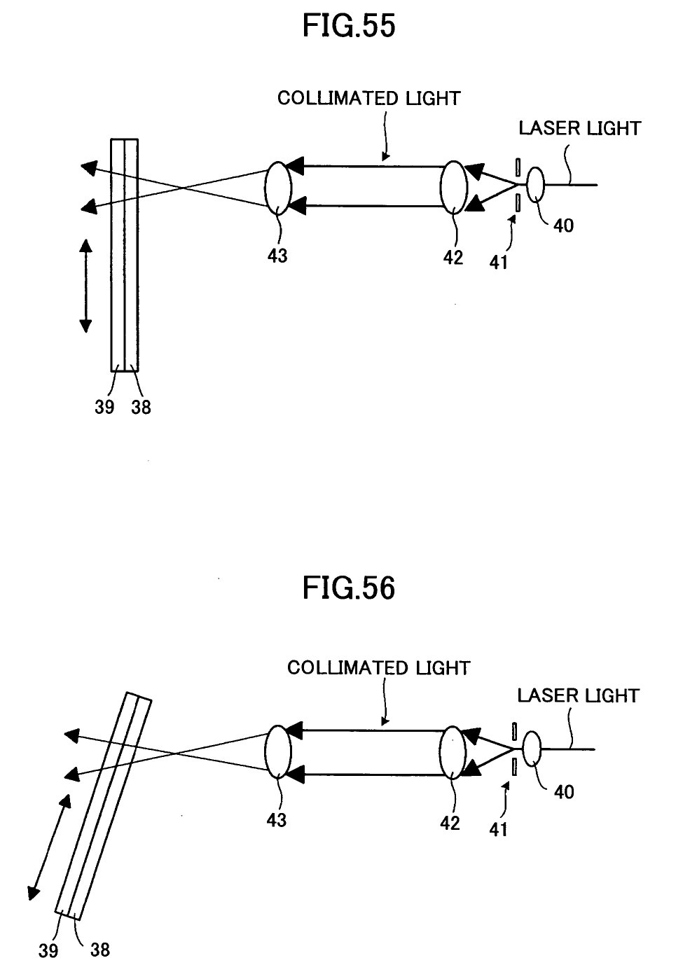

As another example, as shown in FIG. 55, after light is converged by means of the converging lens 43 once, divergent light diverging from this converging point is applied to a single hologram grating in the original hologram plate 38, and in this condition, duplication exposure is performed. At this time, in a case were the duplication wavelength is in neighborhood of the operation wavelength of the optical head device, the converging point thus produced through the converging lens 43 is set at a point equivalent to the light emitting point on the light source in the optical head device. When the duplication wavelength and the operation wavelength in the optical head device are different, the light is made to converge at a point different from the light emitting point on the light source by a distance according to the difference in the wavelengths, and divergent light from the point is applied to the original hologram plate 38.

FIG. 23 illustrates another example of a method of duplication corresponding to the method in the oblique exposure way according to the ninth or tenth embodiment (the tenth or eleventh aspect of the present invention) descried above. In this method, as shown, with respect to convergent light for duplication, the original hologram plate 38 and the hologram recording material for duplication 39 made approximately in contact with one another are disposed obliquely, and duplication exposure is performed in a condition in which the convergent light for duplication converges at a point equivalent to a light receiving point on a photodetector in an optical head device in which a thus-produced hologram diffraction grating by means of duplication is applied. Then, the original hologram plate 38 and the hologram recording material for duplication 39 made approximately in contact with one another are integrally moved in the plane of the substrate by a predetermined distance, and then, duplication exposure is performed again. These processes are repeated until all the hologram diffraction gratings included in the original hologram plate are transferred to the hologram recording material for duplication 39 by means of the interference exposure.

At this time, in a case were the duplication wavelength is in neighborhood of the operation wavelength of the optical head device, the converging point thus produced through the converging lens 43 is set at a point equivalent to the light receiving point on the photodetector in the optical head device. When the duplication wavelength and the operation wavelength in the optical head device are different, the light is made to converge at a point different from the light receiving point on the photodetector by a distance determined according to the difference in the wavelengths, which light is applied to the original hologram plate 38.

In another example, as shown in FIG. 56, the original hologram plate 38 and the hologram recording material for duplication 39 are made approximately in contact with one another and are disposed in a state of being inclined as shown. Then, after light is converged by means of the converging lens 43 once, divergent light diverging from this converging point is applied to a single hologram grating in the original hologram plate 38, and in this condition, duplication exposure is performed. At this time, in a case were the duplication wavelength is in neighborhood of the operation wavelength of the optical head device, the converging point thus produced through the converging lens 43 is set at a point equivalent to the light receiving point on the photodetector in the optical head device. When the duplication wavelength and the operation wavelength in the optical head device are different, the light is made to converge at a point different from the light receiving point on the photodetector by a distance determined according to the difference in the wavelengths, and divergent light from the point is applied to the original hologram plate 38.

In each of the above-described methods, instead of integrally moving the original hologram plate 38 and the hologram recording material for duplication 39 during the duplication exposure as mentioned above, it is also possible that, while the original hologram plate 38 and the hologram recording material 39 are fixed, the light to be applied for exposure is moved by a predetermined distance. In this case, a part of the exposure light applying optical system is moved along a direction along a plane of the original hologram plate.

After the plurality of hologram diffraction gratings in the original hologram plate 38 are thus duplicated in or transferred to the hologram recording material for duplication 39, a plurality of hologram diffraction gratings thus produced by means of duplication are separated as a result of they being carved by means of a diamond cutter or such into single separate hologram diffraction gratings, and then, each thereof is mounted in a respective one of the optical head devices. According to the method, it becomes possible to easily produce many hologram diffraction gratings, and thus, to improve the productivity.

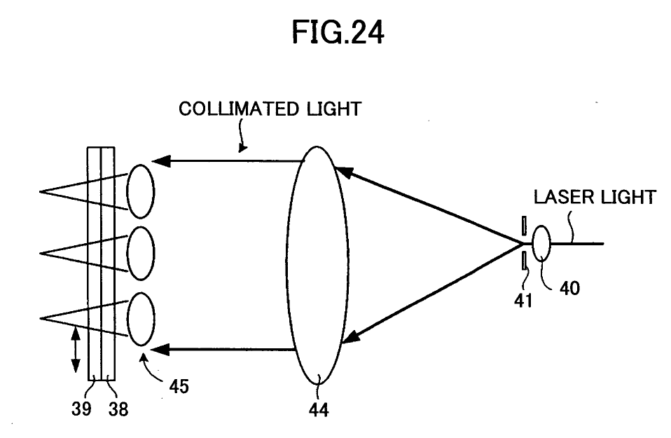

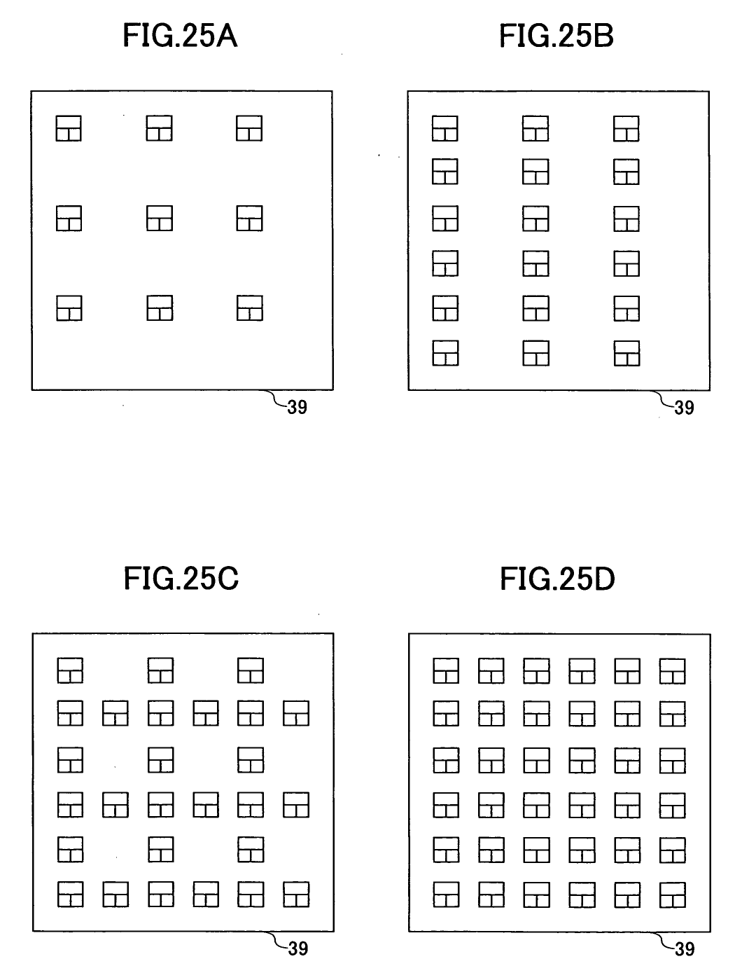

As another method of duplicating a diffraction grating, a twenty-ninth embodiment according to the thirty-fourth and thirty-ninth aspects of the present invention is described next, with reference to FIGS. 24 and 25A through 25D.

In the present embodiment, different from the above-mentioned method in which the plurality of hologram diffraction gratings included in the original hologram plate 38 are used to expose the hologram recording material for duplication 39 one by one, a plurality of hologram diffraction gratings are used for the exposure together at once, while the original hologram plate 38 is moved (or, instead, the exposure applying light is moved) for exposure duplication for another groups of hologram diffraction gratings, and thus, all the hologram diffraction gratings included in the original hologram plate 38 are duplicated. In FIG. 24, laser light is transformed into divergent light by means of a lens 40, the divergent light is made to pass through a pin hole (or an aperture) 41 if necessary for the purpose of removing flare light therefrom, the light is then transformed into parallel light by means of a collimator lens 44, and then, the light is applied to a lens array 45. In the example of FIG. 24, the lens array 45 includes total 9 lenses, i.e., three lenses along the figure by three lenses along a direction perpendicular to the figure. As the original hologram plate 38, as shown in FIG. 21, an original hologram plate in which many hologram diffraction gratings 38a are arranged is used, and the original hologram plate 38 is disposed approximately in contact with the hologram recording material for duplication 39.

A specific duplication process is described next. First, as shown in FIG. 25A, total nine diffraction gratings, i.e., 9=3×3, are duplicated by means of exposure. After that, the original hologram plate 38 and the hologram recording material for duplication 39 are moved integrally vertically in the figure by a distance of the grating unit interval. Then, as shown in FIG. 25B, total nine diffraction gratings, i.e., 9=3×3, are again duplicated by means of exposure for a different group. After that, the original hologram plate 38 and the hologram recording material for duplication 39 are again moved integrally horizontally in the figure by the distance of the grating unit interval. Then, as shown in FIG. 25C, total nine diffraction gratings, i.e., 9=3×3, are duplicated by means of exposure for a further different group. After that, further, the original hologram plate 38 and the hologram recording material for duplication 39 are moved integrally vertically in the figure by the distance of the grating unit interval. Then, as shown in FIG. 25D, total nine diffraction gratings, i.e., 9=3×3, are duplicated by means of exposure for a further different group. Through the processes of FIGS. 25A through 25D, total thirty-six hologram diffraction gratings are duplicated in the hologram recording material for duplication. According to this method, the duplication exposure is completed only in the number of times of the exposure operations one ninth the case where the hologram diffraction gratings are duplicated one by one. Accordingly, it is possible to effectively reduce the process steps.

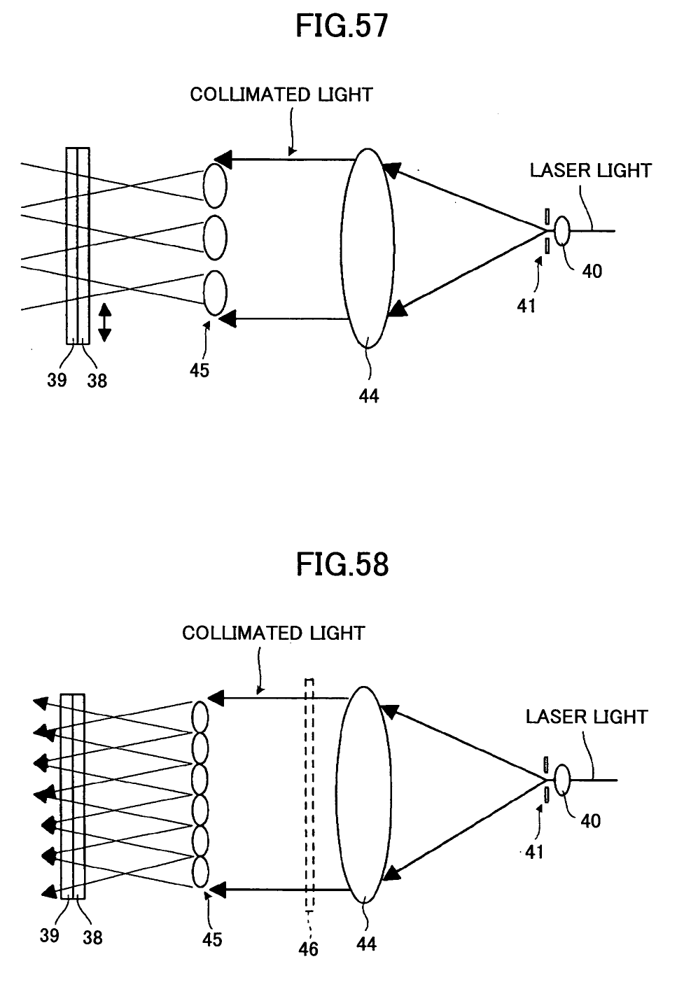

FIG. 57 illustrates another embodiment of a method of duplicating a diffraction grating. In this method, laser light is transformed into parallel light by means of the collimator lens 44, is then converged at converging points by means of the lens array 45 once, and thus, divergent light beams diverging from these converging points respectively are applied to a plurality of hologram diffraction gratings at once. In order to complete duplication of all the hologram diffraction gratings included in the original hologram plate 38, as in the above-mentioned method described with reference to FIGS. 25A through 25D, the movement along a plane of the substrate is performed.

Alternatively, instead of integrally moving the original hologram plate 38 and the hologram recording material for duplication 39 during the duplication exposure process, it is also possible that, while the original hologram plate 38 and the hologram recording material 39 are fixed, the light to be applied for the exposure is moved by a predetermined distance each time. In this case, a part of the exposure light applying optical system is moved in a direction along a plane of the original hologram plate.

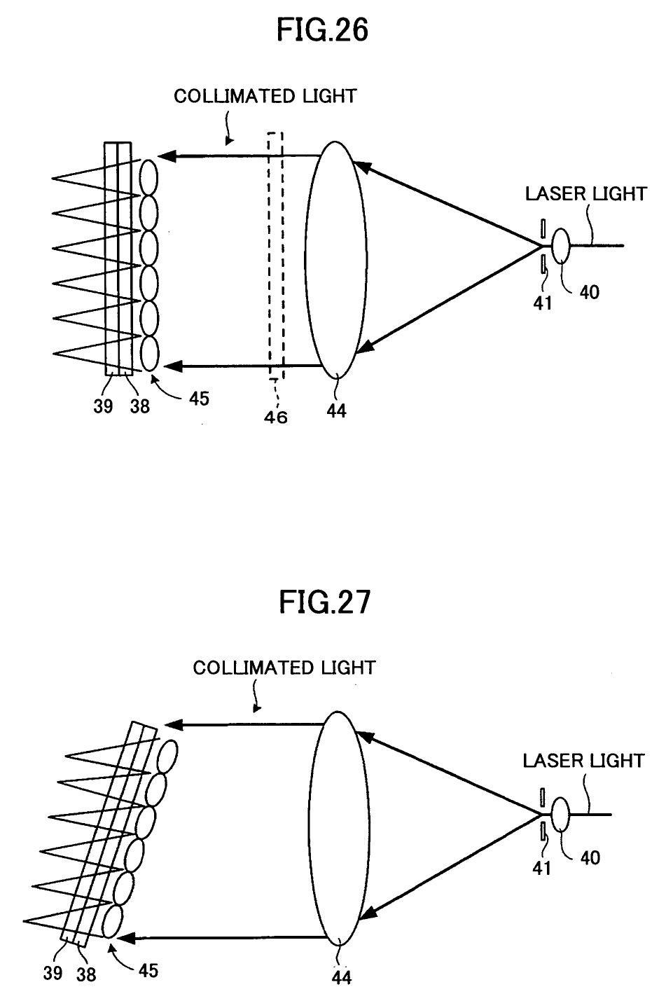

As another method of duplicating a diffraction grating, a thirtieth embodiment according to the thirty-fifth and thirty-ninth aspects of the present invention is described next with reference to FIG. 26. In the method illustrated in FIG. 26, which is similar to the method in the twenty-ninth embodiment with reference to FIG. 24, a lens array 45 having the number of lenses arranged in manner of matrix, which number is same as the number of hologram diffraction gratings included in the original hologram plate 38, is used. Then, laser light transformed into parallel light by means of the collimator lens 44 is made to pass through an intensity distribution flattening filter 46, by which the intensity distribution in the applied light is flattened, and the thus-obtained light having the flattened intensity distribution is then applied to the whole area of the lens array 45. Thereby, all the hologram diffraction gratings in the original hologram plate 38 are duplicated by means of exposure together at once in the hologram recording material for duplication 39.

FIG. 27 illustrates a further another method of duplicating a diffraction grating. In this method, the optical system same as that shown in FIG. 26 is used, and duplication exposing light is applied obliquely to the original hologram plate 38. The original hologram plate 38 and the hologram recording material for duplication 39 are made approximately in contact with one another, and are disposed obliquely with respect to parallel light applied from the collimator lens 44. A lens array 45 which is used to apply convergent light to the hologram diffraction gratings in the original hologram plate 38 is disposed in parallel with the original hologram plate 38, and is disposed obliquely with respect to the parallel light. The particular lenses of the lens array 45 are corrected in aberration with respect to the parallel light applied thereto obliquely so as to converge the applied light sharply to form appropriate beam spots on the respective ones of the hologram diffraction gratings in the original hologram plate.

By the method described above with reference to FIG. 26 or 27, it is possible to achieve duplication of many hologram diffraction gratings in the hologram recording material for duplication 39 together at once in a single exposure process, and thus, the process is simplified.

Furthermore, in the configuration shown in FIG. 26, the intensity distribution flattening filter 46 is disposed to which light made to a parallel beam by means of the collimator lens 44 is applied. This filter 46 is an intensity distribution correction filter having transmittance lower at a central part and becoming higher as the radius increases, having a function of transforming a Gaussian distribution of the laser light applied to have the intensity distribution uniform to be applied to the lens array 45 and thereby to equalize duplication exposing amounts among the respective hologram diffraction gratings in the original hologram plate. This intensity distribution flattening filter 46 may also be applied to the duplication exposure optical system shown in FIG. 22 or 24 in the same manner.

FIG. 58 illustrates a further another embodiment in which, after laser light is transformed into parallel light by means of the collimator lens 44, the light is once converged at converging points by means of the lens array 45 having the number of lenses same as the number of all the hologram diffraction gratings in the original hologram plate, and then, divergent light beams diverging from the converging points respectively are applied to the all the hologram diffraction gratins so that exposure is performed through all the hologram diffraction gratings in the original hologram plate at once.

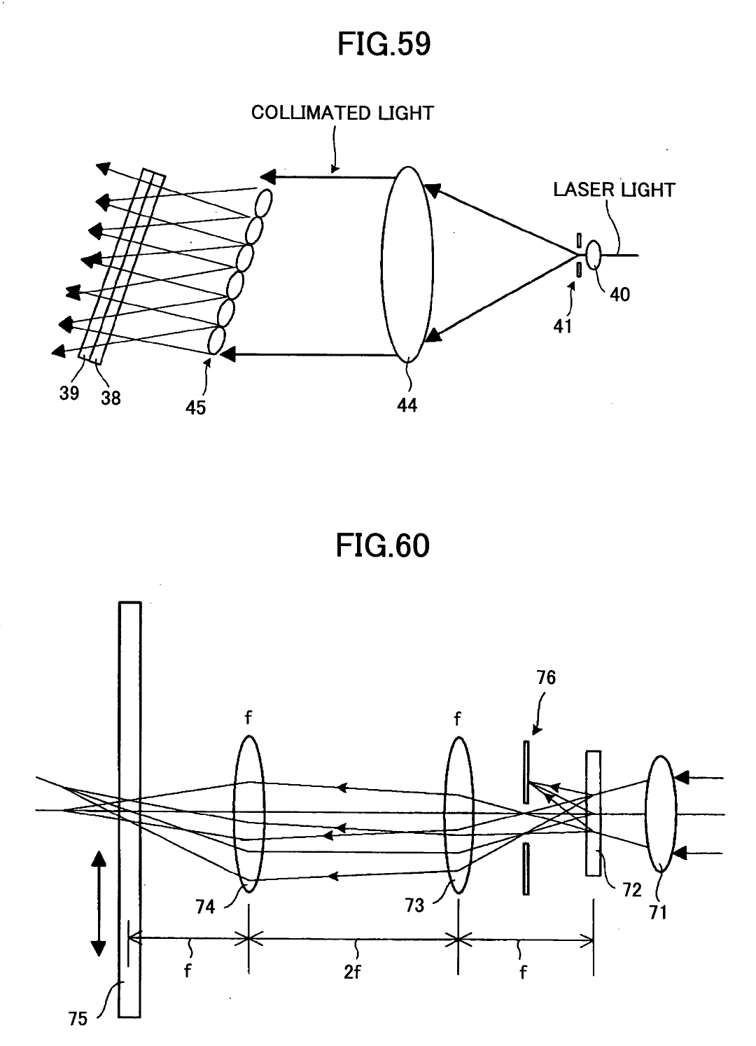

FIG. 59 illustrates a further another embodiment in which the original hologram plate 38 and the hologram recording material for duplication 39 made approximately in contact with one another is disposed obliquely in a light beam made into a parallel state by means of the collimator lens 44, and also the lens array 45 is disposed in parallel with the original hologram plate 38 obliquely with respect to the parallel light beam. Then, the micro lens array 45 converges the thus-applied parallel beam, and the thus converged beams then diverging from the converging points respectively are applied to all the hologram diffraction gratings at once as shown. Thus, exposure is performed through all the hologram diffraction gratings at once.

A method of duplicating a large number of hologram diffraction gratings with the use of a relay optical system in a thirty-first embodiment according to the thirty-sixth and thirty-ninth aspects of the present invention is described next with reference to FIG. 60.

This method includes a first step of applying convergent light or divergent light to a single original hologram plate 72 and exposing a hologram recording material for duplication 75 for a single hologram as a result of causing interference by gathering 0-th light and 1-st diffracted light generated from the original hologram plate 72 through lenses 73 and 74 in the relay optical system; and a second step of moving only the hologram recording material for duplication 75 in a direction along a plane thereof. Then, the first and second steps are repeated alternately, so that a plurality of hologram diffraction gratings can be recorded in a duplication manner in the hologram recording material for duplication 75 in manner of matrix by means of exposure.

Further, instead of moving the hologram recording material for duplication 75, during the duplication exposure process, while the hologram recording material for duplication is fixed, rather the exposure applying light may be moved by a predetermined distance. In this case, a part of the exposure light applying optical system including the original hologram plate 72 is moved in a direction along a plane of the original hologram plate.

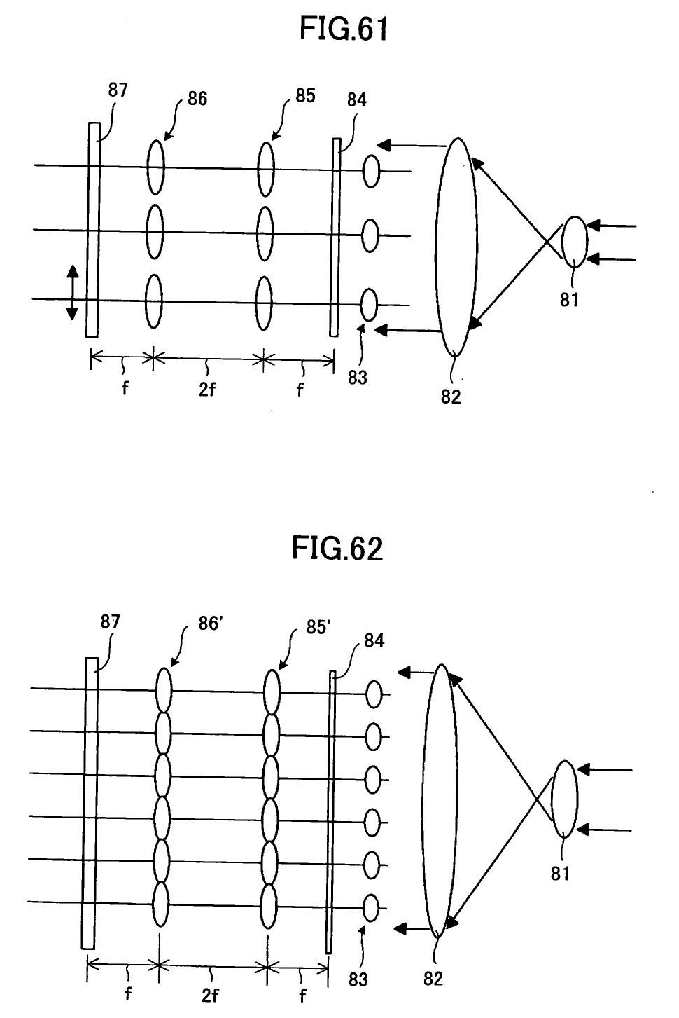

Another method of duplicating a large number of hologram diffraction gratings with the use of a relay optical system in a thirty-second embodiment according to the thirty-seventh and thirty-ninth aspects of the present invention is described next with reference to FIG. 61.

It is assumed that N denotes the number of all the holograms to be duplicated, N1 denotes the number of holograms for which exposure is performed together at once, where N>N1. This method includes a first step of transforming laser light for duplication having undergoing coupling by means of a lens 81 then into a parallel beam by means of a collimator lens 82, applying N1 convergent or divergent light beams passing through a group of lenses 83 to respective ones of N1 hologram diffraction gratings in an original hologram plate 84, and thus recording N1 holograms in a hologram recording material for duplication 87 by means of interference exposures respectively generated as a result of 0-th light and 1-st diffracted light generated by the respective N1 hologram gratings of the original hologram plate being gathered individually in the hologram recording material for duplication 87 through N1 respective relay optical systems 85 and 86; and a second step of moving and stopping only the hologram recording material for duplication 87 in a direction along a plane thereof. The first and second steps are repeated alternately, and thus, finally the N holograms gratings are recorded in manner of duplication in the hologram recording material for duplication 87 in manner of matrix.

Further, instead of moving the hologram recording material for duplication 87, during the duplication exposure process, while the hologram recording material for duplication 87 is fixed, rather the exposure applying light may be moved by a predetermined distance. In this case, an exposure light applying optical system including the original hologram plate 84, and the N1 relay optical systems 85 and 86 is moved in a direction along a plane of the original hologram plate.

Another method of duplicating a large number of hologram diffraction gratings with the use of a relay optical system in a thirty-third embodiment according to the thirty-eighth and thirty-ninth aspects of the present invention is described next with reference to FIG. 62.

It is assumed that N denotes the number of all the holograms to be duplicated. According to this method, laser light for duplication having undergone coupling by means of a lens 81 is transformed to a parallel beam by means of a collimator lens 82, N convergent or divergent light beams passing through a group of lenses 83 are applied to respective ones of the N hologram diffraction gratings in an original hologram plate 84, and thus N1 holograms are recorded in a hologram recording material for duplication 87 by means of interference exposures respectively generated as a result of 0-th light and 1-st diffracted light generated by the respective hologram gratings of the original hologram plate 84 being gathered individually in the hologram recording material for duplication 87 through N1 respective relay optical systems 85′ and 86′. Thus, the N holograms gratings are recorded in manner of duplication in the hologram recording material for duplication 87 together at once in manner of matrix.

A thirty-fourth embodiment according to the fortieth aspect of the present invention is described next.

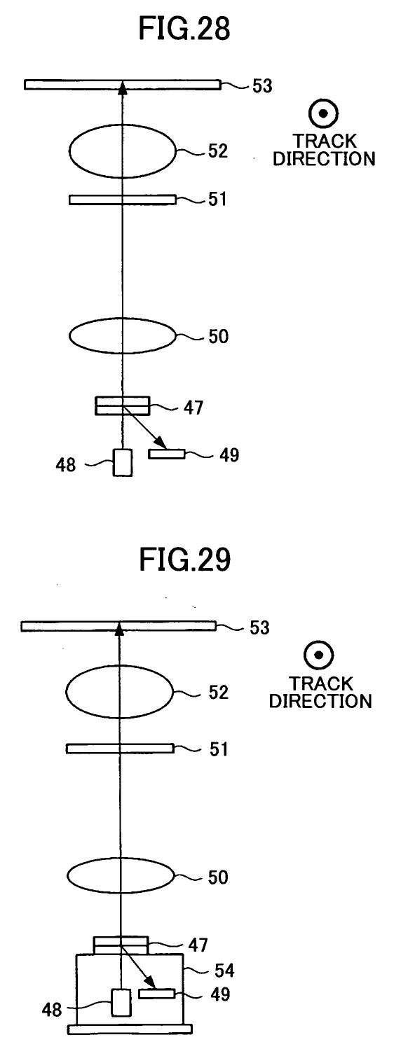

According to the present embodiment, especially a polarization diffraction grating from among diffraction gratings described above for the first through thirty-third embodiments (the first through thirty-eighth aspects of the present invention) is applied to an optical head device (optical pickup device). FIG. 28 illustrates a general configuration of an optical head device in an embodiment of the present invention. As shown, this optical head device includes a light source made of a semiconductor laser 48 (LD), a polarization diffraction grating 47 according to the present invention, a collimator lens 50 acting as a coupling lens, a ¼ wavelength plate 51, an objective lens (converging lens) 52, an optical disk (optical recording medium) 53 and a photodetector 49.

In the configuration shown in FIG. 28, light emitted from the light source 48 is set so that almost all thereof is transmitted by the polarization diffraction grating 47. After passing through the polarization diffraction grating 47, the light is collimated into an approximately parallel light by means of the collimator lens 50, then the light is transformed into one in circular polarization by means of the ¼ wavelength plate 51, the light is then converged on the optical disk 52 by means of the objective lens 52. Reflected light from the optical disk 53 is then transformed into approximately parallel light by means of the objective lens 52, is transformed into one in a polarization direction perpendicular to that appearing on the going light path by means of the ¼ wavelength plate 51, is transformed into convergent light by means of the collimator lens 50 and then is applied to the polarization diffraction grating 47. Since this light applied at this time has the polarization direction perpendicular to that appearing on the going light path, almost all of the light applied is diffracted thereby, and then, +1-st diffracted light is applied to the photodetector 49, where signal detection is performed. At this time, when the track direction in the optical disk 53 is perpendicular to FIG. 28, a push-pull signal as a tracking signal is obtained from-a difference signal produced from a comparison in the luminous energy between a left half and a right half of a spot around the optical axis with respect to the returning light applied to the polarization diffraction grating 47.

As mentioned above, the diffraction efficiency of the polarization diffraction grating according to the present invention is more than 80% in case of perpendicular (normal) incidence, and thus, in comparison to 40% of a vertical rectangular grating in the related art, the diffraction efficiency is greatly improved. Accordingly, it is possible to achieve high speed signal reproduction with the optical head device employing the diffraction grating according to the present invention.

A thirty-fifth embodiment according to the forty-first aspect of the present invention is described next.

FIG. 29 shows a general configuration of an optical head device in another example according to the thirty-fifth embodiment of the present invention. This embodiment is different from the thirty-fourth embodiment shown in FIG. 28 in that the light source 48, the photodetector 49 and the polarization diffraction grating 47 are disposed inside and on an opening of a common case 54 so that they are integrated into a unit. By providing such a unit configuration, since the light source 48, the photodetector 49 and the polarization diffraction grating 47 are integrated into the unit, it is possible to efficiently reduce a time required for assembling the optical head device and to make easier the adjustment work therefor.

A thirty-sixth embodiment according to the forty-second aspect of the present invention is described next.

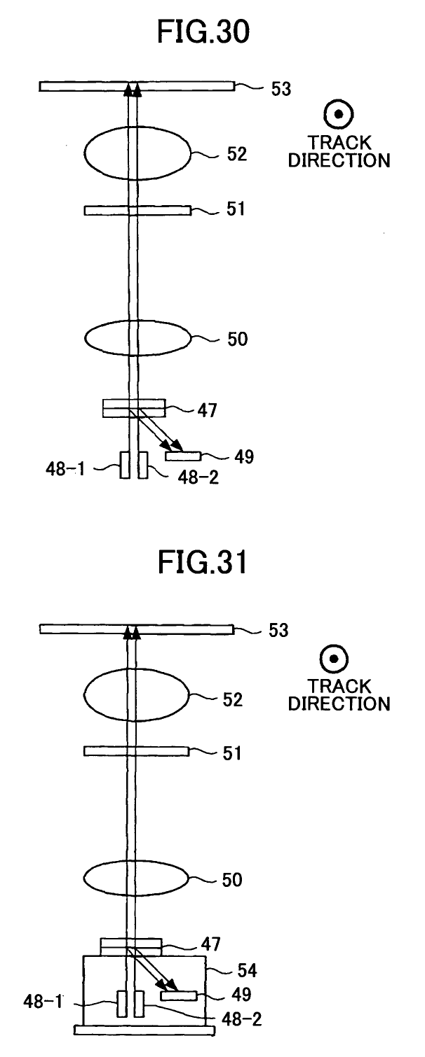

According to the present embodiment, especially a polarization diffraction grating from among the diffraction gratings described above for the first through thirty-third embodiments (the first through thirty-eighth aspects of the present invention) is applied to an optical head device (optical pickup device) which is operable at two different operation wavelengths. FIG. 30 illustrates a general configuration of an optical head device in an embodiment of the present invention. As shown, this optical head device includes light sources made of semiconductor lasers (LDs) 48-1 and 48-2 having different wavelengths, a polarization diffraction grating 47 according to the present invention, a collimator lens 50 acting as a coupling lens, a ¼ wavelength plate 51, an objective lens (converging lens) 52 for which aberration is corrected for the two wavelengths, an optical disk (optical recording medium) 53 and a photodetector 49 which are configured for the two wavelengths.

Since this optical head device operable in the two wavelengths includes the two light sources 48-1 and 48-2, it can handle optical disks 53 in two different types having different recording densities. As the optical disks 53, an optical disk in a CD family at a normal recording density, an optical disk in a DVD family having a performance of recording information at high density and so forth, for example, may be applied even in a single product of the optical head device. Since the recording densities are different between the CD family and the DVD family, operation wavelengths to be applied and substrate thicknesses of the optical disks are different therebetween. For example, a disk in the CD family for which wavelength of 780 nm is used has the substrate thickness of 1.2 mm, while a disk in the DVD family for which wavelength of 660 nm is used has the substrate thickness of 0.6 mm, for example.

In the configuration shown in FIG. 30, light emitted from any of the light sources 48-1 and 48-2 is set so that almost all thereof is transmitted by the polarization diffraction grating 47. After passing through the polarization diffraction grating 47, the light is collimated into an approximately parallel light by means of the collimator lens 50, then the light is transformed into one in circular polarization by means of the ¼ wavelength plate 51 used commonly for the two wavelengths, and the light is then converged on the optical disk 52 by means of the objective lens 52. Reflected light from the optical disk 53 is then transformed into approximately parallel light by means of the objective lens 52, is transformed into one in a polarization direction perpendicular to that appearing on the going light path by means of the ¼ wavelength plate 51, is transformed into convergent light by means of the collimator lens 50 and then is applied to the polarization diffraction grating 47. Since this light applied has the polarization direction perpendicular to that appearing on the going light path, almost all of the light applied is diffracted thereby, and then, +1-st diffracted light is applied to the photodetector 49 used commonly for the two wavelengths, where signal detection is performed. At this time, when the track direction in the optical disk 53 is perpendicular to FIG. 30, a push-pull signal as a tracking signal is obtained from a difference signal produced from a comparison in the luminous energy between a left half and a right half of a spot around the optical axis with respect to the returning light applied to the polarization diffraction grating 47.

As mentioned above, the diffraction efficiency of the polarization diffraction grating according to the present invention is more than 80% in case of perpendicular (normal) incidence, and thus, in comparison to 40% of a vertical rectangular grating in the related art, the diffraction efficiency is greatly improved. Accordingly, it is possible to achieve high speed signal reproduction in the optical head device employing the diffraction grating according to the present invention.

A thirty-seventh embodiment according to the forty-third aspect of the present invention is described next.

FIG. 31 shows a general configuration of an optical head device in another example according to the thirty-seventh embodiment of the present invention. This embodiment is different from the thirty-sixth embodiment shown in FIG. 30 in that the light sources 48-1 and 48-2, the photodetector 49 and the polarization diffraction grating 47 are disposed inside and on an opening of a common case 54 so that they are integrated into a unit. By providing such a unit configuration, since the light sources 48-1 and 48-2, the photodetector 49 and the polarization diffraction grating 47 are integrated into the unit, it is possible to effectively reduce a time required for assembling the optical head device and to make easier the adjustment work therefor.

A thirty-eighth embodiment according to the forty-fourth aspect of the present invention is described next.

In this embodiment, the optical head device (optical pickup device) according to any of the thirty-fourth through thirty-seventh embodiments described above is mounted in an optical disk drive apparatus.

Since the optical head device according to any of the thirty-fourth through thirty-seventh embodiments employs the polarization diffraction grating having high diffraction efficiency and having the grating pitch well shortened, high luminous energy usage efficiency is achieved and also a signal having a high reliability suitable for high speed recording or reproduction is obtained. Furthermore, since the diffraction efficiency is thus high, it is possible to reduce a gain of an optical integrated circuit (OPIC) of signal detection system, and thereby high speed response in the OPIC can be achieved. Furthermore, since the diffraction efficiency does not change depending on the incidence angle, a signal having a reduced offset can be obtained. Accordingly, it is possible to achieve high speed information recording or reproduction and stable servo control in the optical disk drive apparatus.

Furthermore, the optical head device according to the present invention employs the polarization diffraction grating, and also, the polarization diffraction grating may be integrated together with the light source and the photodetector, it is possible to effectively reduce the size or thickness of the optical head device, and thus, it is advantageous to apply the optical head device according to the present invention as an optical head device of an optical disk drive apparatus mounted in a notebook-type personal computer or such, for example.

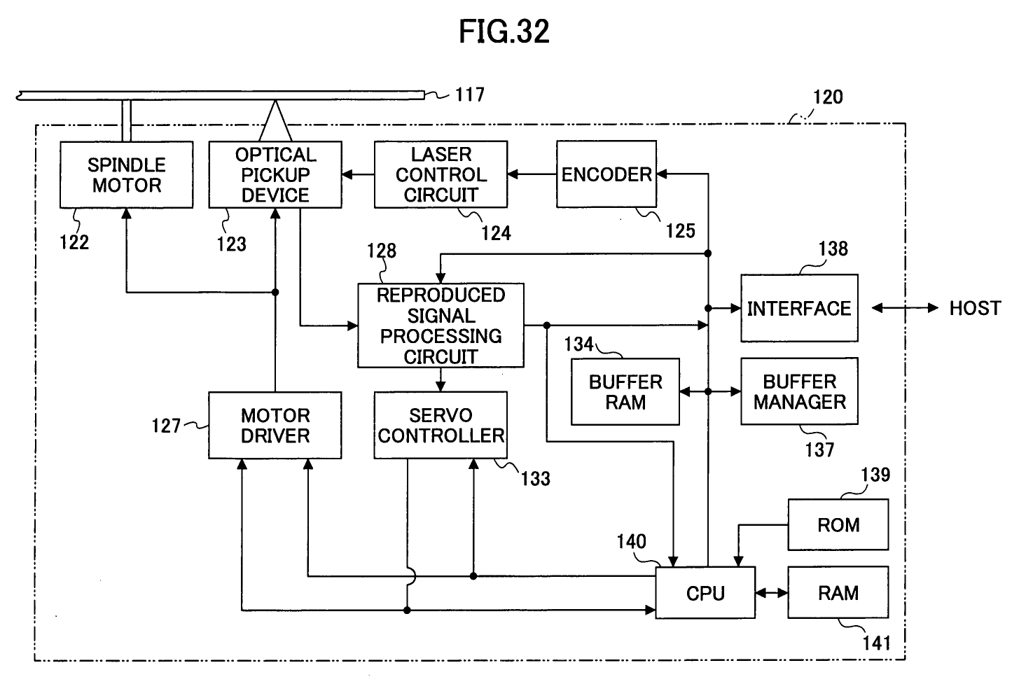

FIG. 32 shows a block diagram illustrating a general configuration of one example of an optical disk drive apparatus. This optical disk drive apparatus 120 includes a spindle motor 122 which drives and rotates an optical disk 117 acting as an optical information recording medium, an optical head device (optical pickup device) 123 according to the present invention, a laser control circuit 124, an encoder 125, a motor driver 127, a reproduced signal processing circuit 128, a servo controller 133, a buffer RAM 134, a buffer manager 139, an interface 138, a read only memory (ROM) 139, a central processing unit (CPU) 140 and a random access memory (RAM) 141. Arrows shown in FIG. 32 represent flows of typical signals or information but do not necessarily represent all of the connection relationship between the respective blocks. Furthermore, the configuration shown in FIG. 32 is only for example, and a configuration of an optical disk drive apparatus according to the present invention is not limited thereto.

As the optical disk 117, an optical disk in a CD (compact disk) system such as a CD, a CD-R, a CD-RW, or such, an optical disk in a DVD (digital versatile disk) family such as a DVD, a DVD-R, a DVD+R, a DVD-RW, a DVD+RW or such, a high-density optical disk requiring a light source of blue semiconductor laser, or such may be applied. By configuring the optical head device (optical pickup device) 123 so that it includes a plurality of light sources having different wavelengths as the optical head device described above with reference to FIG. 30 or 31, and appropriate one of the light sources is selectively driven according to a type of the optical disk 117 loaded, it is possible to provide the optical disk drive apparatus which can perform recording or reproduction for a plurality of types of optical disks.

In FIG. 32, the optical head device (optical pickup device) 123 applies laser light to a recording surface of the optical disk 117 in which a spiral or concentric track(s) is(are) formed, and also, receives reflected light from the recording surface, so as to perform recording or reproducing information to or from the optical disk 117. The optical head device 123 has, for example, the configuration shown in any of FIGS. 28 through 31.

The reproduced signal processing circuit 128 converts a current signal output from the optical head device (optical pickup device) 123 into a voltage signal, and detects an RF signal including a wobble signal and reproduced information, and a servo signal (a focus signal and a tracking signal) based on the voltage signal. Then, the reproduced signal processing circuit 128 extracts address information and synchronization signal from the wobble signal. The thus-extracted address information is provided to the CPU 140, and the synchronization signal is provided to the encoder 125. Furthermore, the reproduced signal processing circuit 128 performs error correction processing and so forth on the RF signal, and then, stores the thus-obtained data into the buffer RAM 134 via the buffer manager 137. Furthermore, the servo signal is provided to the servo controller 133 via the reproduced signal processing circuit 128. The servo controller 133 generates a control signal for controlling the optical head device (optical pickup device) 123 based on the servo signal, and provides it to the motor driver 127.

The buffer manager 137 manages input and output of data to and from the buffer RAM 134, and sends a message to the CPU 140 when a total data amount stored in the buffer RAM 134 reaches a predetermined value. The motor driver 127 controls the optical head device (optical pickup device) 123 and the spindle motor 122 based on the control signal from the servo controller 133 and instructions from the CPU 140. The encoder 125 takes data stored in the buffer RAM 123 via the buffer manager 137 based on instructions from the CPU 140, adds error correction code thereto or so, produces data to be written to the optical disk 117, and also, outputs the data to be written to the laser control circuit 124 in synchronization with the synchronization signal from the reproduced signal processing circuit 128. The laser control circuit 124 controls the laser light output of the optical head device (optical pickup device) 123 based on the data to be written from the encoder 125.

The interface 138 is a communication interface for bi-directional communications with a host (for example, a personal computer), and conforms to ATAPI (AT attachment packet interface), SCSI (small computer system interface), or such.

In the ROM 139, programs for control or such described in code interpretable by the CPU 140 are stored. The CPU 140 controls operations of the respective parts in the apparatus based on the programs stored in the ROM 139, and holds data or such required for the control in the RAM 141 temporarily.

According to the present invention, since the optical head device (optical pickup device) 123 employing the polarization diffraction grating having the high diffraction efficiency is mounted in the optical disk drive apparatus as described above, it is possible to achieve high luminous energy usage efficiency, to obtain a signal with high reliability, and also, to achieve fast recording or reproducing of information to or from the optical disk 117. Furthermore, according to the present invention, by providing the plurality of light sources having the different wavelengths in the optical head device (optical pickup device) 123, it is possible to achieve the optical disk drive apparatus by which information can be recorded to or reproduced from optical disks in a plurality of different standards, such as optical disks in the CD family or DVD family, a high density optical disk requiring a light source of a blue semiconductor laser or such.

Further, the present invention is not limited to the above-described embodiments, and variations and modifications may be made without departing from the basic concept of the present invention.

The present application is based on Japanese Laid-open Patent Applications Nos. 2003-120141 and 2003-193733, filed on Apr. 24, 2003 and Jul. 8, 2003, respectively, the entire contents of which are hereby incorporated by reference.

1. A diffraction grating used in an optical head device leading light from a light source to an optical system, converging the light on an optical recording medium through a converging lens, detecting reflected light from the optical recording medium by a photodetector and recording information to the optical recording medium, reproducing information therefrom, or performing both the recording and reproducing, said diffraction grating comprising a grating part which comprises a plurality of divided areas,
wherein:
a setting is made such that diffracted light exiting from each of the plurality of areas is led to a corresponding particular photo-detecting area of the photodetector; and
each of the plurality of areas of the diffraction grating is produced either by first two-beam interference exposure in which a hologram recording material is exposed to interference fringes produced from first divergent light emitted from a position equivalent to a light emitting point on the light source of the optical head device and second divergent light emitted from a position equivalent to a light receiving point corresponding to each photo-detecting area on the photodetector, or by second two-beam interference exposure in which a hologram recording material is exposed to interference fringes produced from first convergent light converging at the position equivalent to the light emitting point on the light source of the optical head device and second convergent light converging at the point equivalent to the light receiving point corresponding to each photo-detecting area.

2. A method for producing the diffraction grating claimed in claim 1, comprising the step of:
performing exposure while disposing a sector mask defining the respective areas immediately before the hologram recording material, when producing the plurality of areas of the diffraction grating by the two-beam interference exposure individually,

3. The diffraction grating as claimed in claim 1, wherein:
a wavelength of the light used for producing the diffraction grating through the interference exposure is different from a wavelength of the optical head device; and
each of the plurality of areas of the diffraction grating is produced either by first two-beam interference exposure in which a hologram recording material is exposed to first divergent light emitted from a position corresponding to the light emitting point on the light source of the optical head device determined according to the difference in wavelength and second divergent light emitted form a position corresponding to the light receiving point of each photo-detecting area determined according to the difference in wavelength, or by second two-beam interference exposure in which a hologram recording material is exposed to first convergent light converging at the position corresponding to the light emitting point on the light source of the optical head device determined according to the difference in wavelength and second convergent light converging at the position corresponding to the light receiving point of each photo-detecting area determined according to the difference in wavelength.

4. A method for producing the diffraction grating claimed in claim 3, comprising the step of:
configuring at least one optical system used for the two-beam interference exposure so that the optical system provides aberration for canceling out aberration otherwise occurring due to difference in wavelength of the light used between recording operation for the hologram recording material and reproduction operation in the optical head device so that diffracted light without aberration is obtained on the photodetector in a condition in which the thus-produced diffraction grating is applied in the optical head device.

5. The method for producing the diffraction grating as claimed in claim 4, further comprising the step of:
disposing a hologram providing the aberration canceling out the aberration otherwise occurring when difference occurs in wavelength between recording and reproduction in at least one optical path of the two-beam interference exposure optical systems.

6. A method for duplicating a diffraction grating, comprising the steps of:
utilizing the diffraction grating claimed in claim 1, comprising the grating part which is divided into the plurality of areas, as an original hologram plate, and making the original hologram plate and a hologram recording material for duplication approximately in contact with one another; and
applying light from the side of the original hologram plate, so as to expose the hologram recording material to interference fringes produced by 0-th light and 1-st diffracted light generated from the original hologram plate.

7. A method for duplicating a diffraction grating, comprising the steps of:
configuring a diffraction grating based on calculation made through a computer for interference fringes equivalent to that of said diffraction grating claimed in claim 1 which comprises the grating part divided into the plurality of areas, for utilizing it as an original hologram plate, and making the original hologram plate and a hologram recording material for duplication approximately in contact with one another; and
applying light from the side of the original hologram plate, so as to expose the hologram recording material to interference fringes produced by 0-th light and 1-st diffracted light generated from the original hologram plate.

8. The method for duplicating a diffraction grating as claimed in claim 6, wherein:
convergent light converging at the position equivalent to the emitting point on the light source of the optical head device or divergent light emitted from the position equivalent to the light emitting point on the light source of the optical head device is used as light to be applied when the original hologram plate of the diffraction grating is made approximately in contact with the hologram recording material for duplication and the light is applied from the side of the original hologram plate so that the diffraction grating is duplicated.

9. The method for duplicating a diffraction grating as claimed in claim 7, wherein:
convergent light converging at the position equivalent to the emitting point on the light source of the optical head device or divergent light emitted from the position equivalent to the light emitting point on the light source of the optical head device is used as light to be applied when the original hologram plate of the diffraction grating is made approximately in contact with the hologram recording material for duplication and the light is applied from the side of the original hologram plate so that the diffraction grating is duplicated.

10. The method for duplicating a diffraction grating as claimed in claim 6, wherein:
convergent light converging at a position, corresponding to the light emitting point of the light source, determined according to a difference between the duplicating wavelength and the light source wavelength of the optical head device or divergent light emitted from a position, corresponding to the light emitting point of the light source, determined according to the difference between the duplicating wavelength and the light source wavelength of the optical head device is used as light to be applied when the original hologram plate of the diffraction grating is made approximately in contact with the hologram recording material for duplication and the light is applied from the side of the original hologram plate so that the diffraction grating is duplicated,

11. The method for duplicating a diffraction grating as claimed in claim 7, wherein:
convergent light converging at a position, corresponding to the light emitting point of the light source, determined according to a difference between the duplicating wavelength and the light source wavelength of the optical head device or divergent light emitted from a position, corresponding to the light emitting point of the light source, according to the difference between the duplicating wavelength and the light source wavelength of the optical head device is used as light to be applied when the original hologram plate of the diffraction grating is made approximately in contact with the hologram recording material for duplication and the light is applied from the side of the original hologram plate so that the diffraction grating is duplicated,

12. The method for duplicating a diffraction grating as claimed in claim 6, wherein:
convergent light converging at a position equivalent to a point from among a plurality of light receiving points respectively corresponding to a plurality of photo-detecting areas of the photodetector of the optical head device or divergent light emitted from a position equivalent to a point from among the plurality of light receiving points respectively corresponding to the plurality of photo-detecting areas is used as light to be applied when the original hologram plate of the diffraction grating is made approximately in contact with the hologram recording material for duplication and the light is applied from the side of the original hologram plate so that the diffraction grating is duplicated.

13. The method for duplicating a diffraction grating as claimed in claim 7, wherein:
convergent light converging at a position equivalent to a point from among a plurality of light receiving points respectively corresponding to a plurality of photo-detecting areas of the photodetector of the optical head device or divergent light emitted from a position equivalent to a point from among the plurality of light receiving points respectively corresponding to the plurality of photo-detecting areas is used as light to be applied when the original hologram plate of the diffraction grating is made approximately in contact with the hologram recording material for duplication and the light is applied from the side of the original hologram plate so that the diffraction grating is duplicated.

14. The method for duplicating a diffraction grating as claimed in claim 6, wherein:
convergent light converging at a position, corresponding to a point from among a plurality of light receiving points respectively corresponding to a plurality of photo-detecting areas of the photodetector of the optical head device, determined according to a difference between the duplicating wavelength and the light source wavelength of the optical head device, or divergent light emitted from a position, corresponding to a point from among the plurality of light receiving points respectively corresponding to the plurality of photo-detecting areas of the photodetector of the optical head device, determined according to the difference between the duplicating wavelength and the light source wavelength of the optical head device is used as light to be applied when the original hologram plate of the diffraction grating is made approximately in contact with the hologram recording material for duplication and the light is applied from the side of the original hologram plate so that the diffraction grating is duplicated.

15. The method for duplicating a diffraction grating as claimed in claim 7, wherein:
convergent light converging at a position, corresponding to a point from among a plurality of light receiving points respectively corresponding to a plurality of photo-detecting areas of the photodetector of the optical head device, determined according to a difference between the duplicating wavelength and the light source wavelength of the optical head device, or divergent light emitted from a position, corresponding to a point from among the plurality of light receiving points respectively corresponding to the plurality of photo-detecting areas of the photodetector of the optical head device, determined according to the difference between the duplicating wavelength and the light source wavelength of the optical head device is used as light to be applied when the original hologram plate of the diffraction grating is made approximately in contact with the hologram recording material for duplication and the light is applied from the side of the original hologram plate so that the diffraction grating is duplicated.

16. The method for duplicating a diffraction grating as claimed in claim 12, wherein:
as the light to be applied for the duplication, convergent light converging at or divergent light diverging from a position corresponding to a light receiving point of a photo-detecting area from among the plurality of photo-detecting areas provided for obtaining a focus error signal is used.

17. The method for duplicating a diffraction grating as claimed in claim 13, wherein:
as the light to be applied for the duplication, convergent light converging at or divergent light diverging from a position corresponding to a light receiving point of a photo-detecting area from among the plurality of photo-detecting areas provided for obtaining a focus error signal is used.

18. The method for duplicating a diffraction grating as claimed in claim 14, wherein:
as the light to be applied for the duplication, convergent light converging at or divergent light diverging from a position corresponding to a light receiving point of a photo-detecting area from among the plurality of photo-detecting areas provided for obtaining a focus error signal is used.

19. The method for duplicating a diffraction grating as claimed in claim 15, wherein:
as the light to be applied for the duplication, convergent light converging at or divergent light diverging from a position corresponding to a light receiving point of a photo-detecting area from among the plurality of photo-detecting areas provided for obtaining a focus error signal is used.

20. A method for duplicating the diffraction grating claimed in claim 1, comprising the steps of:
configuring a diffraction grating based on calculation made through a computer for interference fringes equivalent to that of the diffraction grating claimed in claim 1 which comprises the grating part divided into the plurality of areas, for utilizing it as a first original hologram plate, and making the original hologram plate and a hologram recording material for duplication approximately in contact with one another;
applying light from the side of the original hologram plate, so as to expose the hologram recording material to the interference fringes produced by 0-th light and 1-st diffracted light generated from the first original hologram plate so as to produced a second original hologram plate;
making the second original hologram plate and a hologram recording material for duplication approximately in contact with one another; and
applying light from the side of the second original hologram plate, so as to expose the hologram recording material to the interference fringes produced by 0-th light and 1-st diffracted light generated from the first original hologram plate so as to produce a diffraction grating,
wherein, when the diffraction grating is produced as a result of the second original hologram plate being and the hologram recording material for duplication being made approximately in contact with one another and the light being applied from the side of the second original hologram plate, convergent light converging at a position equivalent to a light emitting point of the light source of the optical head device or divergent light emitted from the position equivalent to the light emitting point of the light source is used as the light to be applied.

21. A method for duplicating the diffraction grating claimed in claim 1, comprising the steps of:
configuring a diffraction grating based on calculation made through a computer for interference fringes equivalent to that of the diffraction grating claimed in claim 1 which comprises the grating part divided into the plurality of areas, for utilizing it as a first original hologram plate, and making the first original hologram plate and a hologram recording material for duplication approximately in contact with one another;
applying light from the side of the first original hologram plate, so as to expose the hologram recording material to the interference fringes produced by 0-th light and 1-st diffracted light generated from the first original hologram plate so as to produce a second original hologram plate;
making the second original hologram plate and a hologram recording material for duplication approximately in contact with one another; and
applying light from the side of the second original hologram plate, so as to expose the hologram recording material to the interference fringes produced by 0-th light and 1-st diffracted light generated from the second original hologram plate so as to produce a diffraction grating,
wherein, in case where the duplicating exposure wavelength is different from the light source wavelength, when the diffraction grating is produced as a result of the second original hologram plate and the hologram recording material for duplication being made approximately in contact with one another and the light being applied from the side of the second original hologram plate, convergent light converging at a position, corresponding to the light emitting point of the light source of the optical head device, determined according to a difference between the duplicating exposure wavelength and the light source wavelength of the optical head device, or divergent light emitted from a position, corresponding to the light emitting point of the light source of the optical head device, determined according to the difference between the duplicating exposure wavelength and the light source wavelength of the optical head device is used as the light to be applied.

22. A method for duplicating the diffraction grating claimed in claim 1, comprising the step of:
configuring a diffraction grating based on calculation made through a computer for interference fringes equivalent to that of said diffraction grating claimed in claim 1 which comprises the grating part divided into the plurality of areas, for utilizing it as a first original hologram plate, and making the first original hologram plate and a hologram recording material for duplication approximately in contact with one another;
applying light from the side of the original hologram plate, so as to expose the hologram recording material to the interference fringes produced by 0-th light and 1-st diffracted light generated from the first original hologram plate so as to produce a second original hologram plate;
making the second original hologram plate and a hologram recording material for duplication approximately in contact with one another; and
applying light from the side of the second original hologram plate, so as to expose the hologram recording material to the interference fringes produced by 0-th light and 1-st diffracted light generated from the first original hologram plate so as to produce a diffraction grating,
wherein, when the diffraction grating is produced as a result of the second original hologram plate and the hologram recording material for duplication being made approximately in contact with one another and the light being applied from the side of the second original hologram plate, convergent light converging at a position equivalent to a point from among a plurality of light receiving points corresponding to a plurality of photo-detecting areas of the photodetector of the optical head device or divergent light emitted from a position equivalent to a point from among the plurality of light receiving points is used as the light to be applied.

23. A method for duplicating the diffraction grating claimed in claim 1, comprising the step of:
configuring a diffraction grating based on calculation made through a computer for interference fringes equivalent to that of said diffraction grating claimed in claim 1 which comprises the grating part divided into the plurality of areas, for utilizing it as a first original hologram plate, and making the original hologram plate and a hologram recording material for duplication approximately in contact with one another;
applying light from the side of the original hologram plate, so as to expose the hologram recording material to the interference fringes produced by 0-th light and 1-st diffracted light generated from the first original hologram plate so as to produce a second original hologram plate;
making the second original hologram plate and a hologram recording material for duplication approximately in contact with one another; and
applying light from the side of the second original hologram plate, so as to expose the hologram recording material to the interference fringes produced by 0-th light and 1-st diffracted light generated from the second original hologram plate so as to produce a diffraction grating,
wherein, in case where the duplicating exposure wavelength is different from the light source wavelength of the optical head device, when the diffraction grating is produced as a result of the second original hologram plate and the hologram recording material for duplication being made approximately in contact with one another and the light being applied from the side of the second original hologram plate, convergent light converging at a position corresponding to a point from among a plurality of light receiving points corresponding to a plurality of photo-detecting areas of the photodetector of the optical head device determined according to a difference between the duplicating exposure wavelength and the light source wavelength of the optical head device, or divergent light emitted from a position corresponding to a point from among the plurality of light receiving points corresponding to the plurality of photo-detecting areas of the photodetector of the optical head device according to the difference between the duplicating exposure wavelength and the light source wavelength of the optical head device is used as the light to be applied.

24. The method for duplicating a diffraction grating claimed in claim 6, wherein:
when the duplicating exposure wavelength is different from the light source wavelength of the optical head device, the duplicating exposure is performed with the use of an optical system for applying the light from the side of the original hologram plate configured so that said optical system provides aberration for canceling out aberration otherwise occurring due to difference in light wavelength between the duplicating operation and the reproduction operation in the optical head device.

25. The method for duplicating a diffraction grating claimed in claim 7, wherein:
when the duplicating exposure wavelength is different from the light source wavelength of the optical head device, the duplicating exposure is performed with the use of an optical system for applying the light from the side of the original hologram plate configured so that said optical system provides aberration for canceling out aberration otherwise occurring due to difference in light wavelength between the duplicating operation and the reproduction operation in the optical head device.

26. A method for duplicating a diffraction grating comprising the step of:
using, as an original hologram plate, the diffraction grating according to claim 1 or a diffraction grating produced based on calculation made through a computer for interference fringes equivalent to said diffraction grating, and exposing a hologram recording material for duplication to interference fringes produced by diffracted 0-th light and 1-st diffracted light generated from the original hologram plate as a result of light being applied from the side of the original hologram plate to the hologram recording material for duplication via a relay optical system.

27. The method for duplicating a diffraction grating as claimed in claim 26, wherein:
the relay optical system is configured so that a surface on the original hologram plate and a surface on the hologram recording material for duplication have a relation of approximately conjugate planes in imaging.

28. The method for duplicating a diffraction grating as claimed in claim 26, wherein:
the relay optical system comprises two lens systems,
wherein a front-side focal point of a first lens system thereof closer to the original hologram plate coincides with a surface of the original hologram plate, a rear-side focal point of the first lens system is made coincident with a front-side focal point of a second lens system, and also, a rear-side focal point of the second lens system coincides with a surface of the hologram recording material for duplication.

29. The method for duplicating a diffraction grating as claimed in claim 26, wherein:
when a diffraction grating is duplicated as a result of light being applied from the side of the original hologram plate, a wavelength of the duplication applying light is in the vicinity of the light source wavelength of the optical head device, and, convergent light converging at a position equivalent to the light emitting point of the light source of the optical head device or divergent light emitted from the position equivalent to the light emitting point of the light source is used as the light to be applied.

30. The method for duplicating a diffraction grating as claimed in claim 26, wherein:
when a diffraction grating is duplicated as a result of light being applied from the side of the original hologram plate, a wavelength of the duplication applying light is different from the light source wavelength of the optical head device, and, convergent light converging at a position corresponding to the light emitting point of the light source of the optical head device determined according to a difference between the duplicating wavelength and the light source wavelength of the optical head device, or divergent light emitted from the position, corresponding to the light emitting point determined according to the difference between the duplicating wavelength and the light source wavelength of the optical head device is used as the light to be applied.

31. The method for duplicating a diffraction grating as claimed in claim 26, wherein:
when a diffraction grating is duplicated as a result of light being applied from the side of the original hologram plate, a wavelength of the duplication applying light is in the vicinity of the light source wavelength of the optical head device, and, convergent light converging at a position equivalent to a point from among a plurality of light receiving points corresponding to a plurality of photo-detecting areas of the photodetector of the optical head device or divergent light emitted from a position equivalent to a point from among the plurality of light receiving points is used as the light to be applied.

32. The method for duplicating a diffraction grating as claimed in claim 26, wherein:
when a diffraction grating is duplicated as a result of light being applied from the side of the original hologram plate, a wavelength of the duplication applying light is different from the light source wavelength of the optical head device, and, convergent light converging at a position corresponding to a point from among a plurality of light receiving points corresponding to a plurality of photo-detecting areas of the photodetector of the optical head device determined according to a difference between the duplicating wavelength and the light source wavelength of the optical head device, or divergent light emitted from a position corresponding to a point from among a plurality of light receiving points corresponding to a plurality of photo-detecting areas of the photodetector of the optical head device determined according to a difference between the duplicating wavelength and the light source wavelength of the optical head device is used as the light to be applied.

33. The method of duplicating a diffraction grating as claimed in claim 26, wherein:
a spatial filter is provided in the relay optical system for only transmitting 0-th light and a one of the 1-st diffracted light and blocking diffracted light in the other orders applied from the original hologram plate.

34. The method of duplicating a diffraction grating as claimed in claim 29, wherein:
a plane including a convergent point or a divergent point of the duplication applying light for the original hologram plate and perpendicular to an optical axis of the relay optical system and a plane including imaging points of light emitted from these points through the relay optical system and perpendicular to the axis have a relation of conjugate planes in imaging made by the relay optical system.

35. The method of duplicating a diffraction grating as claimed in claim 30, wherein:
a plane including a convergent point or a divergent point of the duplication applying light for the original hologram plate and perpendicular to an optical axis of the relay optical system and a plane including imaging points of light emitted from these points through the relay optical system and perpendicular to the axis have a relation of conjugate planes in imaging made by the relay optical system.

36. The method of duplicating a diffraction grating as claimed in claim 31, wherein:
a plane including a convergent point or a divergent point of the duplication applying light for the original hologram plate and perpendicular to an optical axis of the relay optical system and a plane including imaging points of light emitted from these points through the relay optical system and perpendicular to the axis have a relation of conjugate planes in imaging made by the relay optical system.

37. The method of duplicating a diffraction grating as claimed in claim 32, wherein:
a plane including a convergent point or a divergent point of the duplication applying light for the original hologram plate and perpendicular to an optical axis of the relay optical system and a plane including imaging points of light emitted from these points through the relay optical system and perpendicular to the axis have a relation of conjugate planes in imaging made by the relay optical system.

38. The method of duplicating a diffraction grating as claimed in claim 33, wherein:
a plane including a convergent point or a divergent point of the duplication applying light for the original hologram plate and perpendicular to an optical axis of the relay optical system and a plane including imaging points of light emitted from these points through the relay optical system and perpendicular to the axis have a relation of conjugate planes in imaging made by the relay optical system.

39. The method of duplicating a diffraction grating as claimed in 29, wherein:
an imaging magnification to the hologram recording material for duplication by the relay optical system from the original hologram plate surface is equal to an imaging magnification to the imaging point of light by the relay optical system from a converging point or a diverging point of the duplication applying light.

40. The method of duplicating a diffraction grating as claimed in 30, wherein:
an imaging magnification to the hologram recording material for duplication by the relay optical system from the original hologram plate surface is equal to an imaging magnification to the imaging point of light by the relay optical system from a converging point or a diverging point of the duplication applying light.

41. The method of duplicating a diffraction grating as claimed in 31, wherein:
an imaging magnification to the hologram recording material for duplication by the relay optical system from the original hologram plate surface is equal to an imaging magnification to the imaging point of light by the relay optical system from a converging point or a diverging point of the duplication applying light.

42. The method of duplicating a diffraction grating as claimed in 32, wherein:
an imaging magnification to the hologram recording material for duplication by the relay optical system from the original hologram plate surface is equal to an imaging magnification to the imaging point of light by the relay optical system from a converging point or a diverging point of the duplication applying light.

43. The method of duplicating a diffraction grating as claimed in 33, wherein:
an imaging magnification for the hologram recording material for duplication by the relay optical system with respect to the original hologram plate surface is equal to an imaging magnification to the imaging point of light by the relay optical system from a converging point or a diverging point of the duplication applying light.

44. The method of duplicating a diffraction grating as claimed in claim 6, wherein:
the diffraction grating obtained through the duplication comprises a volume phase diffraction grating including liquid crystal material in the hologram recording material for duplication.

45. The method of duplicating a diffraction grating as claimed in claim 7, wherein:
the diffraction grating obtained through the duplication comprises a volume phase diffraction grating including liquid crystal material in the hologram recording material for duplication.

46. The method of duplicating a diffraction grating as claimed in claim 6, wherein:
the diffraction grating in the original hologram plate comprises a volume phase diffraction grating.

47. The method of duplicating a diffraction grating as claimed in claim 7, wherein:
the diffraction grating in the original hologram plate comprises a volume phase diffraction grating.

48. The method of duplicating a diffraction grating as claimed in claim 46, wherein:
the diffraction grating in the original hologram plate has a diffraction efficiency equal between for 0-th light and for +1-st diffracted light

49. The method of duplicating a diffraction grating as claimed in claim 47, wherein:
the diffraction grating in the original hologram plate has a diffraction efficiency equal between for 0-th light and for +1-st diffracted light

50. The method of duplicating a diffraction grating as claimed in claim 6, wherein:
the diffraction grating in the original hologram plate comprises a surface relief diffraction grating.

51. The method of duplicating a diffraction grating as claimed in claim 7, wherein:
the diffraction grating in the original hologram plate comprises a surface relief diffraction grating.

52. The method of duplicating a diffraction grating as claimed in claim 50, wherein:
the diffraction grating in the original hologram plate has a diffraction efficiency equal between for 0-th light and for +1-st diffracted light.

53. The method of duplicating a diffraction grating as claimed in claim 51, wherein:
the diffraction grating in the original hologram plate has a diffraction efficiency equal between for 0-th light and for +1-st diffracted light.

54. The method of duplicating a diffraction grating as claimed in claim 6, comprising the steps of:
making an original hologram plate having a plurality of the diffraction gratings each having the plurality of divided areas approximately in contact with a hologram recording material for duplication, and exposing the hologram recording material to interference fringes made from 0-th light and 1-st diffracted light generated from a diffraction grating of the original hologram plate as a result of light being applied from the side of the original hologram plate to the single diffraction grating;
moving relatively the original hologram plate, the hologram recording material for duplication and a light for the exposure after the exposure by a predetermined amount; and
repeating said step of exposure and said step of moving alternately a plurality of times.

55. The method of duplicating a diffraction grating as claimed in claim 7, comprising the steps of:
making an original hologram plate having a plurality of the diffraction gratings each having the plurality of divided areas approximately in contact with a hologram recording material for duplication, and exposing the hologram recording material to interference fringes made from 0-th light and 1-st diffracted light generated from a diffraction grating of the original hologram plate as a result of light being applied from the side of the original hologram plate to the single diffraction grating;
moving relatively the original hologram plate, the hologram recording material for duplication and a light for the exposure after the exposure by a predetermined amount; and
repeating said step of exposure and said step of moving alternately a plurality of times.

56. The method of duplicating a diffraction grating as claimed in claim 6, comprising the steps of:
making an original hologram plate having a plurality of the diffraction gratings each having the plurality of divided areas approximately in contact with a hologram recording material for duplication, and exposing the hologram recording material to interference fringes made from 0-th light and 1-st diffracted light generated from respective diffraction gratings of the original hologram plate as a result of light being applied from the side of the original hologram plate to the plurality diffraction gratings simultaneously from among the plurality of diffraction gratings included in the original hologram plate;
moving relatively the original hologram plate, the hologram recording material for duplication and a light for the exposure after the exposure by a predetermined amount; and
repeating said step of exposure and said step of moving alternately a plurality of times.

57. The method of duplicating a diffraction grating as claimed in claim 7, comprising the steps of:
making an original hologram plate having a plurality of the diffraction gratings each having the plurality of divided areas approximately in contact with a hologram recording material for duplication, and exposing the hologram recording material to interference fringes made from 0-th light and 1-st diffracted light generated from respective diffraction gratings of the original hologram plate as a result of light being applied from the side of the original hologram plate to the plurality diffraction gratings simultaneously from among the plurality of diffraction gratings included in the original hologram plate;
moving relatively the original hologram plate, the hologram recording material for duplication and a light for the exposure after the exposure by a predetermined amount; and
repeating said step of exposure and said step of moving alternately a plurality of times.

58. The method of duplicating a diffraction grating as claimed in claim 6, comprising the steps of:
making an original hologram plate having a plurality of the diffraction gratings each having the plurality of divided areas approximately in contact with a hologram recording material for duplication, and exposing the hologram recording material to interference fringes made from 0-th light and 1-st diffracted light generated from the respective diffraction gratings of the original hologram plate as a result of light being applied from the side of the original hologram plate to the plurality diffraction gratings simultaneously so as to expose the hologram recording material for duplication for the plurality of diffraction gratins included in the original hologram plate in a lump.

59. The method of duplicating a diffraction grating as claimed in claim 7, comprising the steps of:
making an original hologram plate having a plurality of the diffraction gratings each having the plurality of divided areas approximately in contact with a hologram recording material for duplication, and exposing the hologram recording material to interference fringes made from 0-th light and 1-st diffracted light generated from the respective diffraction gratings of the original hologram plate as a result of light being applied from the side of the original hologram plate to the plurality diffraction gratings simultaneously so as to expose the hologram recording material for duplication for the plurality of diffraction gratins included in the original hologram plate in a lump.

60. The method of duplicating a diffraction grating as claimed in claim 26, comprising the steps of:
disposing an original hologram plate having a plurality of the diffraction gratings each having the plurality of divided areas recorded therein and a hologram recording material for duplication with the relay optical system inserted therebetween, and exposing the hologram recording material to interference fringes made from 0-th light and 1-st diffracted light generated from a diffraction grating of the original hologram plate as a result of light being applied from the side of the original hologram plate to the single diffraction grating thereof; and
moving relatively the original hologram plate, the hologram recording material for duplication and a light for the exposure after the exposure by a predetermined amount; and
repeating said step of exposure and said step of moving alternately a plurality of times.

61. The method of duplicating a diffraction grating as claimed in claim 26, comprising the steps of:
disposing an original hologram plate having a plurality of the diffraction gratings each having the plurality of divided areas recorded therein and a hologram recording material for duplication with the relay optical system inserted therebetween, and exposing the hologram recording material to interference fringes made from 0-th light and 1-st diffracted light generated from respective diffraction gratings of the original hologram plate as a result of light being applied from the side of the original hologram plate to the plurality of diffraction gratings from among the plurality of diffraction gratings of the original hologram plate; and
moving relatively the original hologram plate, the hologram recording material for duplication and a light for the exposure after the exposure by a predetermined amount; and
repeating said step of exposure and said step of moving alternately a plurality of times.

62. The method of duplicating a diffraction grating as claimed in claim 26, comprising the steps of:
disposing an original hologram plate having a plurality of the diffraction gratings each having the plurality of divided areas recorded therein and a hologram recording material for duplication with the relay optical system inserted therebetween, and exposing the hologram recording material to interference fringes made from 0-th light and 1-st diffracted light generated from the respective diffraction gratings of the original hologram plate as a result of light being applied from the side of the original hologram plate to the plurality of diffraction gratings thereof so as to expose the hologram recording material for duplication for the plurality of diffraction gratings included in the original hologram plate in a lump.

63. A diffraction grating produced as a result of the method of duplicating a diffraction grating claimed in claim 6 being performed.

64. A diffraction grating produced as a result of the method of duplicating a diffraction grating

65. A diffraction grating produced as a result of the method of duplicating a diffraction grating claimed in claim 54 being performed.

66. A diffraction grating produced as a result of the method of duplicating a diffraction grating claimed in claim 55 being performed.

67. A diffraction grating produced as a result of the method of duplicating a diffraction grating claimed in claim 56 being performed.

68. A diffraction grating produced as a result of the method of duplicating a diffraction grating claimed in claim 57 being performed.

69. A diffraction grating produced as a result of the method of duplicating a diffraction grating claimed in claim 58 being performed.

70. A diffraction grating produced as a result of the method of duplicating a diffraction grating claimed in claim 59 being performed.

71. A diffraction grating produced as a result of the method of duplicating a diffraction grating claimed in claim 60 being performed.

72. A diffraction grating produced as a result of the method of duplicating a diffraction grating claimed in claim 61 being performed.

73. A diffraction grating produced as a result of the method of duplicating a diffraction grating claimed in claim 62 being performed.

74. A diffraction grating produced as a result of the method of duplicating a diffraction grating claimed in claim 63 being performed.

75. A diffraction grating produced as a result of the method of duplicating a diffraction grating claimed in claim 64 being performed.

76. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein in said optical system, the diffraction grating claimed in claim 1 and a ¼ wavelength plate are provided on the light path, and the reflected light from the recording medium is received by the photodetector after being branched off by means of the diffraction grating.

77. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 6.

78. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein in said optical system, a diffraction grating produced by the method of duplicating a diffraction grating claimed in claim 6 and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 7.

79. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 54.

80. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 55.

81. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 56.

82. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 57.

83. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 58.

84. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 59.

85. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 60.

86. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 61.

87. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 62.

88. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 63.

89. An optical head device leading light from a light source to an optical system, converging the light to a recording medium by a converging lens, detecting reflected light from the recording medium by a photodetector and thus performing recording, reproduction or both recording and reproduction of information to or from the recording medium,
wherein:
in said optical system, a diffraction grating and a ¼ wavelength plate are provided on the light path, and the reflected light from the recording medium is received by the photodetector after being branched off by means of the diffraction grating; and
said diffraction grating comprises a diffraction grating produced through the method of duplicating a diffraction grating claimed in claim 64.

90. The optical head device as claimed in claim 76, wherein:
said light source, said photodetector and said diffraction grating are united.

91. The optical head device as claimed in claim 77, wherein:
said light source, said photodetector and said diffraction grating are united.

92. The optical head device as claimed in claim 78, wherein:
said light source, said photodetector and said diffraction grating are united.

93. The optical head device as claimed in claim 79, wherein:
said light source, said photodetector and said diffraction grating are united.

94. The optical head device as claimed in claim 80, wherein:
said light source, said photodetector and said diffraction grating are united.

95. The optical head device as claimed in claim 81, wherein:
said light source, said photodetector and said diffraction grating are united.

96. The optical head device as claimed in claim 82, wherein:
said light source, said photodetector and said diffraction grating are united.

97. The optical head device as claimed in claim 83, wherein:
said light source, said photodetector and said diffraction grating are united.

98. The optical head device as claimed in claim 84, wherein:
said light source, said photodetector and said diffraction grating are united.

99. The optical head device as claimed in claim 85, wherein:
said light source, said photodetector and said diffraction grating are united.

100. The optical head device as claimed in claim 86, wherein:
said light source, said photodetector and said diffraction grating are united.

101. The optical head device as claimed in claim 87, wherein:
said light source, said photodetector and said diffraction grating are united.

102. The optical head device as claimed in claim 88, wherein:
said light source, said photodetector and said diffraction grating are united.

103. The optical head device as claimed in claim 89, wherein:
aid light source, said photodetector and said diffraction grating are united.

104. An optical head device leading light from a plurality of light sources to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, the diffraction grating claimed in claim 1 and a ¼ wavelength plate are provided on the light path, and the reflected light from the recording medium is received by the common photodetector after being branched off by means of the diffraction grating.

105. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 6.

106. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 7.

107. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 54.

108. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 55.

109. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 56.

110. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 57.

111. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 58.

112. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 59.

113. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 60.

114. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 61.

115. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 62.

116. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 63.

117. An optical head device leading light from a light source to an optical system through a common coupling lens, converging the light to a recording medium by a converging lens, detecting reflected light from the recording medium by a photodetector and thus performing recording, reproduction or both recording and reproduction of information to or from the recording medium,
wherein in said optical system, a diffraction grating and a ¼ wavelength plate are provided on the light path, and the reflected light from the recording medium is received by the common photodetector after being branched off by means of the diffraction grating; and
said diffraction grating comprises a diffraction grating produced through the method of duplicating a diffraction grating claimed in claim 64.

118. The optical head device as claimed in claim 104, wherein:
said plurality of light sources, said photodetector and said diffraction grating are united.

119. The optical head device as claimed in claim 105, wherein:
said plurality of light sources, said photodetector and said diffraction grating are united.

120. The optical head device as claimed in claim 106, wherein:
said plurality of light sources, said photodetector and said diffraction grating are united.

121. The optical head device as claimed in claim 107, wherein:
said plurality of light sources, said photodetector and said diffraction grating are united.

122. The optical head device as claimed in claim 108, wherein:
said plurality of light sources, said photodetector and said diffraction grating are united.

123. The optical head device as claimed in claim 109, wherein:
said plurality of light sources, said photodetector and said diffraction grating are united.

124. The optical head device as claimed in claim 110, wherein:
said plurality of light sources, said photodetector and said diffraction grating are united.

125. The optical head device as claimed in claim 111, wherein:
said plurality of light sources, said photodetector and said diffraction grating are united.

126. The optical head device as claimed in claim 112, wherein:
said plurality of light sources, said photodetector and said diffraction grating are united.

127. The optical head device as claimed in claim 113, wherein:
said plurality of light sources, said photodetector and said diffraction grating are united.

128. The optical head device as claimed in claim 114, wherein:
said plurality of light sources, said photodetector and said diffraction grating are united.

129. The optical head device as claimed in claim 115, wherein:
said plurality of light sources, said photodetector and said diffraction grating are united.

130. The optical head device as claimed in claim 116, wherein:
said plurality of light sources, said photodetector and said diffraction grating are united.

131. The optical head device as claimed in claim 117, wherein:
said plurality of light sources, said photodetector and said diffraction grating are united.

132. An optical disk drive apparatus employing the optical head device claimed in claim 76 to perform recording, reproduction or both recording and reproduction of information to or from a recording medium.

133. An optical disk drive apparatus employing the optical head device claimed in claim 77 to perform recording, reproduction or both recording and reproduction of information to or from a recording medium.

134. An optical disk drive apparatus employing the optical head device claimed in claim 78 to perform recording, reproduction or both recording and reproduction of information to or from a recording medium.

135. An optical disk drive apparatus employing the optical head device claimed in claim 79 to perform recording, reproduction or both recording and reproduction of information to or from a recording medium.

136. An optical disk drive apparatus employing the optical head device claimed in claim 80 to perform recording, reproduction or both recording and reproduction of information to or from a recording medium.

137. An optical disk drive apparatus employing the optical head device claimed in claim 81 to perform recording, reproduction or both recording and reproduction of information to or from a recording medium.

138. An optical disk drive apparatus employing the optical head device claimed in claim 82 to perform recording, reproduction or both recording and reproduction of information to or from a recording medium.

139. An optical disk drive apparatus employing the optical head device claimed in claim 83 to perform recording, reproduction or both recording and reproduction of information to or from a recording medium.

140. An optical disk drive apparatus employing the optical head device claimed in claim 84 to perform recording, reproduction or both recording and reproduction of information to or from a recording medium.

141. An optical disk drive apparatus employing the optical head device claimed in claim 85 to perform recording, reproduction or both recording and reproduction of information to or from a recording medium.

142. An optical disk drive apparatus employing the optical head device claimed in claim 86 to perform recording, reproduction or both recording and reproduction of information to or from a recording medium.

143. An optical disk drive apparatus employing the optical head device claimed in claim 87 to perform recording, reproduction or both recording and reproduction of information to or from a recording medium.

144. An optical disk drive apparatus employing the optical head device claimed in claim 88 to perform recording, reproduction or both recording and reproduction of information to or from a recording medium.

145. An optical disk drive apparatus employing the optical head device claimed in claim 89 to perform recording, reproduction or both recording and reproduction of information to or from a recording medium.

146. An optical disk drive apparatus employing the optical head device claimed in claim 104 to perform recording, reproduction or both recording and reproduction of information to or from a recording medium.

147. An optical disk drive apparatus employing the optical head device claimed in claim 105 to perform recording, reproduction or both recording and reproduction of information to or from a recording medium.

148. An optical disk drive apparatus employing the optical head device claimed in claim 106 to perform recording, reproduction or both recording and reproduction of information to or from a recording medium.

149. An optical disk drive apparatus employing the optical head device claimed in claim 107 to perform recording, reproduction or both recording and reproduction of information to or from a recording medium.

150. An optical disk drive apparatus employing the optical head device claimed in claim 108 to perform recording, reproduction or both recording and reproduction of information to or from a recording medium.

151. An optical disk drive apparatus employing the optical head device claimed in claim 109 to perform recording, reproduction or both recording and reproduction of information to or from a recording medium.

152. An optical disk drive apparatus employing the optical head device claimed in claim 110 to perform recording, reproduction or both recording and reproduction of information to or from a recording medium.

153. An optical disk drive apparatus employing the optical head device claimed in claim 111 to perform recording, reproduction or both recording and reproduction of information to or from a recording medium.

154. An optical disk drive apparatus employing the optical head device claimed in claim 112 to perform recording, reproduction or both recording and reproduction of information to or from a recording medium.

155. An optical disk drive apparatus employing the optical head device claimed in claim 113 to perform recording, reproduction or both recording and reproduction of information to or from a recording medium.

156. An optical disk drive apparatus employing the optical head device claimed in claim 114 to perform recording, reproduction or both recording and reproduction of information to or from a recording medium.

157. An optical disk drive apparatus employing the optical head device claimed in claim 115 to perform recording, reproduction or both recording and reproduction of information to or from a recording medium.

158. An optical disk drive apparatus employing the optical head device claimed in claim 116 to perform recording, reproduction or both recording and reproduction of information to or from a recording medium.

159. An optical disk drive apparatus employing the optical head device claimed in claim 117 to perform recording, reproduction or both recording and reproduction of information to or from a recording medium.
